(19) United States
(12) Patent Application Publication
(10) Pub. No.: US 2024/0278116 A1
(43) Pub. Date: Aug. 22, 2024

(54) CLOUD-STREAMING OF INTERACTIVE DIGITAL PHOTO-REALISTIC GRAPHICAL CONTENT, AUDIO, AND SIMULATIONS FOR USERS

(71) Applicant: DESERT SABER, L.L.C., Tucson, AZ (US)

(72) Inventors: Michael G. Peltier, Tucson, AZ (US); Mary M. Poulton, Mead, WA (US); Mark R. Baker, Tucson, AZ (US)

(21) Appl. No.: 18/441,619

(22) Filed: Feb. 14, 2024

Related U.S. Application Data
(60) Provisional application No. 63/447,545, filed on Feb. 22, 2023.

(51) Int. Cl. A63F 13/355; A63F 13/52; G06T 15/20

(52) U.S. Cl. CPC A63F 13/355; A63F 13/52; G06T 15/20

(57) ABSTRACT

Systems and methods of providing interactive content to a single user or multiple users include providing a server having interactive content. Using a processor of the server, at least a portion of the interactive content for one or more users is rendered in a single server instance simultaneously, thereby providing rendered screen frames of the interactive content for the one or more users. The rendered screen frames of the interactive content are streamed through at least one network connection to the one or more users, whereby the rendered screen frames of the interactive content are displayed on one or more local computing devices corresponding to the one or more users, respectively.

### CROSS REFERENCE TO RELATED APPLICATION

This application claims benefit of U.S. Provisional Application Ser. No. 63/447,545, entitled, “Cloud-Streaming of Interactive Digital Photo-Realistic Graphical Content, Audio, and Simulations for Users” filed Feb. 22, 2023, the entire disclosure of which is incorporated herein by reference.

### FIELD OF THE DISCLOSURE

The present disclosure is generally related to providing digital interactive content and more particularly is related to cloud-streaming of interactive digital, photo-realistic graphical content, audio, and simulations for users.

### BACKGROUND OF THE DISCLOSURE

The metaverse is a massively scaled and interoperable network of real-time rendered 3D virtual worlds that can be experienced synchronously and persistently by an effectively unlimited number of users with an individual sense of presence, and with continuity of data, such as identity, history, entitlements, objects, communications, and payments. Various 3D virtual worlds currently exist and operate within the metaverse as video games and interactive platforms, such as, for example, those that operate under the brands ROBLOX®, MINECRAFT®, or SECOND LIFE®, among others. Video games such as FORTNITE® allow large numbers of users to synchronously experience events such as concerts and celebrity appearances as individual avatars. Several video game or digital interactive platforms, such as those operated by MICROSOFT®, SONY®, AMAZON®, and others, render interactive content in real time and cloud stream to user devices.

In operation, these games and platforms usually require an application to be downloaded and the graphics are rendered using the graphical processing unit (GPU) and central processing unit (CPU) present on the user's computing device. As such, the graphics and actions in the video games are restricted by the computational limits of the GPU and CPU, herein referred to jointly as the processing units (PU) on the user's computing device.

To avoid the computational limits of the PU on a user's local computer, some video games utilize remote rendering of graphics which are then streamed to a user's computing device. However, this arrangement requires one remote instance of the game per each user which has shortcomings. Namely, such an arrangement cannot economically scale to an unlimited number of users because it is impractical or impossible for a server to have sufficient computational power to process a remote instance for each of an unlimited number of users.

Additionally, video games use fixed decision trees to control the game logic and flow. While these decision trees may be very large and complex, game play generally cannot stray beyond the pre-determined options in the game, even in large open-world games.

While many video games are utilized purely for entertainment purposes, there are also games referred to as ‘serious games’ which are video games used for learning and occupational training. They are programmed like entertainment video games and have the same limitations as entertainment video games for graphics rendering on user devices, simplified graphics and simulations, and fixed decision trees.

Virtual video conferencing applications such as those operate under the brands META WORK ROOMS®, MICROSOFT MESH FOR TEAMS®, WEBEX HOLOGRAM®, GOOGLE PROJECT STARLINE®, DELOITTE UNLIMITED REALITY®, with or without virtual reality or augmented reality hardware, are currently limited to lower resolution graphics that can be rendered on the headset of a user or streamed to the user's headset. Avatars in such conferencing software are often cartoon-style representations of meeting participants or video of actual participants whose range of motion is limited to the position in front of a camera. Meeting locations are often also cartoonish representations of worksites. As such, there are practical limitations to these applications.

Social meetings can take place in some video games and platforms like ROBLOX® and SECOND LIFE® but they are typically limited to the video game world graphics of the particular games or platforms. Additionally, they have the same limitations with regards to the range of motion, fixed decision trees, and limited realism that restrict entertainment video games.

Thus, a heretofore unaddressed need exists in the industry to address the aforementioned deficiencies and inadequacies.

### SUMMARY OF THE DISCLOSURE

Embodiments of the present disclosure provide a system and method for providing interactive content to at least one user. Briefly described, in architecture, one embodiment of the system, among others, can be implemented as follows. A system of providing interactive content to at least one user has a server having interactive content. The server has a processor and a non-transitory memory. Rendered screen frames are derived from the interactive content by a rendering process with the processor of the server. The rendering process renders at least a portion of the interactive content for one or more users and may be adjusted for each specific user's perspective in a single server instance simultaneously, thereby providing the rendered screen frames of the interactive content for the one or more users. At least one network connection is between the server and local computing devices, wherein the rendered screen frames of the interactive content are streamed to the one or more users such that each user sees their specific frame from their perspective. A display device is provided for each of the local computing devices, wherein the rendered screen frames of the interactive content are displayed on the display device of each of the local computing devices corresponding to the one or more users, such that each user sees their specific frame from their perspective, respectively.

The present disclosure can also be viewed as providing methods of providing interactive content to at least one user. In this regard, one embodiment of such a method, among others, can be broadly summarized by the following steps: providing a server having interactive content; rendering, with a processor of the server, at least a portion of the interactive content for one or more users in a single server instance simultaneously, thereby providing rendered screen frames of the interactive content for the one or more users, such that each user sees their specific frame from their perspective; and streaming, through at least one network connection, the rendered screen frames of the interactive content to the one or more users, whereby the rendered screen frames of the interactive content are displayed on one or more local computing devices corresponding to the one or more users, respectively.

The present disclosure can also be viewed as providing methods of providing interactive gaming content to at least one user. In this regard, one embodiment of such a method, among others, can be broadly summarized by the following steps: providing a server having a virtual environment with interactive gaming content; rendering, with a processor of the server, at least a portion of the interactive gaming content for at least one user in a single server instance simultaneously, thereby providing rendered screen frames of the interactive gaming content for all users of the virtual environment, wherein the portion of the interactive gaming content is rendered to a texture canvas which has capacity for all rendered screen frames from each user's perspective of the interactive gaming content; partitioning the rendered screen frames of the interactive content into individual user screen frames corresponding to each user of the virtual environment; and streaming, through at least one network connection, the rendered screen frames of the interactive content to each user of the virtual environment, whereby the virtual environment is accessed by each user through a web browser on a local computing device of the user, and the rendered screen frames of the interactive content are displayed on the local user computing device of the user providing that user with their specific perspective of the virtual environment.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagrammatical illustration of an adaptive behavior cycle, in accordance with embodiments of the present disclosure.

FIG. 2 is a diagrammatical block illustration of the platform, in accordance with embodiments of the present disclosure.

FIG. 3 is a diagrammatical illustration of the CO-ED communication system, in accordance with embodiments of the present disclosure.

FIG. 4 is a diagrammatical illustration of GEMs connected by CO-ED, in accordance with embodiments of the present disclosure.

FIG. 5 is a diagrammatical illustration of how CO-ED and GEMs operate as a polymorphic logic tree, in accordance with embodiments of the present disclosure.

FIG. 6 is a diagrammatic illustration of how CO-ED and GEMs operate as a polymorphic logic tree, in accordance with embodiments of the present disclosure.

FIG. 7 is a diagrammatical illustration of an example of the CO-ED system where intelligent queue GEMs are used for inspecting a ladder, in accordance with embodiments of the present disclosure.

FIG. 8 is a diagrammatic illustration of a system for providing interactive content to one or more users, in accordance with embodiments of the present disclosure.

FIG. 9 is a diagrammatical illustration of the texture canvas and the screen frames of the system, in accordance with embodiments of the present disclosure.

FIG. 10 is a diagrammatical illustration of the texture canvas and the screen frames of the system, in accordance with embodiments of the present disclosure.

FIG. 11 is a diagrammatical illustration of the texture canvas divided into screen frames of the system, in accordance with embodiments of the present disclosure.

FIG. 12 is a diagrammatical illustration of the texture canvas of the system, in accordance with embodiments of the present disclosure.

FIG. 13 is a diagrammatical illustration of the texture canvas of the system, in accordance with embodiments of the present disclosure.

FIG. 14 is a diagrammatical illustration of the texture canvas of the system, in accordance with embodiments of the present disclosure.

FIG. 15 is a diagrammatical illustration of the texture canvas of the system, in accordance with embodiments of the present disclosure.

FIG. 16 is a diagrammatical illustration of the texture canvas of the system, in accordance with embodiments of the present disclosure.

FIG. 17 is a diagrammatical illustration of the texture canvas of the system, in accordance with embodiments of the present disclosure.

FIG. 18 is a diagrammatical illustration of stream configuration, in accordance with conventional techniques.

FIG. 19 is a diagrammatical illustration of a SFU, in accordance with conventional techniques.

FIG. 20 is a diagrammatical illustration of streaming method used by the system, in accordance with embodiments of the present disclosure.

FIG. 21 is a diagrammatical illustration of a video stream process used by the system, in accordance with embodiments of the present disclosure.

FIG. 22 is a diagrammatical illustration of an audio stream process used by the system, in accordance with embodiments of the present disclosure.

FIG. 23 is a diagrammatical illustration of a spatialized audio stream process used by the system, in accordance with embodiments of the present disclosure.

FIG. 24 is a diagrammatical illustration of an audio stream process for teleconferencing and similar communications, in accordance with embodiments of the present disclosure.

FIG. 25 is a diagrammatical illustration of the details of the digital signal processors of FIG. 23 in a spatialized audio stream process used by the system, in accordance with embodiments of the present disclosure.

FIG. 26 is a diagrammatical illustration of the optimization of digital signal processors of FIG. 23 in a spatialized audio stream process used by the system, in accordance with embodiments of the present disclosure.

FIG. 27 is a diagrammatical illustration of command and control processing used by the system, in accordance with embodiments of the present disclosure.

FIG. 28 is a flowchart illustrating a method of providing interactive content to one or more users, in accordance with embodiments of the present disclosure.

### DETAILED DESCRIPTION

To improve over the shortcomings of conventional digital interactive platforms, as described in the Background, the subject disclosure is directed to a novel platform, including related systems, methods, and technologies, which provide improvements to digital platform technology used for providing interactive simulations and similar interactions to multiple users. Specifically, the novel platform described herein allows for creating, managing, manipulating, rendering, and delivering networked, interactive, interoperable digital video worlds with photo-realistic graphics, and accurate autonomous simulations of objects that can accommodate a single user or a very large numbers of simultaneous users.

As will be detailed, the platform has numerous improvements and benefits over conventional systems. For instance, the platform may maintain a continuity of user experience data across networked, interoperable digital video worlds. The platform may also support multiple, different user-facing experiences such as, but not limited to, occupational training, education, entertainment, socializing, communicating, commerce, and other applications, all of which are considered within the scope of this disclosure.

Notably, the platform operates with remote rendering and cloud streaming content to the user, such that users with virtually any device-including those with low computational power abilities-are capable of playing a video to be immersed in a photo-realistic, interactive experience that typically requires powerful top-end hardware with high computational power. In brief, the user connects a browser to the platform then sends digital video world inputs from a game controller, keyboard, mouse, touch screen, or other input device to the platform. The platform processes the inputs then renders the 3D digital video world remotely using top-end graphics hardware. The rendered 3D scenes are encoded into a video stream then sent back to the user as an audio/video stream. As the user reacts to the scene in the interactive digital video world, the platform adjusts the returned video stream accordingly. From the user's perspective, it produces the same experience as if their computing device, whether a laptop, tablet, phone, smart glasses, smart headset, or another computing device, had the same graphic capabilities as the remote server. The platform may facilitate remote rendering of graphics, audio, controls, and actions and cloud streams the processed information to each simultaneous user by manipulating the rendering process to render all user/users information in a single pass of the PU. This allows a single user's or multiple users' information to be processed on a single instance rather than one instance per user.

In accordance with this disclosure, a server is defined as a computer program (i.e., software) or device (i.e., hardware) that provides a service to another computer program and its user. Thus, a server is taken to mean the hardware and/or software that provides a service. In one example of the subject disclosure, the platform may be implemented with a server that is software.

Conventional multi-player video games are capable of running a small number of instances of a 3D engine on a single hardware platform. This, however, is not efficient as very few instances of the server application can be executed on a single piece of server hardware or compromises must be made in the quality of the graphics, the frame rate of the video stream delivered to the users, and complexity of user interactions. To achieve streaming with an acceptable frame rate, photo-realistic graphics, and complex simulations and interactions, the server hardware must load, maintain, and render separate copies of the high-definition virtual world for each user. Hence, server yield is low for multi-user streaming. The platform described herein may utilize only one server application to support many users with no redundant processing taking place on the server or the user's device. This results in not only more users per server application but also more users per server hardware device.

The platform may be optimized for large scale cloud-streaming of the realistic behaviors of a digital world that occur organically based on user or non-player character (NPC) actions or other characteristics of the virtual world instead of relying on pre-determined fixed decision trees, animations, and other fixed attributes. Instead of a fixed decision tree, the platform may use a polymorphic decision tree with open world and sandbox mechanics that facilitate emergent behaviors not pre-programmed or anticipated by the author(s) or users of the digital experience. The platform interfaces with a third-party 3D engine, such as the UNREAL ENGINE® from EPIC GAMES®, which provides graphics processing services supporting lighting, textures, shading, animations, etc.

The platform may network different interactive virtual worlds that the user can be seamlessly handed off to, so the user never has to leave the platform to experience different applications in different worlds. While virtual worlds running on the platform are accessed through conventional web browsers, once a virtual world in the platform is launched, the user does not have to exit one world and relaunch another world through the conventional browsers. The platform can be used in lieu of a conventional website, e.g. instead of entering a website, the user would enter a virtual world. Virtual worlds can be accessed by a URL from an object in another webpage.

Multiple interactive digital video worlds may be integrated/interoperable to allow multiple groups to coexist and conduct activities of their choosing simultaneously in the same world and choose to interact or not. The actions of one group can impact other groups or individuals in the networked, integrated/interoperable digital video worlds if such decisions would cause interactions in the physical world. For example, in an airport digital video world, employees for an airline can be trained on their tasks independently but simultaneously with employees of the fuel service company. The actions of the fuel service company employees can impact the baggage handlers without the two groups coordinating their training and/or interaction. Similarly, multiple users can experience the interactive digital video worlds for different purposes simultaneously. For example, some users may be doing on-the-job training, others may be socializing at a concert, others may be shopping in a digital storefront, all within the same virtual world.

Naturally, virtual worlds in the platform can be experienced in multiple languages and cultures simultaneously by multiple users. The platform may support localization of content for different languages, dialects, cultures, as well as regional artifacts like signage, electrical outlet configuration, left-hand versus right-hand driving, and other relevant differences between multiple user locations. The localization may extend to differences in procedures, regulations, and other relevant specifications between an organization's different subsidiaries, work sites, and unit operations within a work site. A worker at a site in Country A may simultaneously train together in the same virtual environment with a worker at a site in Country B and each will experience the training in their preferred language and with the relevant procedures for their site. Conversely, the localization can be specific to a site/region such that a user from Country A may experience the relevant procedures and/or preferred language of Country B.

The platform may support persistent worlds as well as persistent items within a world, such as the state of tools, vehicles, the weather, etc. Persistent worlds allow for the digital video worlds to exist in the state left in by previous users just like the real world. For example, a vehicle parked in front of a fire hydrant will stay there until moved. And like persistent worlds, the status of equipment and tools can be persistent from session to session. Wear and tear or breakage persists until the item is repaired or taken out of service. Users experience persistence for health exposures such as loud noise without proper hearing protection, dust exposure, musculoskeletal strains, and even mental health.

The platform and its user-facing experiences may use 360° open, persistent worlds with a sandbox mechanic which means any actionable objects present in the digital video world can be used and can interact with each other, and nearly anything that can happen in the physical world can happen in a digital video world experience. The open world and sandbox mechanics lead to emergent behaviors and user actions that do not have to be pre-programmed or anticipated by the virtual world designer or the users.

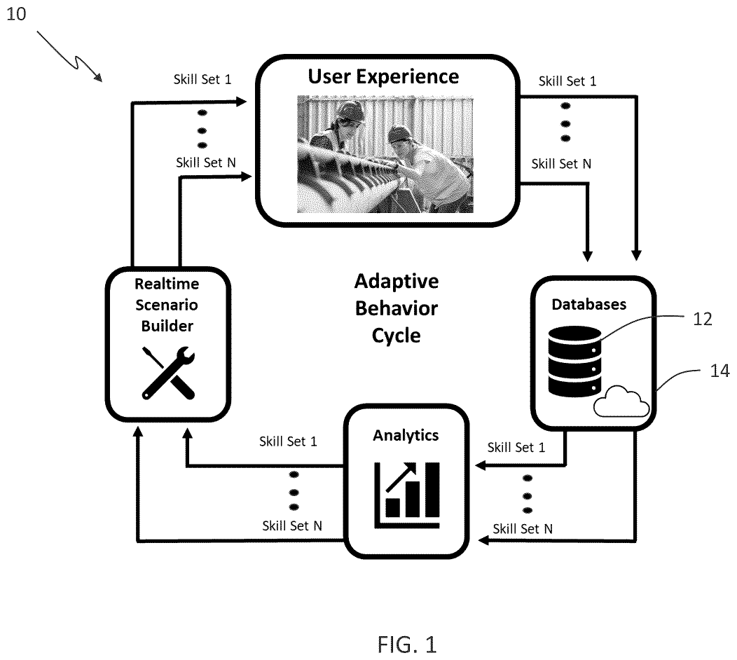

The platform may utilize an adaptive behavior cycle that allows actual real-time dynamic changes to the interactive digital video world experience using a polymorphic decision tree and the state of micro-simulators to analyze a large set of user actions. These actions may range from the user's time to make a decision, the decision space that is explored, changes to decisions, communication with non-player characters (NPCs) and other users, and metrics for competencies and capabilities. FIG. 1 is a diagrammatical illustration of an adaptive behavior cycle 10, in accordance with embodiments of the present disclosure. As shown, the adaptive behavior cycle 10 may drive the user's interaction in the virtual worlds. The adaptive behavior cycle uses the polymorphic decision tree and a large set of metrics based on user actions and responses to determine how the experience should adapt to each user and then automatically adapts the experience in real time. In other words, the adaptive behavior cycle 10 may modify user experiences based on user actions, behaviors, and desired level of challenge, all while the user never sees a break in the experience.

The platform is designed to track nearly every action a user takes, including if and when they change their mind about an action, how long they take to make a decision, their preferred sequence of activities, etc. The data are stored in databases 12 on a server 14 typically in the cloud or alternatively on local servers for non-cloud deployment. For training and e-learning, simple analytics can be provided via a trainer or teacher dashboard to show individual and group accomplishments. Machine learning tools can be applied to the database for an organization, cohort, or user to understand what actions and knowledge define an expert at a job, mastery of knowledge, etc. An expert vector can be constructed from the database and maps other users in that role or mastery level against the expert vector to determine future experiences.

In occupational training applications, a user's decisions can be analyzed based on an established competency model provided by a user or organization. A user's behaviors are evaluated by comparing in-scenario actions to established patterns of behaviors. Data derived from using user experiences are analyzed in a data management system in the context of other experiences. Data can be shared with enterprise resource software to correlate the impact of improved individual performance with organizational performance. For occupational training and e-learning experiences, trainers/teachers can interact in the sessions by adjusting the learning experience based on metrics from a live dashboard for individual and group session performance, interacting as an NPC in the session, passively observing the learning as an NPC in the session, and more. The data management system may track changes to the competencies and procedures used by a user or organization and provide updated training to a user. The data management system manages and stores each change and can analyze changes in user performance as a function of changed procedures allowing a user or organization to compare outcomes from different procedures and quantify workforce mastery of the new procedures.

Data across multiple skill sets are collected from a learning session then stored on a database 12 accessible to a data management system. These data, which are far more detailed than simple pass/fail Booleans, are analyzed to determine the user's competency for each of the skill sets defined, then adjustments are made to the module based on the user's needs. This approach allows users to advance in skill sets they are proficient at without leaving them behind in skill sets they are weak in. The result is a learning session adaptively tuned to the user's needs and skills whether it be learning to operate equipment, manage a team, or master a knowledge topic, etc. The formative feedback, practice, and variety of experience provided by the adaptive behavior cycle 10 provides a significant improvement for better and faster user learning and recall.

Competencies can be weighted and combined to allow the score of a critical parameter to exert more influence over the combined score. Weights can be combined based on context to emphasize a current desired skill set over a previously used skill set that is also used to complete the present task. Flexible competency weighting guides the adaptive behavior cycle to focus on the important skill or behavior sets without losing sight of related skills or behaviors.

Trainers, teachers, or other individuals or users, physically located at a local, remote, or centralized location, can enter a session in a Picture-in-Picture (PiP) window or otherwise displayed on the heads-up display (HUD) as a live stream to the whole class or a single user or other users. As additional options, the trainer/teacher/other individuals can passively observe the learning or environment through the eyes of a user in the individual's session or as a 3rd person spectator observing the entire learning or other environment. These trainers/teachers/other individuals, which may be referred to as second users relative to the primary user(s), can assume the role of a non-player character (NPC) and coach a user in the individual's session. Any second users can be derived from a camera view of that particular user. Trainers/teachers can challenge users by changing conditions in the session for a user or the entire class-e.g., change learning or application conditions, trigger new decision points. Trainers/teachers/other individuals can insert an existing reference video or other materials in Picture-in-Picture (PiP) or HUD; additionally, the platform or trainer/teacher/other individuals can trigger content such as videos based on user actions. Trainers/teachers/other individuals can share their screen to show how to do something to the whole class or a single user. Trainers/teachers/other individuals can analyze data to see how each user, cohort, and/or unit are doing based on a scoring rubric.

During a learning session, if a user is making mistakes or has questions, the user can click a button, speak a verbal command, or provide other input to bring the trainer/teacher/other individuals into the user's session. In one example, the platform can determine when mistakes are being made and can notify the trainer/teacher/other individuals of each occurrence so the trainer/teacher/other individuals can observe and intervene. Optionally, NPC expert commentators can provide input via the PiP. Trainers/teachers/other individuals, from a remote location, can provide learning input to sessions that are occurring anywhere in the real world at the same time-and the learning doesn't even have to be on the same topics.

Editing tools allow users to create and modify virtual worlds in the platform without downloading any applications, or recompiling code. The platform accesses and loads content, including code, for virtual worlds and users from databases that can be distributed across multiple servers and multiple server locations. Content is identified by universal identifiers (referred to as DSUIDs in the present disclosure, but are independent of the reference name). The DSUIDs can be versioned to allow changes to competencies and procedures to be tracked, and old versions to be deprecated and archived. The platform notifies users when training has been updated. The data management system allows changes in training content versions to be tracked along with when users completed revised training and the results of the previous and revised training.

To be able to adapt to each user's actions with no break in the experience, the platform may use a highly modular approach to building scenarios and simulations. This is accomplished by using Game Element Modules (GEMs) using a scripted programming language and coordinated in the platform through its internal communication system, Common Open Environment Delegate System (CO-ED).

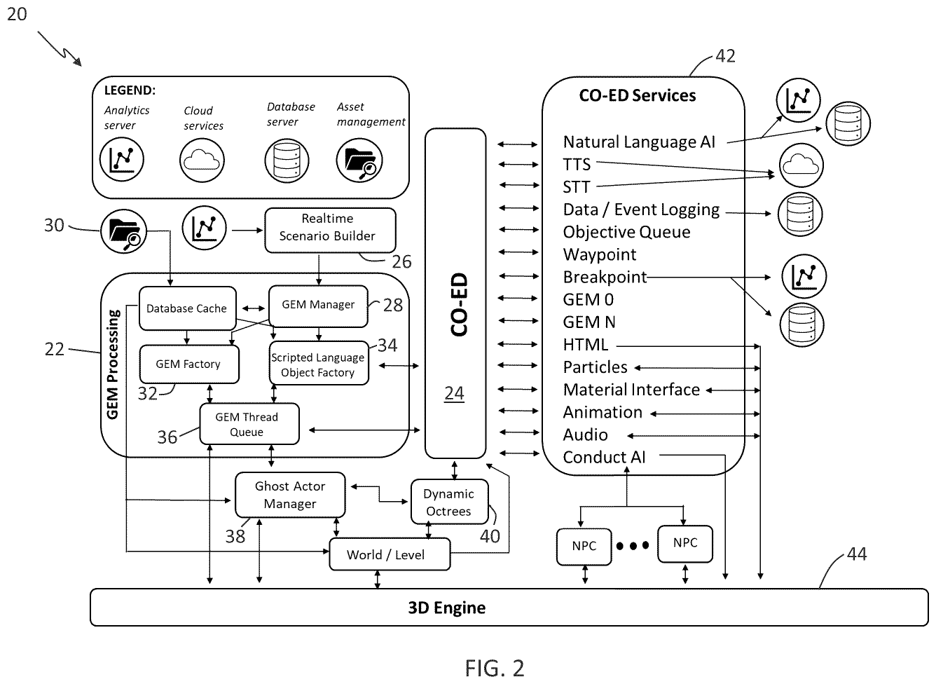

FIG. 2 is a diagrammatical block illustration of the platform 20, in accordance with embodiments of the present disclosure. With reference to FIG. 2, the platform 20 may provide networked, interoperable, interactive, digital video worlds using polymorphic decision tree logic that includes a GEM processing module 22 which communicates via the CO-ED system 24. The platform 20 is designed to optimize the networked, complex, interactive digital video worlds for a wide variety of user experiences for efficient remote rendering and cloud streaming delivery to very large user populations using a range of devices such as smart phones, tablets, laptops, PCs, gaming consoles, smart devices such as smart glasses or smart headsets, and any other computerized device. The platform design is driven by the need to optimize the auto-assembly of content modules, GEMs, in real-time based on user expertise and actions without a break in the user experience. The polymorphic decision process responds to the user's actions rather than simply guiding the user through a pre-defined decision tree.

A GEM is a fundamental executable block representing a reusable modular component of the overall scenario. GEMs may contain other GEMs and/or be interconnected with other GEMs to compose the overall logic for a particular user experience. At runtime, the GEMs can be polymorphically modified as the user experience plays out to adjust to the user's actions.

When a user-facing application is initialized, the real-time scenario builder 26 directs the GEM manager 28 to load or pre-cache all GEMs that will be needed for the current scenario. The initial scenario is typically tailored to the user's skill level, interests, history, as well as other user-specific parameters. As the scenario progresses, the real-time scenario builder 26 can change the existing scenario on the fly as directed by the external analytics server; this allows a user experience to be adapted live as necessary based on user actions.

The GEM manager 28 loads GEMs from an external database 30 and directs the GEM factory 32 or the scripted language object factory 34 to create the specified GEMs. The GEM manager 28 is also responsible for directing the platform 20 to pre-cache any GEMs or assets that might be needed because of the currently loaded user experience, or as a consequence of real time changes being applied to an existing user experience.

The GEM processing module 22 defines the specific module with its objectives, data, assets, scoring, etc. The GEM architecture allows a polymorphic rather than a fixed decision tree so the user experience can be customized without having to recompile and re-issue software updates. This approach gives the user-facing experience a building-block flexibility.

Scenario and decision logic are stored in the GEM tree and not a decision tree, so the software does not need to recompile or re-issue to make changes. The supervisory GEM spawns the asset list rather than hardcoding it into the module map so new equipment, tools, people, hazards can be introduced dynamically into any module or world. Any combination of GEMs can be dynamically linked to produce more and more sophisticated user experiences, such as introducing adverse weather or introducing an unexpected event (e.g., a fire, accident, etc.), all without the need to recompile or re-issue the software.

The dynamic decision process used in the platform 20 means user-facing experiences continuously evolve and respond to users' actions. GEMs can be automatically invoked into user experiences based on user actions leading to a polymorphic rather than static decision tree. Users can constantly use the platform and experience new situations.

It is noted that the GEM system, as described herein, may be significant to making the platform content authoring system scalable. In the GEM factory 32 and/or the scripted language object factory 34, GEMs can be defined by just a few lines of script code or references to one or more built-in general-purpose programming language GEM classes, to large executable scripts with many built-in references. The GEM factory 32 generates GEMs from general purpose programming language references in database files; the scripted language object factory 34 builds executable GEM-based scripted objects from database information. In either case, the resulting executable GEM is applied to the GEM thread queue 36 for execution.

The platform 20 may use a ghost actor system having a glost actor manager 38 that works in conjunction with the dynamic octree 40 to populate the open world with specific tools, equipment, buildings, and even some terrain features as needed by the user experiences. This allows the base worlds to be designed as “bare bones” worlds, then populated with specific objects, buildings, features, etc., on-demand as the user experience requires. This also allows base worlds to be used over a wider variety of user experiences than the traditional fixed world map. The ghost actor manager 38 allows actors that are out of scope in the world/level to be de-spawned or omitted from the level while still allowing their states and effects (if any) to be considered in the overall scenario. The ghost actor manager 38 uses the dynamic octree 40 to determine when an effected actor falls in or out of scope. The ghost actor system saves the persistent features of the virtual world.

The dynamic octree 40 can be used by the ghost actor manager 38, NPCs, and user pawns to query nearby objects in the virtual world. The dynamic octree 40 also monitors the motion of all actors (or actor placeholders) within its bounds and updates itself accordingly. Multiple dynamic octrees 40 can be used in a single level to reduce look-up times and partition congested items into smaller octrees. If a moveable object passes from the bounds of one dynamic octree 40 to another, that item is automatically handed-off to the appropriate octree.

CO-ED 24 may be the primary communication hub linking polymorphic GEMS and other platform components to a dynamic stack of CO-ED services 42. Each connection may be made using a delegate system. As such, transferring data may be accomplished by invoking a delegate and transfer time is virtually nil. There are several stock CO-ED services that interface with a 3D engine 44, however the largest user of CO-ED are GEMs.

CO-ED 24 allows an arbitrary number of modules (either single user or multi-user) to concurrently run in a common world. While the scenario objectives, scores, difficulty levels, logging etc., are isolated from each other, the world and the users are not. That is, if users in one module start a fire or block a road with a collision, then all users in all modules running in that environment must contend with those conditions, regardless of who they are affiliated with or where they are using the platform 20. CO-ED 24 may be significant to the scalability of the platform 20.

As previously identified, the vast majority of CO-ED service endpoints are instantiated as GEMs at runtime. These may include stock built-in services, most of which interface to a 3D engine, where any of these stock services can be overridden by redirecting the connection.

One service may be the text to speech (TTS) service, which accepts text requests in one of the supported languages and submits them to text to speech providers. The returned results are fed back asynchronously to the requesting consumer endpoint. Another service is the speech to text (STT) service, which submits a voice stream to a speech to text provider, then forwards the resulting text string to subscribing services. Subscribing services can include data/event logging, subtitling, and natural language AI services to process the text. The use of speech to text and text to speech allows interaction with the user via voice or text (e.g., conversing with other users, use of radio or telephonic communications, in-game interactions with a trainer or supervisor in training mode, etc.). AI services are implemented to allow users to ask NPC counterparts verbal questions, or to verbally answer NPC questions.

Another service is the objective queue, which monitors any user objectives that are pending and determines if the objectives were successful, failed, or accomplished without first completing a prerequisite. As an example, in a training context, each objective might be a single step in a standard operating procedure or a single inspection point. The waypoint service may monitor any number of conditions (typically queued by a GEM) that require feedback to the polymorphic logic, or to the user, when those conditions are met. Like the waypoint service, a breakpoint service may monitor any of several conditions that require immediate action (such as failing an objective). In addition to providing feedback to the session logic, the breakpoint service also notifies the external analytics server of the condition and generally invokes a change in the external adaptive behavior cycle.

The data/event logging service may provide a rich stream of heterogenous data reflecting user actions and events in the user experience. This is typically a very wide metrics vector, which is recorded in the external database server and referenced by the analytics server to adjust the adaptive behavior cycle. The HTML (Hyper-Text Markup Language) service provides rendering services for HTML files that are available in the database, or from an external URL. Other document rendering services, such as but not limited to Portable Document Format (PDF), presentations, or word processor documents may be provided. The results of these rendering services can be displayed as heads up display (HUD) elements or applied to render textures to change signs and/or labeling on actors to agree with the user's selected language. The particle service may process particle requests and applies them to a particle physics module in a 3D engine. The material interface service may process material parameter changes or animations to the specified material slots on the specified actor. The animation service may process animation requests for a specified actor then forwards them to a 3D engine animation system. The audio service may queue up audio requests, such as sound effects, TTS results, background music, etc., then applies them to the specified actor's audio component or a 3D engine audio system, depending on sound type. Photo-realistic digital humans are important to engage users in the realism of the experience. For example, many tasks require complex hand movements that can be time consuming to animate. The platform uses an efficient workflow that reduces the time to make these animations.

The conduct AI (Artificial Intelligence) system is a lightweight unsupervised machine learning artificial intelligence system capable of operating in real time inside the interactive digital video worlds. Conduct AI is applied on a per-NPC basis and provides the NPC with realistic human-like behavior. Indigenous to the system is human error such as complacency, oversight, and forgetting. Note that these human error aspects are native to the system and not artificially provided strictly by random chance. Conduct AI not only provides human-like behavior in terms of how the NPC appears in motions, curiosity, complacency, etc., but also allows NPCs to develop personal bias (good or bad) with respect to other NPCs or the user. Conduct Al can be expanded to allow NPCs to learn the same tasks the user is training for. This allows an NPC peer to accompany the user, which the user can compare their training progress against. Conduct AI can also provide a supervisor in training with a realistic NPC crew that learns from his/her lead. In addition, the conduct Al algorithm can accommodate a virtual on-the-job trainer character that can show the user how to perform a procedure or task. After the virtual trainer's demonstration, it verbally directs the user to perform the tasks and watches for errors while providing verbal encouragement if and when the user is successful. If the user makes a mistake, the virtual trainer can verbally stop the user, point out the error, then demonstrate the correct manner to perform the task while supplying additional instruction.

Subsets of code in GEMs are identified by unique ID's (in the present disclosure called DSUIDs) in databases and cached in memory with a time stamp related to the last time the code was edited. The storage of the DSUID and time stamp reduces the load on the servers and reduces the network traffic, thereby allowing more users on a single instance.

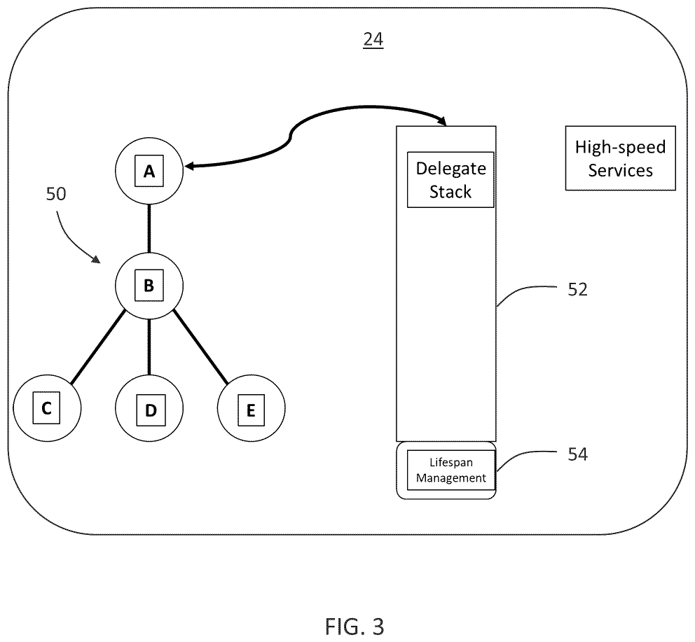

CO-ED 24 is described in further detail in FIG. 3, which is a diagrammatical illustration of the CO-ED 24 communication system, in accordance with embodiments of the present disclosure. CO-ED 24 functions as an internal network by connecting services and subscribers within the platform without using a transport layer, so no data packets need to be created and transferred. CO-ED 24 uses delegates which use function pointers to route information to target endpoints in the internal network. No time is used in this communication since packets are not being transported. Common arguments are used that allow heterogeneous data to be compatible across the platform. CO-ED 24 supports a wide diversity of connection types. Additionally, CO-ED 24 handles everything in the background, including permissions, spawning services, connecting delegates, etc. The result is the ability to run multiple experiences, users, and worlds on a single instance of a user facing application. The highly modular approach, coordinated by CO-ED 24, allows user-facing applications to seamlessly morph according to what the adaptive behavior cycle (automatically), or another entity, such as but not limited to a teacher, trainer, or other individual, (manually), predicts for changing the scenario. CO-ED 24 lightens the amount of code that must be handled by the server which provides for efficient streaming of even complex user experiences.

With reference to FIG. 3, each node 50 in CO-ED has a list of delegates that the node 50 is connected to. All delegates reside in a common pool of delegates (arranged in an array), referred to as a delegate stack 52, which collectively form the internal network. These delegates are managed by a lifespan management tool 54. The management tool 54 can establish or remove connections from nodes 50 to delegates in the pool and/or create or destroy delegates within the pool as necessary. For example, if a connection is not used in a particular span of time, then the connection is disconnected; if a delegate remains disconnected for a particular span of time, then the delegate is deleted.

CO-ED 24 uses an array of delegates to bind to target functions. Each delegate has several functions it can point to. These target functions are arbitrary and are generally defined by the service endpoint of a GEM. Each delegate can operate in one or more modes. Three primary modes of operation are: 1) peer-to-peer with a return value from the end node; 2) multi-cast; 3) bi-directional with two-way communication between nodes. Some delegates have a return value. Some delegates can only be bound to one type of target. Some delegates can multi-cast and be bound to multiple targets. For example, if an explosion takes place in the virtual world, the explosion event can be propagated via multi-casts to multiple nodes that process various aspects of the explosion, such as sound, shockwave, and NPC receipt of the event.

When a node 50 in CO-ED 24 is invoked, for example, node A, the platform directly calls a function at the other end of the connection, such as node B. The two nodes are connected by CO-ED 24, but data packets are not transferred from node A to node B. Each node 50 (node A through node E) has its own delegate or delegates within the delegate stack 52, which facilitates direct transfer of heterogeneous payload data as arguments in a direct function call. Nodes 50 can be any type of GEM including high-speed services GEMs.

Each node 50 in CO-ED 24 may be a GEM, e.g., a computer coded object, which can be thought of as a micro-plugin. Interpreted GEMs are programmed in an interpreted scripted language. Some GEMs are high-speed GEMs that need to execute faster or more frequently than an interpreted language will allow; these GEMs are typically programmed in a general-purpose compiled programming language. GEMs are autonomous objects with a specific input/output format for communication via CO-ED 24. Interpreted GEMs are user editable to allow modification of user-facing applications or to create new applications. GEMs can be text-based or pre-compiled into tokens for faster execution. Each GEM has one or more configuration sections that can be overwritten from a database as well as one or more variable parameter sections that may be modified as conditions change. Each GEM also has a list of applicable consumer and service end points used to communicate via CO-ED as well as a description of any services the GEM provides.

GEMs have a unique plugin functionality. Traditional plugins typically attach to a central interface for a specific type of plugin and are managed by a common plugin manager. GEMs typically connect to arbitrary interfaces on other GEMs and are managed by the GEMs themselves. Although some GEMs are preemptively loaded, most GEMs are not loaded until or unless their services are explicitly requested by other GEMs. Specifically, a GEM requests a specific service from CO-ED 24; if the GEM providing that service exists, CO-ED will establish a connection between the requesting GEM and the existing service GEM, otherwise CO-ED will load the service GEM prior to establishing the connection. In the latter case, the newly loaded GEM might itself request other GEMs to be loaded and connected to it. This behavior of leaving GEM management to GEMs themselves is key to the overall polymorphic (i.e., self-changing) behavior of the platform's core logic.

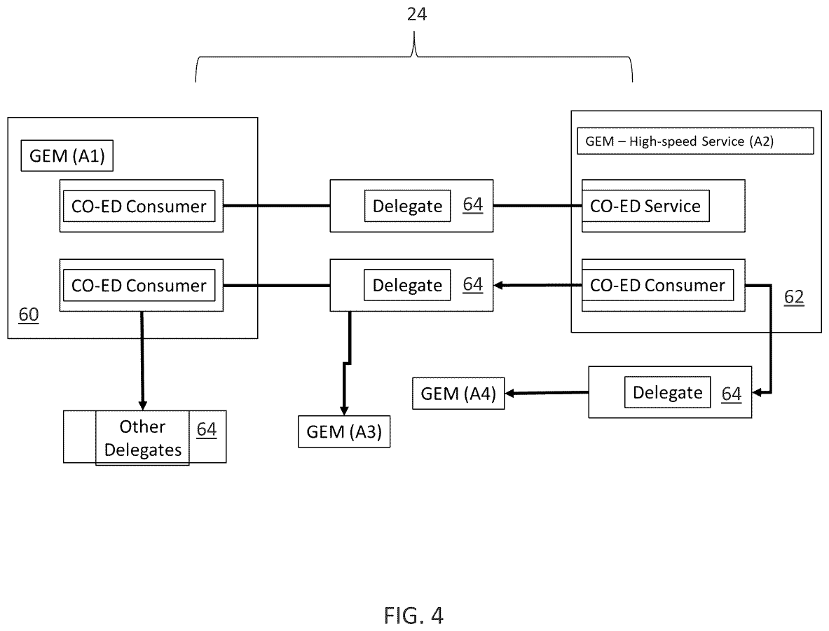

As an example of diverse GEMs which can be utilized, FIG. 4 is a diagrammatical illustration of GEMs connected by CO-ED 24, in accordance with embodiments of the present disclosure. As shown, CO-ED 24 establishes connections between consumer endpoints 60 and service endpoints 62 via a delegate 64. The consumer endpoint 60 is analogous to a client on a traditional network, and the service endpoint 62 is analogous to a server on a traditional network. Any GEM, whether interpreted or high-speed may contain any combination of consumer and/or service endpoints 60, 62. After connections are established, a consumer endpoint 60 can request data, action, or other services from a service endpoint 62 via the delegate 64, for example, from the top consumer endpoint in GEM A1 to the service endpoint in GEM A2. In this example, that request could result in GEM A2 propagating results or events via its consumer endpoint 60 to other GEMS, such as GEMs A3 and A4, and so on. The example configuration shown may be transient and only exist for a short time as the polymorphic network changes its topography to accommodate current conditions.

Services are provided by GEMs that contain one or more service endpoints 62. Not all GEMs have service endpoints 62, therefore not all GEMs are services. Likewise, consumers are GEMs that contain one or more consumer endpoints 60. Not all GEMs have consumer endpoints 60, therefore not all GEMs are consumers. Frequently, GEMs contain both consumer and service endpoints 60, 62 and operate in both roles simultaneously.

A delegate 64 is a computer code that binds one or more consumer endpoints 60 to one or more service endpoints 62. A delegate 64 can be thought of functionally as an internal network connection or data path through which heterogeneous payloads are transferred, though no actual transport/packet layer is implemented. A consumer endpoint 60 is a small code object that provides an interface to delegates 64. In addition, consumer endpoints 60 can request a connection to a service via CO-ED 24, as well as explicitly severing that connection should the need arise (most connections are severed implicitly by CO-ED 24). A consumer endpoint 60 also contains the target function that is called by the delegate 64 for receiving multicast broadcasts from service endpoints 62 or receiving bidirectional data from service endpoints 62. A service endpoint 62 is a small code object that contains the function called by the consumer endpoint 60 via the delegate. In addition, service endpoints 62 also provide an interface to the delegate 64 for broadcasting multicast payloads to all consumers connected to the delegate 64, as well as an interface to call a function that receives bidirectional data for a selected consumer connected to the delegate 64.

A service endpoint 62 will have one and only one delegate 64 connected to it. A delegate 64 is created when the service is created, and destroyed when the service is destroyed. That is, a single delegate is dedicated to a single service. In this sense, a delegate 64 is more closely associated with its service endpoint 62 rather than any consumer endpoints 60 connected to it. A service can be a gateway to an external network. A gateway service will format the payload data into a packet then transmit the packet to an external server. This type of service is typically used to send logged data, such as competency measurements, to a data server. It can also be used to transfer user state data from one instance of the platform to another, thereby allowing users to be seamlessly handed off to other instances of the platform. A consumer can also be a gateway from an external network. Consumers operating as a gateway will look like a server to an external network and accept packets on a specified port number. A consumer gateway is typically used to accept user state data from another instance of the platform then forward it to a performer service, which will initialize and place the user in the current world.

All connections begin with a request from a consumer endpoint 60. Consumer endpoints 60 in a GEM are initially disconnected and dormant and will remain in that state until or unless the host GEM requires the service the endpoint is configured to connect to. Optionally, a consumer endpoint 60 can be forced to explicitly connect with a service even if it does not have data to transfer; this feature can be used to ensure services are preemptively loaded before they are needed. The usual case is to leave consumer endpoints 60 dormant until or unless they have data to transfer (i.e., connect on demand). Some consumer endpoints 60 may remain dormant throughout the entire life of the GEM and never establish a connection if their corresponding services are not needed by the host GEM.

When a consumer endpoint 60 connects to a service (whether explicitly or on demand), it will send a connection request to CO-ED 24 with the service name or identifier of the service it needs to connect to. If the service is already loaded, CO-ED 24 will identify the delegate that is associated with the target service then connect the consumer to that service's delegate 64. If the service does not exist, CO-ED 24 will load and initialize the appropriate service GEM, then connect the consumer to the newly created service delegate 64. Once a connection is established, data is transferred autonomously between the consumer and service endpoints 60, 62 without further support required from CO-ED 24. Thus, CO-ED 24 may only be used to establish connections and to manage the lifespan of connections, delegates 64, and services.

CO-ED 24 manages the lifespan of connections and services by monitoring timestamps associated with each consumer connection to a delegate 64. If a connection shows no data activity for a predetermined amount of time, CO-ED 24 will disconnect the consumer endpoint 60 from the delegate 64 and place the endpoint back into a dormant state. If the service is subsequently needed, the endpoint will re-connect on demand using the same process as described previously. This behavior may be overridden by the consumer endpoint configuration if the connection should be maintained indefinitely. CO-ED 24 also manages the lifespan of delegates 64 and services. If all consumer connections have been disconnected from a delegate 64, CO-ED 24 will allow that delegate and its associated service to remain loaded for a predetermined period. If no new connections have been established before the predetermined period expires, CO-ED 24 will destroy the delegate and service as a pair. This behavior can be overridden in the service configuration if the service needs to remain loaded indefinitely. If a deleted service is subsequently needed, CO-ED 24 will re-create it as directed by the requesting consumer endpoint.

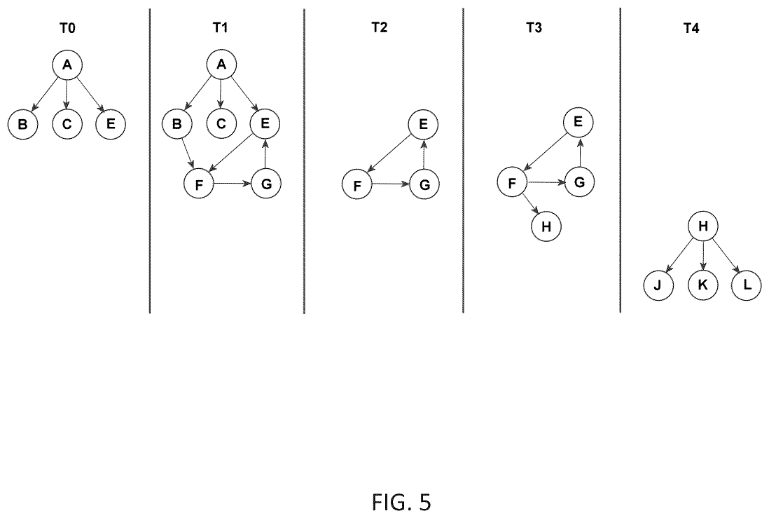

The connection and service lifespan management provided by CO-ED 24, along with the ability of each GEM to define any other GEMs that should be loaded and connected to it, provides a unique architecture that allows one or more polymorphic (self-changing) logic trees to spontaneously evolve within the CO-ED delegate system. To this end, FIG. 5 is a diagrammatical illustration of how CO-ED and GEMs operate as a polymorphic logic tree, in accordance with embodiments of the present disclosure. Specifically, FIG. 5 illustrates an example of how GEMs A through L create a polymorphic logic tree from time TO through time T4 based on their needs and the current state of the system, while CO-ED destroys unused nodes that are no longer needed. The result is a continuously changing logic tree capable of providing a unique experience every time the application is executed. In FIG. 5, GEMs are depicted as a circle labeled with letters A through L. Logical connections are depicted with an arrow for clarity, whereas in practice these connections consist of a consumer endpoint at the tail of the arrow, a service endpoint at the arrowhead, and the delegate shown by the arrow shaft. Again, for clarity, FIG. 5 does not show idle service endpoints or dormant consumer endpoints that do not contribute to the example being discussed. In addition, the example of FIG. 5 assumes all delegates are operating in peer-to-peer mode, though the same principles apply for delegates operating in multicast or bidirectional mode.

With reference to FIG. 5, assume GEM A is created at TO as a consequence of a prior operation, such as system initialization or loaded at the request of another GEM. Also assume that three of the consumer endpoints on GEM A are configured to explicitly connect to their target services on GEMs B, C, and E preemptively, even though they do not have data to transfer at this point in time. This results in GEMs B, C, and E being created and connected to GEM A as shown at T0. Note that at TO no data or other activity has taken place across these connections that were created preemptively. Also note that all GEMs illustrated could contain many other consumer and/or service endpoints (not shown) that could provide additional logical pathways beyond those shown in this simplified example.

Sometime before T1, GEM A determines that it will need services from GEM B, causing the data path between GEMs A and B to become active. GEM B processes the request, which in this case (based on user input, the state of the virtual world, or other factors) causes GEM B to request services from GEM F, which processes a loop involving GEMs G and E. This causes GEMs F and G to be created and establishes the loop's data paths between GEMs F, G, and E, as shown at T1. At T2 the loop processing between GEMs F, G, and E had been taking place for some time. At some point between Tl and T2, CO-ED determined that the connections between GEMs A and B, A and C, and between B and F have not been used for some time and dropped those connections. Sometime after the connections were deleted but prior to T2, CO-ED determined that GEMs A, B, and C were no longer relevant and deleted them from the system. This leaves the logic tree at T2 reduced to just the GEMs that are participating in the loop being processed.

At T3, GEM F determines that the loop processing has completed and, based on the current conditions, exits the loop, and invokes services from GEM H. This causes GEM H to be created along with the connection between GEMs F and H. Finally, at T4, GEM H has requested services concurrently between itself and GEMs J, K, and L. Sometime between T3 and T4, CO-ED removed the inactive connections between GEMs F, G, E, and H, and deleted GEMs F, G, and E, which were no longer being used. This behavior is similar to the transition between T1 and T2. The resulting state at T4 is a logic tree that only consists of the relevant GEMs currently being used by the system.

It is important to note that the example of FIG. 5 is true polymorphic behavior and not just a simple matter of keeping only the relevant sections of a logic tree in memory. For example, given the same starting conditions, the logic tree at TI could be completely different if GEM A had requested services from GEM C, rather than GEM B. That is, GEMs F, G, and G might have never been created, and GEM C might have invoked GEMs M, N, and P (not shown). Also consider that GEM A could have other consumer endpoints (not shown) besides those linking to GEMs B, C, and E, which might have been invoked based on subtle changes that might have occurred between the initial conditions and early processing by GEM A. Furthermore, because most GEMS are editable, a specific GEM's behavior could be modified for a particular user or organization, which may result in a completely different logic tree evolving from similar conditions.

Also consider that CO-ED is responsible for resolving which GEM should be used based on the service name or ID that is requested by a consumer endpoint. Therefore, CO-ED is free to substitute a compatible GEM that provides the same or similar service as those shown above. For example, at T3 at the end of the loop processing, CO-ED could substitute a compatible GEM for GEM H, say GEM Y (not shown) providing that GEMs H and Y each had a service endpoint that provided the same type of services. If GEM Y is substituted for GEM H, then the connections shown at T4 may be completely different. Substitutions such as this can occur based on the condition of the world (e.g., is it raining?), the skill of the user, the requirements of the application, and more including which services are already loaded. In some cases, substitutions like this could be made by random choice, though the overall polymorphic behavior is largely driven by user activity and based on conditions in the world and state of the system.

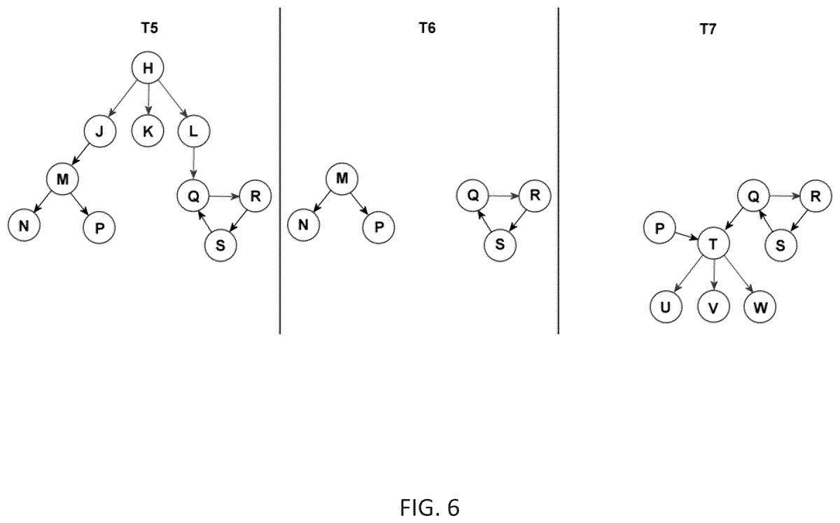

To continue the example of FIG. 5, FIG. 6 is a diagrammatic illustration of how CO-ED and GEMs operate as a polymorphic logic tree, in accordance with embodiments of the present disclosure. In particular, FIG. 6 illustrates the polymorphic logic tree splitting into isolated logic trees within the same delegate space, then recombining. A polymorphic logic tree is capable of splitting into multiple independent or isolated logic trees, or isolated logic trees are capable of merging into a single logic tree. This behavior commonly occurs with autonomous micro-simulators, which are typically isolated, but frequently overlap with each other's domain.

FIG. 6 shows how a polymorphic logic tree can split into independent logic trees. States T5, T6, and T7 in FIG. 6 are a continuation of states TO through T4 in the example of FIG. 5. At T5, conditions in GEM H cause GEMs J and L to both become relevant (GEM H requests services from both GEMs J and L). As a result, GEM J requests services from GEM M, which causes GEMs N and P to be created preemptively. Also, GEM L requests services from GEM Q, which creates and executes a loop consisting of GEMs Q, R, and S. These two branches can be thought of logically as occurring concurrently. In practice, they could be executing concurrently on a multi-threaded system, or their execution could be multiplexed (timeshared) on a single thread. It is also entirely possible that one or more of the GEMs involved could go dormant for a period of time. However, in terms of polymorphic topography of the logic tree, each branch (GEM J and GEM L) can be thought of as having relevance concurrently.

At T6, GEMs H, J, K, and L have fallen out of relevancy; were disconnected by CO-ED and, at some point in time before T6, the unused GEMS H, J, K, and L were destroyed by CO-ED. The remaining GEMs that still have relevancy (and therefore have not been destroyed) form two isolated logic trees; one tree consists of GEMs M, N, and P; the other logic tree consists of the loop formed by GEMs Q, R, and S. These two logic trees are isolated from each other, function completely independently, and share nothing in common other than the same CO-ED delegate space that forms the polymorphic infrastructure. How and why two isolated logic trees formed is entirely up to the GEMs involved; neither CO-ED nor any other system components prompt this behavior. Any number of isolated logic trees can and will form in this self-changing fashion; large virtual worlds with many GEMS representing simulators, tasks, and objectives can form hundreds to thousands of isolated logic trees in one common delegate space.

Isolated logic trees like those shown at T6 can also merge into a single logic tree depending on how the GEMs choose to connect themselves. An example of this is shown at T7. GEM Q exits the Q, R, and S loop and requests services from GEM T. At or about the same time, GEM P also requests services from GEM T. At this point the two isolated logic trees seen at T6 are a single logic tree. At some point in time after T7, GEMs P, Q, R, and S may become irrelevant and be destroyed by CO-ED, leaving just GEMs T, U, V, and W, which have little similarity to the two logic trees at T6 from which they were formed. Isolated logic trees can exist as a large network of GEMS, or as nothing more than a single GEM performing an isolated task. It is also possible for an isolated logic tree to decide its task is done and take itself out of relevancy (essentially destroying itself).

The possible combinations of how GEMs polymorphically arrange themselves arc nearly endless and to a large degree unpredictable. This virtually assures no two user experiences will be identical, but it is noted that user experiences could be identical, as may be dependent on the intended design. The primary benefit of a polymorphic logic tree is that it is capable of rendering behaviors that were not foreseen by the original programmer or publisher. Additional benefits of a polymorphic logic tree include the ability to trim the active tree to only nodes that are currently relevant. This reduces load on the system and inevitably allows more users per instance of the user experience.

Services, and the GEMs that provide them, can be diverse. In addition, each GEM typically provides more than one service. Usually, multiple services provided by a GEM are related to each other, though they do not have to be. Services are also diverse in terms of data or information that is passed across the delegates. This can be anything from bulk data, such as 3D assets, to operators and operands (i.e., command/control), events, and more. The core architecture can also support services and data types that were not foreseen or defined at the time the software was published, allowing users to create novel services and experiences.

Some services are invoked at the start of a digital video experience even in an empty world. These are typically high-speed services that interact directly with the underlying 3D engine, which can include but are not limited to rendering a sound, playing an animation, monitoring an event, or performing basic time keeping. High speed services are generally needed for future actions; they are set as default when the world is created and configured to remain in memory even if their delegates are disconnected for a prolonged period of time. Some services can also generate events, which are typically broadcast via multi-cast delegates. Example of events are notification that a specified amount of time has passed, notification that a user entered or left the world, signaling any major event that multiple nodes might have interest in, such as an explosion that occurred in the world, etc. An event can be forwarded or passed on to multiple nodes. Events can also be used to provide a deferred return value. For example, a service runs a sound then notifies the requesting node after the sound is completed.

Services are provided by GEMs, which can be functionally divided into classes based on their primary usage. The classes of GEMs include (but are not limited to) autonomous micro-simulators; act of God; intelligent queues; objectives; competency measures; cohort; volumes; and generic. Because interpreted GEMs can be edited outside of the platform and stored in a remote database for download at any time, users could potentially create novel GEM classes.

Autonomous micro-simulator GEMs are associated with each building, tool, piece of equipment, volumes, or any other actionable or animated asset added to the world. Autonomous micro-simulators use polymorphic logic to communicate with other micro-simulators and their environment where necessary. Micro-simulators are tied to the characteristics of an entity of interest and are tagged to the entity of interest. Micro-simulators not only eliminate the need for any central simulator logic, but also allow faster execution by only including simulator elements for items that are spawned in the world. In addition, the concept of autonomous micro-simulators allows the level of functional detail for each autonomous simulator to be changed in real time as needed based on the scenario. For example, a micro-simulator for a chain saw in an unused state might only monitor passive aspects of the chain saw, like being exposed to excessive heat. When the chain saw is started, an extension to the micro-simulator GEM is loaded that manages fuel consumption, engine temperature, emits engine sounds, etc. When the chain saw's engine is throttled up and the blade is pressed against a surface, an additional extension to the GEM micro-simulator is loaded that manages the effects of the active blade against the surface.

All action in user-facing applications is tied to the objects that the user interacts with. Objects talk to each other through the micro-simulators (via delegates) and the micro-simulators decide what action to take based on the properties of the other micro-simulators. For example, if a liquid leaks from a container and runs downhill to a fire, the fire micro-simulator queries the liquid micro-simulator for its properties such as flammability. If the fluid micro-simulator communicates it is water, the fire could be extinguished depending on the water's physical relationship to the fire. If the fluid micro-simulator communicates it is gasoline, the fire ignites the liquid. Micro-simulators collectively manage the exact state of the world in great detail. Individually, micro-simulators only manage the assets or objects they represent based on the simulator behavior and the state of their local environment. They may also interact with other micro-simulators that overlap their domain using CO-ED. The interaction between micro-simulators via CO-ED produces a virtually unlimited number of possibilities, states, or outcomes. This differs from traditional fixed behavior trees, which are limited to only generating outcomes that were foreseen by the programmers or publisher.

To understand how the interactions between micro-simulators across CO-ED's polymorphic network can produce unforeseen results, consider the following exemplary scenario, which is improbable but possible:

Example Scenario: User A is on a fantasy quest hunting venomous squirrels that have been plaguing the area. User B is part of a training cohort several kilometers away on higher ground, which is training on the use of chain saws. User C is part of a cohort socializing near a campfire somewhere on a slope below the User B cohort. All three users share the same world as well as the same delegate system, yet each of the micro-simulators around them operates only in the local scope and are effectively isolated from each other.

User A fires a gun at a venomous squirrel. The projectile has a micro-simulator that tracks the projectile's path as well as any items it strikes. The projectile misses the squirrel and continues into the distance with its micro-simulator tracking its speed and velocity. Several kilometers away, the projectile strikes a gasoline can near the User B cohort, which is being used to refuel chain saws. The projectile's micro-simulator recognizes that it has struck an object, then notifies the object's micro-simulator that it has been hit, giving the gasoline can's simulator the speed, velocity, and force with which it had been struck.

The gasoline container micro-simulator wakes from dormancy, then calculates that the force was sufficient to penetrate the can: it creates a hole in response. A simulator for the fuel in the can is also woken from dormancy, and with insufficient oxygen to effect combustion, resorts to using a fluid extension to its GEM to simulate and manage fluid leaking out of the gasoline can.

The fluid simulator for the gasoline trickles the stream of fuel down the slope, where the fuel encounters the campfire. Upon encountering the flame, the fuel simulator determines that it should ignite, causing flames to race back up the slope. When the flames contact the fuel can, the fuel simulator in the can now has enough oxygen to trigger an explosion, then the fuel container explodes.

When all the effects settle, the User C cohort moves away from the fire and looks for a more peaceful place to socialize; their actions are unexpectedly driven by the fire. The User B cohort transitions from training on chain saws, to first aid and emergency response training; they train to respond to unexpected explosions, much like they would in the real world if a similar training incident were to occur. User A is unaware of the events resulting from the last shot and simply looks for another venomous squirrel to target.

This exemplary scenario illustrates how the polymorphic interaction of GEMs across CO-ED can allow virtually any chain of cause-and-effect events to occur in a virtual world. With traditional fixed logic trees, the entire sequence of events outlined above, along with the conditions that needed to be in place for it to happen would have had to been included in the logic tree. Furthermore, the exact set of conditions, circumstances, and cohorts involved that happened to be placed geographically in the world as described above, including the stray shot that started it all, would be so incredibly rare that even if it were foreseen by a programmer, it would not likely be included due the chances of it occurring being extremely remote. However, the interaction of simulators capable of interconnecting polymorphically can allow virtually anything that could occur in the real world to occur in a virtual world.

Many of the micro-simulators involved in this exemplary scenario change state after the events settle in a fashion that preserves the state of the virtual world for any future events. For instance, the bullet that started the chain reaction comes to rest somewhere in the world, after which its micro-simulator goes dormant. The bullet is not necessarily removed from the world, though it could be replaced by a ghost actor to reduce system overhead. Spent projectiles could still have relevance depending on the scenario. For example, a spent projectile in a virtual crime scene has relevance for any investigators of the crime in one of many scenarios, such as training crime scene investigators or supporting a fantasy sleuth quest. After the fuel can explodes, its micro-simulator is decommissioned and replaced by a projectile simulator for each piece of shrapnel resulting from the explosion (which in turn could overlap other simulator domains with consequences). After the shrapnel settles, the shrapnel simulators are decommissioned and replaced with a generic debris simulator, which quickly goes dormant. The fire simulator continues to operate until all fuel is expended, at which time the fire micro-simulator is decommissioned. Note that the fire's fuel is not limited to the gasoline that initially spreads the fire: local brush, dry grasses, etc., could also serve as fuel.

This polymorphic transitioning of micro-simulators after interaction with other simulators not only reduces system load for actors that become less relevant, but also preserves the state of the world and provides continuity should any of the preceding chain of events have an impact on future occurrences in the world. This level of realistic cause and effect is not possible with fixed logic trees and action sequencers used in traditional video games or simulators. Furthermore, the polymorphic interaction between micro-simulators over CO-ED is ideally suited for test and research simulators commonly referred to as ‘digital twins’.

A digital twin can be thought of as a virtual representation of a physical asset, person, or process that can be used as test case for its counterpart or “twin” in the real world. For example, building planners might create a digital twin of a proposed factory to determine if any production bottlenecks or other issues exist in the proposed layout. Currently, digital twins have limitations in what they can predict based on what the creators of the digital world foresaw or what historical data reveal about the twin. However, using the polymorphic logic trees created by interaction between micro-simulators, a digital twin could reveal bottle necks, safety issues, waste, and a host of other issues that were not foreseen by the creators of the digital twin.

In the platform, virtual environments are discretized into volumes that encapsulate objects, containers, buildings, vehicles, characters, spaces, and any other actionable artifacts in the environments. Each volume has an inventory of artifacts and characters that should be in the volume, or that enter or leave the volume. The volumes can be created to reflect danger zones around artifacts and spaces, referred to as threat and vulnerability zones. For example, a vehicle will have a volume that is sized dynamically based on its speed and stopping distance. If a pedestrian character crosses a street and the character volume crosses into the vehicle volume the character will be impacted by the vehicle. Threat and vulnerability zones can also be used to determine if a user is aware of any risks, they place themselves in, and to evaluate their competency in terms of staying out of harm's way. Interactions with objects, spaces, etc. do not have to be explicitly programmed in the platform but happen organically based on information contained in GEMs and databases about the volumes, artifacts, spaces, characters, etc.

Act of God GEMs describe natural events such as weather, earthquakes, floods, or random events. Acts of God can influence other GEMs, such as autonomous micro-simulators. For example, transporting goods in the rain might require a different set of rules than transporting the same goods in clear weather. Intelligent queue GEMs list objectives to achieve a desired activity outcome. The lists can be ordered or unordered and can also be nested. Objective GEMs are lists of actions that are met, not met, graded, or pre-requisites for user actions in an activity. In avatar mode the objectives are met by the human user. In NPC mode, the objectives control the NPC in executing the desired activity. This dual usage of objective GEMs allows any objective that can be performed by a human to be performed by an NPC. This allows any NPC to step into a task or even take over a task from a human user. This dual-usage aspect of objective GEMs also allows NPCs to demonstrate how to perform an objective assigned to a human user, as might be the case of on-the-job training or to provide custom tutorials on demand. Competency GEMs measure how well objectives are completed by an avatar or NPC. Cohort GEMs spawn with the world at the top level and decide what cohort a user is in and can serve as a filter for objectives. Generic GEMs are any GEMs that do not fall into the descriptions or categories listed herein.

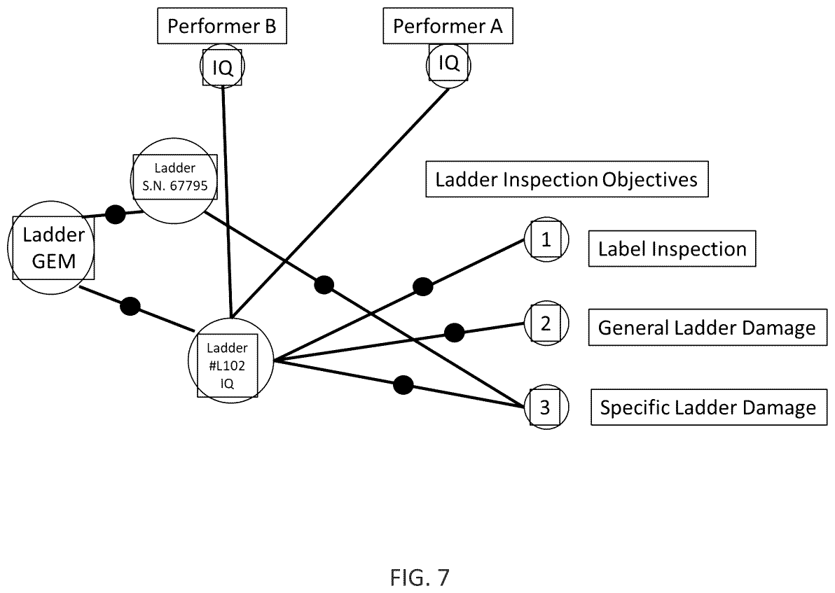

With regards to intelligent queue GEMs, FIG. 7 is a diagrammatical illustration of an example of the CO-ED system where intelligent queue GEMs are used for inspecting a ladder, in accordance with embodiments of the present disclosure. As shown in the example of FIG. 7, users A and B have specific tasks to perform to inspect a ladder before using the ladder. A GEM for ladders launches content for a specific type of ladder, e.g., ladder #L102, for example, an extension ladder. The ladder GEM also launches the content for a specific extension ladder, e.g., ladder serial number 67795. The intelligent queue requires the users to inspect the labels on the ladder and look for general damage that would be common to all extension ladders. This is represented by nodes 1 and 2. The intelligent queues also require the users to inspect the specific ladder for damage, as indicated at node 3. The platform records whether each user performed each task correctly and how long each step took. The information is recorded in databases and competency GEMs are invoked to assess user performance. The adaptive behavior cycle can also be invoked based on results from the competency GEM to alter the scenario the user is experiencing to make it more or less challenging or introduce a different challenge or experience.

It is noted that GEMs automate loading graphical assets, simulation code, and interactions within a virtual video experience. Animation of characters and graphical objects also require procedural automation using the equilibrium animation system in the platform rather than having to pre-define animation sequences for a nearly infinite number of motions in endless virtual environments. In a typical video game or simulator, the virtual world is populated with actors. Actors are code objects that are spawned at a specified location in a virtual world and typically represent an object (such as a rock, a building, a vehicle, etc.) or an effect (fire, smoke, lighting, etc.). Actors may or may not be rendered as determined by the state of the world, if a camera is viewing it, and if the actor represents a visible object. After an actor has been spawned in a world, it requires a certain level of maintenance by the platform. This can include but is not limited to invoking the actor's tick function every frame, calculating the actor's collision characteristics, updating the actor's physics properties, and managing optimization tasks, such as determining if the actor should be culled from a scene if is not in a camera frustrum. The level of maintenance that is required for an actor can vary depending on the actor's type and constraints. For example, static actors (actors that cannot move or be modified in a user session) require less maintenance than dynamic actors (actors that can be moved, deleted, etc.). All actors require some level of computational maintenance or processing periodically.

In most implementations of virtual worlds, the placement of each actor is typically defined at the time the map asset for the world is created. Exceptions to this might include actors that are spawned after the world instance is initialized (such as characters, vehicles, etc.). This can occur when the exact number and types of these actors was not known at the time the world map asset was created or edited. Even in these cases, the map asset typically includes placeholder actors to define where their potential counterparts should be spawned. The placeholder actor requires less maintenance, but it is still an entity in the virtual world that needs to be defined and managed. In addition, the placement of placeholder actors must be defined at the time the world map asset is edited and does not provide for cases that were not provisioned at the time the world was edited.

In the subject platform, the polymorphic characteristics of GEMs and CO-ED could require actors to be spawned in the virtual world that were not considered at the time the world map was authored. For example, an intelligent queue GEM that defines a treasure hunt quest will require that a treasure be placed somewhere in the world. In a traditional game, the map author would need to pre-define all the locations where the treasure might be hidden and would typically mark all those locations with a placeholder actor. This results in many placeholder actors scattered across the virtual world, and also limits the experience. That is, if a user plays the scenario enough times, the user will know where all the potential hiding places are, and the experience loses its mystery and challenge. Furthermore, if no one loads the treasure hunt experience, then the map asset is essentially polluted with unneeded placeholder actors for the treasure.

The platform resolves the above issues using a lightweight data structure or class referred to here as a ‘ghost actor.’ A ghost actor does not reside on the map asset; it is a set of metrics that can be loaded from an external database that defines the actor characteristics. These characteristics can include which asset (e.g., mesh, particle effect, light, etc.) should be used to represent the actor, what autonomous micro-simulator should be used with the actor, as well as additional information that might be required to spawn the actor, such as where it should be placed in the world, how its shaders should be set, etc.

Because the ghost actor is defined in a block of data only and is not defined in the virtual world, the system can modify parameters as needed prior to spawning. For example, a treasure ghost actor in the treasure hunt quest example above could list multiple places that the map author thought would be good treasure hiding locations. In addition, the ghost actor could also specify that locations could be in any container that is large enough to hold the spawned actor (this can be accomplished by querying a list of container simulators in the virtual world). Finally, the ghost actor can reference a GEM that actively searches for hiding places in the world. This allows for an unlimited number of hiding places available for the treasure. This approach would also allow the location of treasures in past quests to be tracked on a per-user basis and guarantee that the user never finds the treasure in the same place twice regardless of how many times the quest is pursued.

The use of ghost actors also allows a virtual world to be authored with broader scope. A virtual world could be authored with minimal actors placed in the world accompanied by a list of suggested ghost actors that provide more detail to the world that are consistent with the world's motif, such as should a fence be a midlevel stone wall or a modern chain-link fence. If a minimal world is required for a scenario, the details represented by the collection of ghost actors can be omitted. Likewise, if a scenario requires a lot of detail in a busy world, all the ghost actors providing detail can be spawned. As such, the same world can be used for little more than forest, meadows, and streams for a hunting quest, versus the same landscape populated with villages, roads, and bridges.

Ghost actors can support autonomous micro-simulators for their actor counterparts even if the actor is not spawned in a session. For example, consider a small shop that is powered by a generator in a shed some distance from the building. The generator is not seen by a camera and therefore does not need to be spawned in-game. However, the generator still needs to provide power to the building. The ghost actor launches the generator simulator, which communicates with the building simulator to determine how much power is being drawn. The generator simulator then calculates when it will run out of fuel, asks a timekeeping service to wake it up at a specified timestamp when the fuel is expended, then goes dormant. The generator remains dormant until the specified timestamp when it runs out of fuel occurs and it cuts power, or when it is notified by the building that its electrical load has changed. If the load changed, the timestamp for when fuel is expended is updated, then the generator again goes dormant. Under these conditions, the generator performs all its tasks managed by its simulator even though there is no generator spawned in the virtual world.

Ghost actors are typically maintained by or referenced from the dynamic octree. However, any GEM, such as a micro-simulator or an intelligent queue can reference ghost actors and when their actor counterparts are spawned in-game. For example, a door simulator referenced by a door ghost actor in the dynamic octree might reference additional ghost actors representing child objects of the door, such as a latch and/or lock.

Ghost actors can be spawned or destroyed on demand, thereby reducing the system overhead. For example, if a user approached the shed housing the generator in the previous example, the generator's simulator might spawn an effects actor to generate an exhaust effect from the building's exhaust stack (based on an exhaust ghost actor maintained by the generator's simulator). The simulator may also produce sounds created by the generator. If the user enters the building, the generator ghost actor will spawn the generator itself, at which time the simulator for the generator will begin managing visible controls, indicators, and gages for the generator as well as animate any visible moving parts. The user is also free to interact with the generator at that point, such as shutting it down or starting it up. When the user leaves the building, the generator actor in the virtual world is destroyed but its simulator remains active. When the user leaves the area, the generator exhaust effects and sounds are destroyed. With this method, thousands of simulators can be active in the world and interact with one another without the overhead of spawning and managing their associated actors in the virtual world when they are not observed. This efficiency is important for optimizing the platform for large-scale multi-user streaming.

Ghost Actors do not have a presence in the virtual world; they only have a definition for an actor that may or may not be spawned in the virtual world. As such, tracking the locations of ghost actors at any point in time requires a process that is independent of the virtual world. Ghost actors can also potentially move, which may not be reflected in the virtual world if their actor counterparts have not been spawned but must be considered in relation to other tracked locations. In addition, movement or placement of ghost actors may require knowledge of other actor placement(s) in the virtual world that are not represented by ghost actor counterparts. The same holds true for locations that might be referenced by simulators or GEMs that have neither actors nor ghost actors associated with them whatsoever. To resolve these issues, the current invention uses a dynamic octree, which allows tracking locations and movements of these elements outside of the virtual world.

An octree is a search tree for 3D spaces that provides quick resolution of which actors in a world overlap at a specified point or are within a specified distance of a point. This is accomplished by dividing the virtual space into successively smaller nodes, which are searched in a fashion like a binary search tree projected into 3 axes. This provides a more efficient means to determine which objects are nearby than alternate approaches, such as iterating through the entire list of all actors in the world and calculating their distances to determine which actors are within a specified distance of a point. The dynamic octree tracks octree interface objects, rather than actors. The interface object allows tracking of heterogeneous elements, such as actors, ghost actors, GEM position references, etc. The interface element contains a copy of, or pointer to, information of interest to the octree, such as location and extents, where applicable.

In addition, the interface elements provide services for various events. These events include movement events sent to the octree and scope events that are sent from the octree. Movement events are sent to the octree via the interface from the entity in motion. If an actor in the virtual world moves because of physics interactions, the object generates a movement event, which alerts the dynamic octree that the position of a tracked item has changed. The dynamic octree responds to the event by comparing the new position to the old position to determine if the object has moved out of its current node. If the object remains in its current node no further action is taken. If the object moved out of its current node, the dynamic octree will rebuild the nodes in question to update the octree accordingly. Typically, the dynamic octree only tracks interfaces that are capable of moving or do not have a permanent actor in the world. Static actors present in the virtual world are typically tracked using an octree in the underlying 3D engine; this approach reduces the time required to build nodes in the dynamic octree because static actors do not need to be considered.

Dynamic octrees can be nested. That is, a dynamic octree can contain another dynamic octree, which itself could contain another dynamic octree and so on to an arbitrary nesting depth. This allows smaller congested areas of a virtual world to be partitioned into successively smaller octrees. This approach reduces the overall number of objects tracked per octree and further improves the time required to rebuild nodes when an object moves. That is, if an object moves in a nested octree, only nodes in the nested octree need to be rebuilt; the parent octree will not be affected unless the motion in question causes the tracked interface to leave the nested octree.

Use of nested octrees does not need to be limited to congested areas. Nested dynamic octrees also provide an optimization for small groups of tracked objects that move in a local region frequently or even continuously. For example, consider an amusement park carousel with eight horses. Each horse continuously moves in a circle as the carousel rotates. Assigning the carousel to its own nested dynamic octree allows rapid rebuilding of nodes, since only eight objects need to be considered. The parent octree will not receive movement events for the horses in the nested octree and therefore takes no action as the horses relentlessly travel their circular paths.

Another event type associated with dynamic octrees are scope events. Dynamic octrees are typically queried by characters to get a list of objects that are within a specified distance. Octrees can also be queried by non-character entities, such as simulators or objective GEMs. When a tracked object is added to a returned query list it falls in scope for the entity performing the query; when the object is removed from a returned list it falls out of scope. Scope events are typically generated by the octree when an object changes scope with respect to a query. These scope events are sent to both the entity that generated the query as well as the object that fell in or out of scope. A typical use case for scope events is to control when a ghost actor should spawn its actor counterpart in the virtual world and when it should destroy that actor. Another use case is to determine when an actionable item is close enough to an avatar to determine if it should be added or removed from the avatar's user interface (UI) list. Scope events can also be used to control when physics should become active or inactive, or when the domains of a micro-simulator overlap that of another.

Realistic falls from height, slips, and trips are difficult to accomplish in video game graphics because of the use of collision capsules that surround characters and prevent characters from penetrating surfaces or bodies. The steppingstones balance system and the equilibrium animation system methods implemented in the platform use center of gravity calculations for characters to determine at what point a character may fall or lose their balance and uses mathematics to determine when a character mesh leaves a collision capsule and realistically animates a fall, slip, trip or recovery of balance. The steppingstones system can be used to calculate musculo-skeletal stress areas on a skeleton and can transmit information to the platform to calculate cumulative stresses over time on a character.

In a traditional video game or simulation, each character is encapsulated in a collision capsule that is used to detect if the character has collided with a wall or the floor. This system is used widely in the gaming industry because it is efficient in terms of computational resources. The same system is used in the platform for the same reason. For most circumstances this system works well and is used in the platform for typical cases. However, the equilibrium system method described herein augments this system by allowing a character to fall out of its collision capsule when the character is out of balance.

The equilibrium system detects when a character is out of balance by calculating the character's center of gravity based on the relative positions of each limb segment. The center of gravity is then projected to the ground based on forces acting on the character (gravity, wind, etc.) as well as inertial forces established by momentum. The equilibrium system also establishes a construct referred to as a balance box, which is a rectangle that encompasses the extents of the feet. If the center of gravity projected to the floor is outside of the balance box, then the character starts to fall over. This is referred to as an Out of Balance (OoB) condition.

If an OoB condition is detected, the equilibrium system will try to compensate by blending into the current animations one of several recovery poses. These poses might be moving arms, legs, hips, etc., into natural positions that a real human might use to compensate for a near fall. The poses are blended dynamically based on degree of imbalance, and therefore are never static. This creates a pseudo-animation that is blended with the current animation. After these correction poses are applied to the character, the center of gravity is re-calculated and again projected onto the balance box plane. If the center of gravity settles within the balance box, the character recovers from the near fall. If not, the character falls out of its collision capsule.

In typical video games or simulations, the exact foot placement in the environment is generally overlooked or ignored. This is generally because foot placement is determined by the locomotion animation and to take precise foot placement into account would require a large library of locomotion animations. The steppingstones system uses a narrow range of stock locomotion animations and distorts them as necessary to land a foot or hand on a specific target. This is accomplished by predicting where a foot would be placed under undistorted conditions, then calculating the amount the animation would need to be scaled or distorted in the XY plane (assuming a coordinate system with Z in the up direction) in order to hit the desired target. This results in natural leg movement to any point derived from a limited set of source animations. This also allows arbitrary foot targets, rather than imposing a requirement that any irregular walking surfaces need to be placed to accommodate the animation.

When the steppingstones system is combined with the equilibrium system's ability to animate attempts to maintain balance, a long or awkward step can be complimented with the appropriate arm and body movements for maintaining balance to produce a composite that appears natural and convincing. The composite animation is created by procedurally distorting a limited number of source animations to accommodate virtually any movement conditions.

Several versions of user interface (UI) mechanics can be used with steppingstones. For cases where exact choice of foot placement is critical, such as a puzzle game where stepping on the wrong stone releases deadly arrows, then the user can explicitly select which stone the next step should fall on. However, in most cases selecting each discrete footfall is tedious and distracts from the primary task. In these cases, steppingstones can select foot placement for the user providing that the user's attention is directed to the ground. If the user does not have their attention directed to the ground, the next footfall lands wherever the undistorted animation directs. This removes the tedium of selecting foot placement yet produces a realistic experience in the sense that they must pay attention to where their feet are being placed or risk falling. Another way of looking at it is that correct foot placement is implied if the user is looking at the ground. Using this implied UI mechanic, the user must balance their attention between foot placement and their primary objective (such as keeping eyes on an enemy).

The equilibrium system can also calculate musculo-skeletal stress based on how a user picks up heavy items. If a user just picks up an item, the avatar bends over, grabs the item, then returns to a standing posture to lift the item (implying using the back to lift). This creates unnecessary musculo-skeletal stress which is applied against the character's health and injury metrics. However, if the user directs their avatar to crouch before grabbing the item, then uncrouch to lift the item (implying using the legs to lift), less musculo-skeletal stress is applied to their health and injury metrics. For training applications, this UI mechanic requires an explicate crouch before picking up heavy items that consciously reinforces the need to lift with the legs when working in the real world.

The equilibrium system also manages realistic hand postures to grasp and manipulate objects and to communicate. All interactable objects have micro-simulators. When a character reaches for an object, the character's micro-simulator queries the object's simulator for any preferred hand posture and/or target location that should be used to pick up or operate the object. For example, when reaching for a toolbox, the toolbox simulator will indicate where the handle is and indicate an appropriate grip posture for the handle; when reaching for a button, the button simulator will indicate where the press surface of the button is and instruct the avatar to use an extended index finger to actuate it with. The returned posture is animated from a relaxed posture as the hand gets closer to the object. This produces a natural animation without the need to create a unique animation for each device the character can interact with. In rare cases where a more complex animation is required (e.g., turn and push), the object's simulator can return a custom animation, as opposed to just a posture. This system can also be leveraged to produce gestures or communicate in sign language.

The equilibrium system includes a reflex system for character heads and eyes. A line trace is computed from a noise or object location to a character. The platform calculates the distance to the object or noise and can inform the character of what made the noise, what an object is, how far it is. The character or NPC can then procedurally animate based on information about the noise or object.

To create realistic falls, slips, trips, and recovery of balance in the equilibrium system, a delay is required between the calculation of the character's center of gravity and the moment in time when the character realizes that the center of gravity has shifted to a point that requires recovery (or an attempt at recovery). This delay typically needs to be variable since a slip might take the character by surprise, but once alerted to the condition the character will have a shorter response time. Response time can also be impacted by the character's virtual health metrics, such as fatigue, exposure to chemicals, etc.

Rather than creating multiple delay loops for reaction times associated with balance, the equilibrium system uses a variable length circular timeline buffer that allows an infinitely variable delay for a single set of metrics. The timeline buffer stores sets of metrics (such as center of gravity offset vectors) that are indexed by timestamp. Typically, a high-resolution timestamp is used with a resolution of 100 nS or 1,000 nS. However, the resolution can be different depending on the situation. Each entry in the timeline buffer contains a timestamp along with the tracked metrics, which is stored in chronological order in the buffer. Note that although the timestamp resolution might be on the scale of 100 nS, the frequency of data points in the buffer can be spaced much farther apart and need not be uniform in terms of temporal spacing.

Metrics are read out of the buffer by timestamp. With 100 nS timestamp resolution, the timestamp of the metrics requested will seldom align with a stored data point. In the vast majority of cases, the returned metrics are interpolated between the closest set of metrics before the requested timestamp and the closest set of metrics after the requested timestamp. This provides up to 100 nS of resolution from relatively few data points. In the case of the equilibrium system, any amount of delay in the perceived location of the center of gravity can be returned from a single timeline buffer by just specifying the timestamp of interest.

A timeline buffer can be periodically trimmed to cull metrics with a timestamp older than the oldest timestamp of interest. For equilibrium, this may be times on the order of 2 seconds or so. When a timeline is trimmed, a timestamp is typically submitted as the trim point. In practice, the first data point and metrics prior to the trim point are retained to preserve the data point for interpolation purposes. If the future end of the timeline is trimmed, then the first data point after the requested culling point is retained.

Data points with their associated timestamps are typically stored in a circular buffer. The circular buffer allows memory that was used for culled data points to be reused for new data points. This eliminates the overhead required to reallocate memory every time a data point is created or destroyed. The physical circular buffer that the data points lie in can be dynamically expanded and shrunk as needed, though doing so requires memory reallocation and should be kept to a minimum where possible.

Timeline buffers can be an important optimization tool when predicting or calculating future events. Consider an example of a campfire in a virtual world. A fire is typically managed by a volume simulator GEM. The fire's volume defines not only where fire and smoke effects should be rendered, but also provides a temperature gradient describing heat radiated from the fire. Fire simulators are also sensitive to environmental elements, such as wind and rain.

Assume a campfire fire has been burning for some time and has burned down to little more than a coal bed with a few sparse flames. An avatar (user) or NPC decides to throw a log on the fire. The log initially has a minimal autonomous simulator GEM attached to it that defines little more than its mass and a few other properties, such as its density, temperature, and one or more core material identifiers.

When the log enters the fire's volume of influence, a combustible simulator GEM extension is appended to the log. The combustible simulator looks up the log's material indices to determine the combustibility of the substance (e.g., is it a rock, wood, steel, or dynamite, etc.). Then the combustion simulator uses the substance parameters to calculate a set of metrics that describe the burn characteristics of the log in question over time. These metrics include when the log will heat sufficiently to ignite, when the flames contributed by the log will reach its peak, and when the flames will die down. Also calculated are similar metrics for smoke density emitted by the log, as well as parameters describing the visual changes to the log as it burns, which will be used by shaders to change the log's appearance as it burns, is reduce to glowing coals, and inevitably reduced to ash.

Note that the above calculations only need to be performed for landmark events, such as when flames reach their peak, or when flames die down to glowing coal, etc. Therefore, only a limited number of calculations and data points need to be added to the timeline buffer at critical timestamps; this could be as few as 10 or so data points. Furthermore, these data points only need to be calculated once for the entire remaining life of the log (unless conditions change). The timestamp on these data points might extend an hour or more into the future depending on conditions. From the initial calculations forward, any detailed aspect of the burning log can be quickly looked up in the timeline buffer for any point in time (perhaps even every frame) without the need to re-calculate anything.

The optimizations offered by using timeline buffers allow accurate simulations of large-scale events that would be computationally prohibitive otherwise which would place limitations on multi-user cloud-streaming. Typically, large-scale events, such as wildfires or floods, are rare in simulations and in other traditional systems are generally scripted (i.e., not a result of cause and effect). As an example of the method described herein, consider a campfire built too close to several clumps of dry grass. The fire's volume extends to encompass the dry grass and falls within the domain of the grass simulator. The grass simulator is extended to include a combustion simulator, which creates a burn timeline for the grasses. That clump of grass is next to other clumps of grass, some of which are near logs, trees bushes, etc., as the polymorphic GEMs start overlapping each other's domain. The characteristics of each burnable item only need to be calculated once on initial contact with the fire as the fire gradually spreads across the virtual landscape. While there may be many burnable items adjacent to each other on a hillside, the number of calculations involved are minimal and not all data sets are calculated at the same time. When combined with prior art optimization techniques, such as suppressing visual effects that are not being observed by a camera, the invention allows a practical approach to large-scale disasters that is not just detailed and accurate in terms of cause and effect, but also computationally manageable for multi-user cloud streaming.

In a typical video game, NPCs tend to lack the subtleties of human behavior and often move around with an almost zombie-like persona. When personalities are artificially imparted on NPCs, they are generally defined by a behavior tree and quickly become predictable after the user gains some familiarity with them. NPCs linear behavior is typically invariant with respect to other NPCs or avatars (users).

Conduct AI is a unique artificial intelligence system that mimics human behavior by allowing NPCs to learn from and react to events that the NPC is exposed to in its virtual environment. Unlike most AI algorithms, conduct AI is not designed to be precise; it is designed to mimic human behavior including human flaws. There are several parameters that the algorithm is dependent on, which can be adjusted differently for each NPC. Some of these parameters, such as curiosity, attention span, interest, recollection, and memory acuity, apply to the core framework of the algorithm. Other parameters are specific to the AI application running on top of the framework. The AI application is code that provides support for specific classes of events that an NPC will investigate or react to. These AI applications can include support for events such as sounds, sights, tasks, character interaction, and more. A single NPC will typically implement multiple AI applications to provide behavioral coverage over a wide range of events.

The conduct AI system typically uses 2 or 3 memory stacks, though it may use any number of memory stacks depending on the AI application. The typical memory stacks are referred to as the short-term, long-term, and cold memory stacks. The depth of these memory stacks is determined by the memory acuity settings and can change from one NPC to the next. An NPC with higher memory acuity will have deeper stacks and is able to retain more information than an NPC with lower memory acuity (shorter memory stacks). Typically, short-term memory is the shortest stack and is used to learn from current events; it is the memory in which unsupervised learning takes place. The long-term memory stack is significantly deeper than the short-term stack and is used to store lessons learned; it forms a repository of the NPC's knowledge and, to a degree, personal history. The cold memory stack, which is optional (dependent on the AI application), is an extension of the long-term stack for old memories that are rarely used; it stores lessons the NPC had learned sometime in the past but has since forgotten or cannot immediately recall (like a password you haven't used for years). Additional memory stacks may be used by specific AI applications for specialized purposes, such as an indelible memory stack for infrequently used information that the NPC is not likely to forget, such as personal information like name, birthdate, etc., or a persistent memory stack for hard lessons learned that the NPC is not likely to forget.

The memory stacks are persistent across sessions and must be stored in a database or other repository when an NPC is removed from a game. When an NPC is spawned in a game, the short-term and long-term memory stacks are loaded from the database or repository. Typically, the cold memory stack is not loaded into active memory until or unless it is needed. This is not a requirement but more of an optimization: cold memory is not always needed, and it will typically take the NPC some time to recall items from cold memory by design, therefore an on-demand loading delay is acceptable. Depending on the AI application, a list of identifiers might be loaded from cold memory, giving the NPC a hint that it knew something about the subject matter at some point in the past.

Each entry to be stored in the memory stacks contains a timestamp, iteration counter, and a set of metrics that are specific to the AI application. For example, metrics for a sound AI application might include (but is not limited to) an identifier for the sound that was heard, an identifier for the object that created the sound (if available), an identifier for any action required (e.g., a chirping cricket requires no action; a fire alarm does), as well and any additional information that might be provided by the autonomous micro-simulator associated with the object creating the sound. Each memory stack entry is promoted to the top of the stack whenever its context is encountered in the virtual world; this makes recently used memories readily accessible and causes less frequently used memories to get pushed deeper into the stack.

When an NPC experiences an event (e.g., hears a sound or sees an object), it searches its short-term memory followed by its long-term memory to determine if it has any familiarity with the event. The long-term memory stack is not searched in its entirety; it is only searched to an arbitrary depth. The depth to which it is searched is biased by the NPC's recollection setting as well as several other factors. A higher recollection setting will result in the long-term memory being examined to a deeper depth before giving up the search. This depth may also be biased by other settings, such as curiosity and interest. The search may also be terminated if the timestamps of the entries exceed a specified age. Typically, the search is terminated before the entire memory stack is examined, even if no hits on the search event occur. That is, the NPC may not recall old memories as efficiently as it does recent memories.

If an event produces a hit in either memory stack, the memory is promoted to the top of the stack, its timestamp is updated, its iteration counter is incremented, and the metrics associated with the entry are examined to determine if any action should be taken, or if the event should be investigated further. Specified actions to be taken are typically stored as an identifier of an objective or intelligent queue GEM that contains action details (e.g., evacuate the building, duck for cover, etc.). If an action was specified, the action is acted upon by placing the action identifier in the NPCs objective queue. If no action was specified, the event is either ignored or possibly investigated further if the entry's metrics are incomplete.

If no hit was produced during the search of the short-term and long-term memory stacks, conduct AI enters an unsupervised learning mode. The learning process begins by creating an entry for the event at the top of the short-term memory stack with its iteration counter set to 1 and timestamp initialized appropriately. At this point the metrics associated with the event are incomplete and typically only contain an identifier of the event; that is, it lacks any contextual information associated with the event. In some cases, the learning mode is terminated at this point and the NPC is left with nothing more than a record that the event occurred but no context describing the event. However, depending on the current iteration count (1 in this case), settings for curiosity and interest, and the AI application in use, the NPC may choose to investigate the event to learn more about the event's context.

This describes the state of an entry at the top of the short-term memory stack for a new event that the NPC experienced for the first time. It is also very similar to the state of the top of the short-term memory stack for any event that the NPC previously experienced but is incomplete in terms of contextual information. The only difference between the two cases would be the iteration count. This could occur if the event produced a hit during the search of the short-term or long-term memory stacks (i.e., the event was experienced in the past) and the entry in question did not contain context information (i.e., the event was never investigated in the past). In this case the entry is moved to the top of the short-term memory stack (regardless of which memory stack it was found in) and its iteration counter is incremented. An NPC is more likely to investigate events with higher iteration counts (number of times it was experienced) than lower iteration counts. This is somewhat analogous to “There's that sound again, what is it?”.

If the NPC chooses to investigate the event, conduct AI will provide an objective GEM that instructs the NPC how to go about gathering the information needed to complete the metrics section of memory stack entry and thereby provide context for the event. The underlying system that generated the event has detailed data regarding the context of the event. A typical AI Algorithm would simply fill in the metrics with the context data available. However, the purpose of conduct AI is to mimic human behavior, therefore, conduct AI forces the NPC to physically investigate the event in the open world environment as if it were a human user who does not have access to the system's underlying data. This creates the appearance of human behavior as the NPC explores the virtual environment in much the same way a human would explore the real world. After the NPC investigates an event, conduct AI returns to its idle state and waits for additional events.

Some housekeeping operations may take place between events, some of which also contribute to the overall human-like behavior of conduct AI. Any short-term entries that get pushed off the end of the short-term stack or are past the short-term expiration time will be moved to the top of the long-term memory stack. The difference between short term and long-term memory is that when an event occurs short-term memory is searched in its entirety, where long-term memory is only searched to an arbitrary depth. This means entries in short-term memory are never forgotten or overlooked, but entries in long-term memory could be.

During housekeeping the framework will also verify that any newly created entries in the short-term stack do not already exist in the long-term stack or in cold memory (if implemented by the AI application). A redundant entry could occur in long-term memory if the search was terminated before the event was found. Cold storage is never searched in response to an event occurrence but could contain a very old record of the newly minted event. If a redundant copy is found, the AI application decides which version to keep. If the new version is retained, the old version is deleted. If the old version is retained, it is moved to the top of the short-term stack, its iteration count is incremented, and the newly minted version is discarded. Note that retaining the old version occurs too late to be of any help regarding the most recent occurrence of the event but will be in place should the event occur again. This has the effect of recalling an older memory sometime after the trigger event occurred. It is up to the AI application, based on any priorities recorded in the entry's metrics, whether to act on any actions associated with the event even if a significant amount of time has passed since the event occurred. This significantly delayed action might be analogous to realizing on your way to work that you left the stove on, and you turn back to mitigate the issue.

The discussion of conduct AI up to this point describes the core framework of the system with references to the AI application in a generic sense. To get an understanding of how the conduct AI framework produces human-like behavior it is necessary to examine a few specific AI application implementations and how the application layer works with the framework to produce these behaviors.

A simple AI application for sound events can be implemented that does little more than prompt the NPC to look in the direction of a newly experienced sound to determine what might have created the sound. This does not mean that all NPCs constantly look toward sounds each time a sound occurs; such behavior would seem as artificial as an NPC that just stares into space. If the NPC successfully recalls hearing the sound in the past and the recalled memory provides full context of the sound, then the NPC will either ignore the sound or take any action that is specified in the recalled record if action is required. However, if the sound is not successfully recalled or the recalled record is incomplete, the NPC may choose to investigate the sound.

If a sound event has never been experienced before, the short-term memory stack entry will contain nothing more than a unique identifier for the sound. If the NPC chooses to investigate the sound, it will look in the direction of the sound then draw a line or spherical trace in that direction, which may or may not intersect one or more objects. If no objects are returned by the trace within a reasonable distance (e.g., a distant gunshot), the source of the sound remains a mystery and the sound's context is left unresolved.

If a single object is returned by the trace, the autonomous simulator for that object is queried for an object identifier as well as any suggested actions that should take place when the sound is heard and any other contextual information the simulator has to offer. The results of the query are stored in metrics of the memory stack entry to provide a context for the sound. Note that this may or may not be the correct context. For example, if an NPC hears a cricket hidden behind a toaster and the line trace returns the toaster (i.e., the toaster blocks the line trace to the cricket), then the NPC might incorrectly assume that all toasters chirp. The NPC will then harbor an ill-conceived concept of toasters until or unless a successive encounter with a cricket refines the context of the sound. This incorrect assumption represents another type of human error that is indigenous to the conduct AI system. It is also entirely possible that the AI application for a very inquisitive NPC might move the toaster to verify that the sound is in fact coming from the toaster and subsequently discover the cricket.

If the trace retuned a single object and a query of its simulator reports that it is a container (such as a cigar box, drawer, cabinet, etc.) then the NPC might open the container and draw another trace into the container to identify the source of the sound. This behavior will depend on the NPC's curiosity and/or interest settings, as well as whether the NPC is currently engaged in a higher priority task. If the trace returns multiple objects, which can occur if small objects are involved at longer trace distances, then the AI application will direct the NPC to move closer to perform another trace. By moving closer, the trace will have better resolution in resolving objects and will return less ambiguous objects. This process is repeated until a single object is returned or the investigation is abandoned.

The AI application plays a significant role in deciding when or if an NPC should investigate an event based on the NPC settings and several generalized conditions. For example, the AI application will be more likely to investigate an event if the event's associated iteration counter indicates that it is a frequent event. Conversely, an AI application will be less likely to investigate an event if the NPC is flooded with many similar events concurrently. This prevents rubbernecking in noisy environments or where a lot of moving objects are present, such as a crowd. This responsibility is placed on the AI application layer to allow different behaviors and priorities to be assigned to different classes of events. For example, movement of an object toward the NPC carries a higher priority or urgency than a sound event.

To understand how conduct AI and its AI application layers produce human-like behavior, consider the following hypothetical example where an experienced NPC named Frank exhibits different behavior than an inexperienced NPC named Bob. This example focuses exclusively on sound events managed by a relatively simple sound AI application:

Frank sits at a table in the break room of an office building. He is flipping through a magazine as an idle animation. A copy machine nearby is making noise as it generates copies. Frank ignores the copy machine; he is familiar with the sound, and it requires no action. A small fan whirs on a countertop as it circulates air in the breakroom; Frank also ignores this sound because he has heard it before and has identified it. Footsteps can be heard coming from an adjacent hallway. Frank looks up to investigate the sound; he is familiar with footsteps and knows they are produced by a character (either another NPC or a human-controlled avatar). However, the action specified with Frank's context of the sound directs him to identify the specific character that is producing the footsteps. Moments later, Bob enters the breakroom. Frank draws a trace to Bob, queries his simulator, and retrieves his identity; Frank now understands that the footsteps are caused by an NPC named Bob. Having fulfilled the action of defining the identity associated with the footsteps, Frank returns his attention to the magazine and resumes his idle animation. The sequence of actions happens organically in the platform. In traditional video games or simulators, this sequence would be pre-specified with a fixed decision tree or behavior tree.

When Bob enters the breakroom, he hears the copy machine running, then looks to the machine to investigate the sound. After creating a context for the sound and associating it with the copy machine, Bob turns his attention to the other sound in the room, the fan. A coffee cup is near the fan and Bob's trace of the fan returns both the fan and the cup. Bob moves closer to the fan and cup until his trace resolves a single object, the fan. Bob then creates a context for the fan sound and has a concept of what causes the sound.

A phone mounted on a nearby wall rings, both Bob and Frank look at the phone. Bob looks to the phone because he is unfamiliar with the sound and his AI application and settings prompted him to investigate it. Frank looks to the phone because he is familiar with the sound and the action that is associated with the sound's context is that someone needs to answer it. Frank is responding to an action associated with the sound; Bob is simply investigating the sound. Based on the objective associated with the sound, Frank gets up, walks to the phone, then answers it.

In a traditional video game or simulator, the above sequence of events would have been scripted by fixed behavior trees, cutscenes, or a combination thereof. Furthermore, a traditional implementation for NPC behavior could not consider an unlimited number of sound conditions that might exist in the breakroom and would need to be limited to one of N scenarios. Furthermore, in a traditional implementation Bob would remain forever ignorant of the sounds he is reacting to. Using the conduct AI system, Bob will respond differently to the same sounds in the future because he now possesses a concept of what the sounds are; he has learned the sounds by examining his environment.

The exemplary scenario with Frank and Bob produces reasonable human-like behavior to the point where an observer could determine that Bob has less experience with the environment than Frank. In this example, for the platform, this human-like behavior is based on sound events alone. The human-like behavior of NPCs can be further improved by adding additional AI application layers that take other event classes into account.

Another class of events that can be managed by an AI application layer is sight. Humans and other creatures in the real world tend to have their attention drawn toward movement that enters their field of view. This is particularly true for peripheral vision where visual acuity is low but sensitivity to movement remains high. The dynamic octree in the platform tracks the movement of objects in order to reconstruct the tree modes whenever objects move. This movement can be used to generate sight events that are treated in much the same fashion as sound events. Likewise other visual effects in the virtual environment, such as fire, smoke, or lighting events can also generate events for consumption by the conduct AI system. The AI application layer for this class of events handles events somewhat differently than events like sound. Nearby movement could pose a threat and should be investigated with a higher urgency than sound. However, frequent nearby movement might tend to be ignored, such as characters walking by in a crowd, cars driving by on a nearby road, or repetitive motion at an amusement park or factory. That is, a high frequency of similar events might eventually lead to complacency, which is another flaw commonly exhibited in human behavior.

When an AI application layer triggers an investigation of an event, the instructions issued to the NPC are in the form of a GEM, such as an objective GEM for simple tasks, or an intelligent queue (a collection of objectives) for more complex tasks. These GEMs are stored in the memory stack entries as an identifier that references the code body. Therefore, no limit is placed on the scope of the investigation. Examples of more complex investigation of events are volume events and character interaction events.

When an NPC enters a volume, it receives a volume event in the form of an identifier associated with the volume. Volumes are typically associated with buildings, which in turn are divided into volumes describing each room, interconnecting corridors, stairwells, etc. Volumes need not be limited to buildings; they can also describe outdoor areas, such as a garden or worksite. If the NPC is unfamiliar with the volume, the AI application layer for volume classes may trigger an investigation of the event. This investigation can in itself be an entire algorithm to sparsely map the volume and inventory its contents. The term sparsely is used here because the investigation algorithm will not map the entire volume in detail on the first pass. However, on successive visits to the same volume, the algorithm will continue to add detail to the metrics associated with the volume. As the NPC becomes more familiar with the volume the need for the AI application to investigate it will diminish.

Consider, again, the example of the experienced NPC, Frank, and the inexperienced NPC, Bob, as applied to volumes:

Frank escorts Bob through a small office building. Frank knows the volume well and his recorded metrics for the volume are rich in detail. Bob has never been in the volume before and has no information regarding the volume. As Frank escorts Bob through the building, Frank seldom looks around to examine his environment; he is familiar with it almost to the point of complacency and his AI application does not trigger any kind of investigation of the volume. However, Bob has never been in the volume before; his AI application layer automatically triggers an investigation algorithm, and he tends to look around frequently to observe the volume and items in it. As with sounds, Bob's investigation of the volume is based only on what he can “see” or otherwise experience in the virtual environment; any detail of the volume that he gains must be limited to characteristics that can be directly observed or experienced by Bob. In some cases, Frank could impart some of his knowledge of the volume to Bob (see below), though that knowledge may carry less weight than details that are directly experienced by Bob. Furthermore, the AI application will place a higher priority on some characteristics of the volume over others. Specifically, the algorithm will be more interested in acquiring the physical layout of the volume and its relationship to connecting volumes over the specific contents of the volume. This is somewhat akin to a human building a mental map of a building they have never been in before to find their way back out.

As Bob walks with Frank through the first volume encountered in the building, Bob takes note of the approximate size of the volume as well as its relationship to the entrance. After those characteristics of the volume are captured, Bob will occasionally glance around to draw line/spherical traces through the volume, which may or may not intersect one or more objects. If the trace returns one or more objects, their simulators are queried for their properties and the information is added to Bob's knowledge of the volume. Bob's traces are more likely to fall on larger objects, such as doors and furniture, though the traces could fall on mid-sized to smaller objects, such as a fire extinguisher or a light switch. The volume itself maintains a detailed inventory of every object in it; Bob's knowledge of the volume is limited to just the items he happened to glance at or otherwise experience, such as for example, sound, haptic, or other feedback.

When Frank and Bob move to an adjacent volume, say a connecting corridor or a room, a new volume event is generated, and a new investigation is triggered. As with the previous volume, the first information gathered is the approximate size of the volume as well as the location of the entrance (i.e., the location of the adjacent volume he entered from), then any items he happens to see or experience are inventoried. This continues for all volumes Bob happens to encounter.

When Bob leaves the building, he will have a fragmented understanding of the building. That is, he will know the layout of any rooms or corridors that he passed through, but no knowledge of the areas he did not personally experience. He will also have some knowledge of the items in the building, but it will be limited to just the items he happened to glance at or otherwise experience. The investigation phases that Bob went through not only replicated human-like behavior as Bob looked around to learn his environment, but also left Bob with a similar understanding of the building that a human might have after their first walk-through of that building.

If Bob visits the same volumes again and recalls the metrics from the first visit, the AI application layer might determine that the record is still incomplete and trigger additional investigation to fill in more detail. At some point, depending on Bob's settings and other factors, the AI application will decide Bob knows enough about the volume and no longer trigger an investigation phase to acquire more detail.

The volume AI application can also be biased based on the task that the NPC must perform. For example, if an NPC is tasked with delivering a sack lunch to room 107 in a building that the NPC has never been in, then the investigation phase is more biased to looking explicitly for doors or room numbers. Specifically, the line traces drawn when investigating the volume are directed more as scans across the walls to return hits on doors. When a door is returned by the trace, the simulator for the door is queried for information regarding the volume on the other side of it. If that volume happens to be room 107, the NPC enters the volume and delivers the lunch.

Another example of a complex investigation is AI application layers supporting character interaction. The events for character interactions occur when an NPC and another character (whether another NPC or a human-controlled avatar) come in proximity. The event identifier is a unique identifier for the particular character encountered. If this is the NPC's first encounter with that character, a new entry is created at the top of the short-term memory stack with no metrics that describe a relationship with that character. In most cases the NPC will do little more than glance at the stranger. However, if the same character is encountered numerous times, the NPC might investigate the character by offering a nod or smile (depending on the NPC's personality settings). The NPC will then query the character's simulator to determine if the gesture was returned in kind, if they were ignored, or if they received a negative reaction to their gesture. The feedback they receive from the character is stored in the metrics and contributes to the NPC's personal bias toward the character (whether positive or negative).

The other character that was encountered could be another NPC, who sees the gesture and must decide how to respond. If the other NPC is reclusive in nature, it might ignore the gesture and press on about its business, if not, it might return the gesture. In either case, the other NPC notes in the metrics for the encounter that the NPC made a first attempt for a social contact and biases its understanding of the NPC accordingly.

The above example is relatively simple and represents the most superficial form of character interaction. Consider an NPC named Ann, who is tasked with picking up trash. A human-controlled avatar with a user handle of Roger442 steps in and helps Ann pick up some of the trash. Ann not only expresses thanks, but also records in her metrics that Roger442 voluntarily assisted her and begins to form a positive personal bias toward Roger442. In future encounters with Roger442, Ann will likely present friendly gestures and vocal greetings. Ann's personal bias toward Roger442 may edge upward or downward depending on the reply to her gesture. It could even come to pass that Ann encounters Roger442 while he is engaged in a task and offers to voluntarily assist him, as he did for her.

Consider the other end of the behavior spectrum, where an NPC named Todd encounters a human controlled avatar for user BadBarny. Upon first encounter, BadBarny punches Todd in the face for no apparent reason. Depending on Todd's personality parameters, he may back down or even reciprocate in kind. Either way, Todd's bias toward BadBarny goes significantly negative. In future encounters, Todd's bias toward BadBarny might prompt him to avoid BadBarny or refuse to work with him even when tasked to do so. If Todd's personality settings tend toward vindictive, BadBarny might find that he created an enemy in the metaverse that actively seeks revenge.

An NPC's personal bias toward other NPCs can affect other aspects of their behavior, such as which characters they gravitate toward and which characters they avoid. If a group of NPCs are walking toward a common destination or are idle as a group, they will tend to organically congregate into groups that resemble social cliques. Human users like Roger442 might find that NPCs tend to gather around him in a friendly fashion, where users like BadBarny find that NPCs avoid him. In training scenarios, as an example, the personal biases NPCs form toward human users (whether good or bad) teach or reenforce good team building skills (or the consequences of poor team building skills), or even detect racial biases when human workers must interact with NPCs representing a cross-section of different race, creeds, color, or genders, which for example can also happen in social gathering or other scenarios.

The conduct AI system goes beyond providing the appearance of human-like behavior; it can significantly alter the trajectory of the virtual world and users in it. The conduct AI system relies heavily on GEMs and the polymorphic logic trees; it runs on the same infrastructure that supports GEMs like autonomous micro-simulators, objectives, intelligent queues, and cohort GEMs. As such, NPC activity under the conduct AI system has the same impact on the polymorphic process as human user activity. Human-like errors committed by NPCs can have the same impact on user scenarios as mistakes made by real humans.

The conduct AI system also injects unpredictable activity into the virtual world that occurs autonomously without scripting. Disasters can be created or averted by NPC behavior alone without intervention by human users. Consider the following example:

NPC Bob stands idle in front of the office building that he toured with Frank. He has been through the office building only once and has a minimal understanding of the building. Not far from Bob is a pile of oily rags near a large propane tank. The autonomous simulator for the rags calculates that the conditions are correct for spontaneous combustion; the rags burst into flames.

The erupting fire creates a bright particle effect, which creates an event that Bob receives; Bob also receives a sound event associated with the flames. The AI application layers for sight and/or sound direct Bob's attention to the fire. Because of the AI application layer, Bob draws a trace to the fire then queries the fire simulator. The fire simulator identifies the phenomenon as a fire. The fire simulator also returns the identifier of an objective defining the action to take. If it were a large fire, the action would be to flee to safety, however, the fire is still relatively small, and the action returned is an intelligent queue GEM identifier, which contains the instructions and actions required to mitigate the fire. The mitigation procedures provided by the fire simulator specify that a fire extinguisher is needed to put out the fire; it also contains the instructions or actions the NPC must execute to successfully extinguish the fire. Meanwhile, the fire's domain has overlapped the propane tank's simulator, which starts calculating heat and pressure present in the tank; the clock is ticking.

What happens next is entirely dependent on what Bob learned about the office building earlier while he walked through its volumes with Frank.

Bob searches his short-term and long-term memory stacks relating to volumes to determine if he has seen a fire extinguisher anywhere. If Bob recalls seeing a fire extinguisher in the office building, he enters the office building, retrieves the fire extinguisher, then performs the actions required to put out the fire. The fire extinguisher simulator expels an extinguishing agent; the extinguishing agent's simulator overlaps the fire simulator's domain and, providing the extinguishing agent covers the base of the flames, prompts the fire simulator to shut down. With the fire simulator decommissioned, the propane tank simulator begins to reduce pressure and temperature. In this scenario, a potential disaster is averted by the actions of an autonomous NPC acting solely on instructions provided by the conduct Al system.

However, if Bob does not recall seeing a fire extinguisher in the office building, for example, either because his line/spherical traces never fell upon a fire extinguisher or he failed to recall details about the office building, then the fire is not mitigated. Consequently, the propane tank simulator inevitably calculates that the pressure in the tank has reached the rupture point and a disaster ensues.

It is important to note that not only was the outcome of the above scenario driven by a single event (whether Bob recalled a fire extinguisher in the building), but either outcome could happen under the conduct AI system without a human user in sight or even without a human user logged into the system. NPCs under the conduct AI system can manage and alter the virtual environment completely autonomously. As such, a virtual world can operate perpetually without any human intervention at all.

The conduct AI system also allows NPCs to learn from secondary sources of information in the virtual world. For example, an NPC can look at a map on a wall. The conduct AI system queries the map's simulator, and the map simulator provides the NPC with the short-term memory stack entries that the conduct AI system would normally build when the NPC walks through the building volumes. The map simulator basically pre-loads the NPC with the knowledge of the building to whatever level of detail the map provides.

This knowledge pre-load is not limited to a map on the wall. It can be any source of information, from GPS information to information stored in huge knowledge databases.

The same principle can be used to enable NPCs to read signs and the sign simulator provides the message of the sign in the form of a pre-loaded memory stack entry with pre-loaded metrics. The metrics can include Intelligent queues or objective GEMs. An NPC could do virtually anything because of the sign, e.g., not looking at the sign, not following the sign's message, obeying the sign, etc.

NPCs who have gained knowledge can share information with other NPCs. The shared information could involve transferring an exact copy of the knowledge, an exaggeration of the knowledge, an abbreviated and incomplete copy of the knowledge, an embellished copy of the knowledge, or any other form of imperfect sharing of information. NPCs can have parameters for skepticism, rumor sharing, and other human behavior traits. The recipient of shared information uses these parameters to bias the reliability of shared information, which further skews the context of the information beyond any modifications that the sender of the information applied. As an example, when Frank escorted Bob through the building in the example above, Frank might have told Bob about a room they did not visit that has a copy machine in it; Bob's context is a volume of average size containing a functional copy machine. In truth, the copy machine might be wedged in a closet, disconnected, dysfunctional, and buried under a stack of boxes.

The rate at which information is imparted from one NPC to another may be throttled to limit transfer of knowledge to a rate similar to that of a conversation. This throttling of information not only mimics the rate at which humans share information, but also allows incomplete information to be transferred if the “conversation” is interrupted or cut short by the recipient due to lack of interest.

NPC knowledge acquisition and information sharing through Conduct AI can be used for such things as training digital twins of customers, workers, and humans in general, and more.

The user interface (UI) in the platform is context sensitive and uses soft mappings from a database to customize controls for users depending on their preferences and physical needs as well as what a particular task or action requires. Any GEM can change the UI for any user based on the polymorphic decision tree. The UI will adjust based on the user's screen size and control functions automatically become icons which can be expanded based on touch or voice commands. In addition, the speech to text system implemented by GEMs and CO-ED (see above) can be used to decode vocal commands issued by the user. Users can customize voice commands in their user settings.

The equilibrium system and the platform UI accommodate haptic devices to receive user input and output and interface to the animation system.

A typical 3D engine builds an input stack for each frame, for each actor, at each animation tic for the UI bindings (e.g., keyboard strokes, mouse clicks, game controller actions, etc.). The platform uses a universal input system with a dynamic hash for bindings based on database configurations for the UI for each user and each type of action needed.

An inspection reticule can be invoked in the heads-up-display (HUD) that is tied to information about the object of the inspection from a database and a checklist for inspections. A user can take a picture of the inspected item and have it stored in a database as part of their competency evaluation. Magnifier lens can be invoked by a user and the optics automatically focus on the object to be examined. Binoculars can be invoked by a user and the optics automatically focus on the object to be examined.

Picture-in-Picture (PiP) window can be invoked by a user to display any type of content from a different perspective of the frame, a video, a website, a document, a live video, a video game, etc. In addition to traditional PiP, the platform can also display content using a reduced viewport. The reduced viewport shrinks or re-allocates the viewport to make screen room for additional content, which may change the aspect of the viewport if necessary. This approach has benefits over traditional PiP because it does not occlude or hide sections of the viewport like PiP. Instead, the reduced viewport approach shows the entire viewport next to the additional content. The viewport may be 3D, 2D, or another representation, or a combination thereof.

The features, components, and functions of the platform described thus far may facilitate or allow the platform to provide highly useful and beneficial interactive simulations for multiple users. These interactive simulations, and the ability to create, manage, manipulate, render, and deliver networked, interactive, interoperable digital video worlds with photo-realistic graphics, and accurate autonomous simulations of objects that can accommodate very large numbers of simultaneous users can offer significant benefits to numerous industries. For instance, such a platform is highly useful for learning, entertainment, communication, social interaction, commerce, or other experiences.

However, a platform with these features requires computationally intensive rendering of multi-dimensional graphics frame-by-frame. Such computational power exceeds the graphical and computational processing unit capacity of smartphones, tablets, self-contained VR headsets, and most general-purpose laptops, and desktop computers. As such, the conventional manner of utilizing the computational power of the user's local computing device is not possible, since local computers simply do not have the necessary computational power. Even with a local computer with heightened computational abilities, using the local computer is still not advantageous, since the resulting content is unlikely to be provided to the user in the manner or time intended.

One solution to the problem of how to deliver such high-quality graphics to limited capacity hardware is to render the graphics on a remote server and stream the rendered frame and corresponding audio via the Internet to the client hardware on the user's local device. Typically, to achieve this solution, a large number of servers would be required, which makes cloud-streaming expensive for many users and applications. Conventionally, for single clients or multiple simultaneous clients, one instance of the remote server is required to render and stream a frame to each client. As such, the number of servers required to deliver each frame of graphics and audio to each client, incorporating the changes in each frame for each simultaneous client, is large. Thus, by itself, rendering the graphics on a remote server and streaming the rendered frame and audio to the user's local device is not a practical solution for a multitude of users in the same or a connected world.

The subject disclosure provides solutions to this problem. One such solution is achieved by using a process for streamed multi-user interactive content, which may be used to provide any type of interactive content to users. An exemplary type of interactive content is streamed multi-user interactive content, such as, for example, gaming, both for entertainment purposes and/or other purposes, such as non-entertainment gaming used for training, learning, marketing, and any other purpose, or combination thereof. For clarity in disclosure, the subject disclosure uses gaming examples throughout, but it is noted that the novel processes and systems described herein may include any type of interactive content.

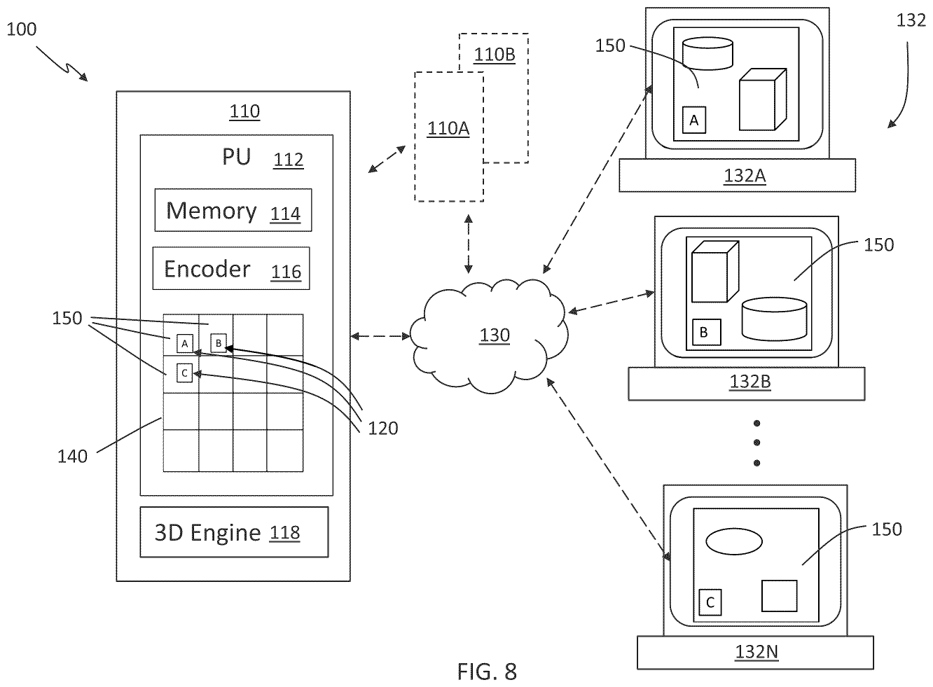

FIG. 8 is a diagrammatic illustration of a system for providing interactive content to one or more users 100, in accordance with embodiments of the present disclosure. The system providing interactive content to multiple users 100, which may be referred to herein simply as ‘system 100’ or ‘platform’ may be used to conduct a process of providing interactive content to multiple users. With reference to FIG. 8, a server 110 is provided, where the server includes a processor 112, such as a processing unit (PU) and a non-transitory memory 114. The server 110 may further include any other features or components that are customary with servers, such as databases, computing programs, input/output devices, and any other hardware or software. As depicted in FIG. 8, the PU 112 of the server 110 may include an encoder 116 and a computer graphics game engine, identified as a 3D engine 118. The server 110 has or hosts interactive content 120 in a common texture 140 or texture canvas which resides in the PU 112. The 3D engine 118 within the server 110 is in communication with the PU 112 and may direct relevant operations that occur in the PU 112.

The system 100 may further include a network connection 130 which allows the server 110 to be in communication with multiple local computing devices 132. The network connection 130 may include any type of computing network connection, such as, for instance, a cloud network, a wireless network, a wired network, a fiberoptic network, or any combination thereof. The local computing devices 132 (132A, 132B . . . 132N) may include any type of computing device, including a laptop computer, a desktop computer, a gaming computer, a tablet computer, a smart device such as a smart phone, smart glasses, a smart visor, or any other electro-computing system. For clarity in disclosure, the system 100 is depicted with a first local computing device 132A, a second local computing device 132B, and may include any number (N) of additional local computing devices, denoted as 132N. Also, for clarity in disclosure, local computing device 132A, 132B, and 132N are shown with two-dimensional screen displays, however, any display system supported by the computing device, such as Augmented Reality (AR) glasses, Virtual Reality (VR) Head Mounted Displays (HMD), or any other evolving display system can be supported by the streamed multi-user interactive content process.

The streamed multi-user interactive content process of system 100 may provide bulk rendering of individual content for any number of users of a virtual environment, such as a virtual gaming environment or synthetic learning environment, or other virtual environment. In this process, unique content 120 for each individual user of system 100 is rendered in a single rendering pass on a single running instance of server 110, thereby allowing a higher user-to-server ratio than current state of the art systems providing similar services. For instance, the processor 112 of server 110 maintains a common texture 140, or texture canvas, upon which it allocates a separate screen frame 150 for each individual user, then renders unique content 120 for each user based on the user's corresponding view of the virtual world in a single rendering pass. The rendered texture 140 is subsequently subdivided into individual user screen frames 150. The appropriate or relevant screen frame 150 is extracted and provided to each appropriate user after the multitude have been rendered, such as, for instance, where each relevant screen frame 150 is encoded into a video stream suitable for network transmission by encoder 116 then transmitted by one or more network connections 130 to the corresponding user devices 132. In one example, a conventional web browser may be utilized to access the network connection 130, whereby the relevant rendered screen frames 150 of the interactive content can then be displayed on the local computing device 132 of each user. The stream of the rendered screen frames 150 may occur simultaneously to each specific user's hardware in real time through a web browser, or through another interface.

The method for streamed multi-user interactive content described relative to FIG. 8 allows multiple users to stream the user experiences to their corresponding computing device all while still allowing rendering of the virtual environment with the same responsiveness and photorealistic detail that is available on the server. Conventionally, nearly all network-streamed games suffer some degradation in graphics quality and speed compared to games that are installed on a computer, which is typically due to the practical limitations of individual processing of gaming content on servers before that content is streamed. The system 100 and method of the subject disclosure, however, do not have this same shortcoming, as the interactive content of the virtual environment is streamed through a web interface, such as, but not limited to a web browser like CHROME® or SAFARI® with no degradation of performance. This is due, at least in part, because the streamed multi-user interactive content process allows very large numbers of users to access interconnected, interactive digital video worlds simultaneously whereby a single instance of the server 112 can simultaneously render interactive photorealistic environments on virtually any high, medium or bottom-end device that is capable of playing a web-based video.

It is noted that each user of virtual environment is digitally within a single authoritative virtual world, which is identical between users, yet the interactive digital experience of each user can vary. For instance, the interactive digital video experience views the digital video world are from the perspective of a virtual camera frustrum associated with a user's avatar. As such, the virtual camera field of view incorporates all objects within its field of view. Each user will have a different virtual camera, a different field of view, and will view all objects from a different point of reference based on their location and viewing angle and direction. This unique field of view for each user is referred to as a user screen frame. Each user screen frame must be rendered by the processing unit (PU) in a computer every time something changes in the user screen frame. The same concept is applied to audio where each user may experience audio within the virtual environment which corresponds to them individually, such as, for instance, where the volume of a particular sound may be based on how geographically close or far that user is from the origin of that sound.

In conventional 3D engines, all graphical objects are prepared to be processed by a PU. A single texture canvas is created that all user screen frames are rendered to. The texture canvas is partitioned into cells with one cell per user frame. For split-screen, the 3D engine locates a user screen that is the size of the display window, then in one pass the 3D engine renders up to four user viewports to the user screen, then displays the screen as-is. This is the only situation where a conventional 3D engine natively allows more than one user per server instance, and it is limited to being displayed on a single machine using a single display system (i.e., all four user views displayed on the same screen). In addition, when using a split screen mode only one user has full input control, and the remaining users are limited to user controllers.

The streamed multi-user interactive content method and system 100 are different than conventional methods and system. As shown in FIG. 8, streamed multi-user interactive content allocates a texture canvas 140 that is large enough to handle all user screen frames 150 at full resolution, such that all of the interactive content 120 within the frames 150 can be viewed without any degradation in resolution. In other words, the interactive content is rendered to the texture canvas 140 which has a sufficient capacity for all rendered screen frames of the interactive content. The full resolution user frames 150 are then rendered as a group in a single pass, and then each user frame 150 is separated from the texture canvas 140 into discrete frames for delivery. For example, the rendered screen frames of the interactive content may be partitioned into individual user screen frames, wherein the individual user screen frames correspond to different users. At this point the frames 150 are no longer split screen because each user frame can be displayed on a different device as a full frame. Thus, the streamed multi-user interactive content method and system 100 provide unique input channels for each user.

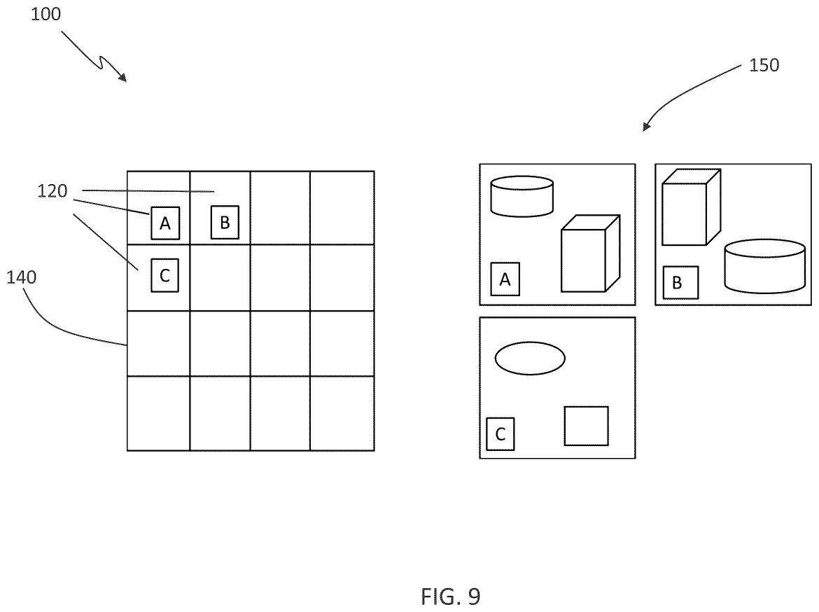

As an example, FIG. 9 is a diagrammatical illustration of the texture canvas 140 and the screen frames 150 of the system 100, in accordance with embodiments of the present disclosure. In FIG. 9, the texture canvas 140 is depicted on the left with the screen frames 150 on the right. Individual user screen frames are labeled, “A”, “B”, “C”, etc. In the frame 150 labeled “A”, the screen frame has objects in the field of view of the user “A” camera frustrum. Similarly, in the frames 150 representing users “B” and “C”, the same objects are viewed from a different camera frustrum. Each object to be rendered by the PU 112 is added to a draw call list which provides instructions to the PU 112. Regardless of the objects represented in each user frame 150, all frames 150 on the texture canvas 140 are rendered in a single pass in the PU 112. It is noted that the streamed multi-user interactive content method and system 100, in general, automatically allocates a texture canvas 140 which is sufficiently large enough to accommodate all user frames in the user resolutions requested. User frames 150 are arranged as cells on the overall texture canvas 140. A background canvas can be set for a variable number of pixels up to the maximum allowed by the PU (typically 16 k pixel resolution). If the maximum number of pixels allowed by the PU for the background canvas 140 is insufficient for the number of user frames 150 at the resolutions requested by the user devices 132, the system 100 may automatically scale the user frames 150 down to a lower resolution that will allow all user frames to fit on the background canvas 140. Or, it may be possible for multiple background canvases to be used, or another instance may be spawned.

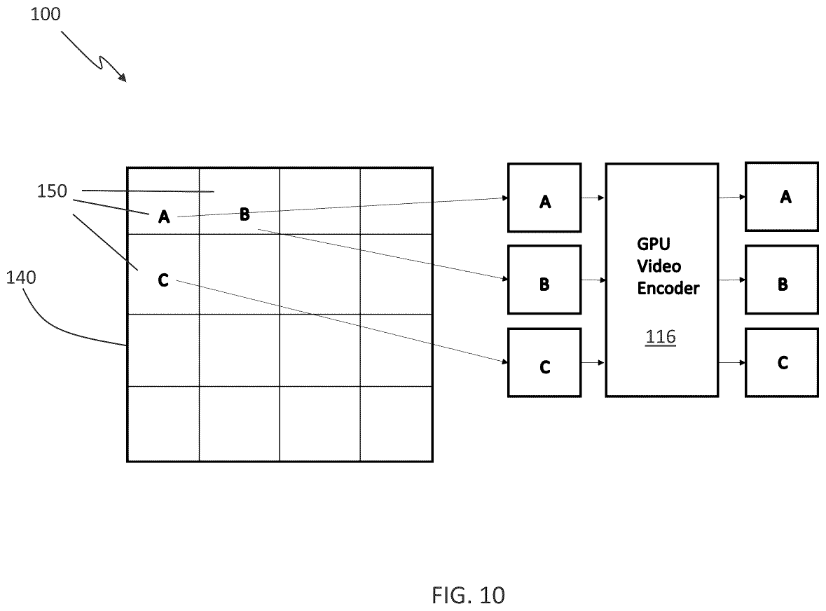

After rendering, the user screen frames 150 are separated from the background texture canvas 140, which is depicted in FIG. 10, which is a diagrammatical illustration of the texture canvas 140 and the screen frames 150 of the system 100, in accordance with embodiments of the present disclosure. The separation of the frames 150 from the texture canvas 140 is illustrated by boxes labeled “A”, “B” and “C”. The user screen frames are passed through a video encoder 116 on the PU 112 and streamed to the appropriate user as shown by the output from the video encoder 116 with arrows pointing to separated user screen frames labeled “A”, “B”, “C”. Encoding the user screen frames 150 may occur prior to streaming of the frames 150.

All aspects of a user's frame may be rendered in a single pass to the master texture canvas 140 prior to separation of individual frames 150. This further includes rendering all overlay icons and graphics, such as, for instance, reduced viewport adjustments, PiP, UI icons, external content, and any heads-up display (HUD) information, such as score. Thus, overlay icons on the rendered screen frames are rendered before partitioning the rendered screen frames into individual user screen frames.

The streamed multi-user interactive content method and system 100 is unique in how it separates out the camera frame from each user into separate threads. After rendering, the individual cells for each user screen frame may be separated and streamed back to each unique user. Single pass rendering for all user screen frames is possible because the streamed multi-user interactive content method and system 100 treat the background canvas as a graphical texture. Each user screen frame is mapped to a unique texture window on the overall background canvas texture. The 3D engine 118 in conjunction with the PU allows separation of individual textures from an overall texture canvas so the rendered cells can be extracted as individual textures and then sent to each user as their uniquely rendered screen view.

Because the master texture canvas 140 of the streamed multi-user interactive content process and system 100 is a texture and the separated user screens are also textures, any number of user screen frames can easily be remapped onto other textures (i.e., other user frames) using a U-V coordinate system. This may be achieved similar to how texture is rendered onto a mesh in 3D space. This feature can be leveraged to arrange any number of arbitrary areas and arbitrary size from the master texture canvas 140 onto the individual textures that are sent to individual users. This allows an unlimited configuration of user screens to be composited onto other user screens with little computational overhead.

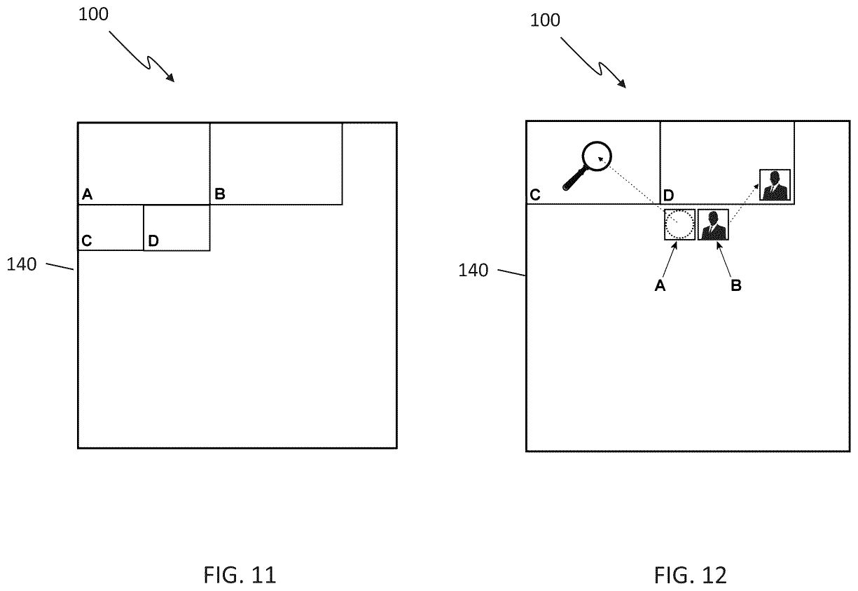

The placement and location of user frames on the background texture canvas 140 does not need to be uniform for each user. FIG. 11 is a diagrammatical illustration of the texture canvas 140 divided into screen frames 150 of the system 100, in accordance with embodiments of the present disclosure. As shown, the background texture canvas 140 is divided into screen frames 150 of different resolutions. High-resolution screen frames “A” and “B” reside on the same background texture canvas 140 as low-resolution screen frames “C” and “D”. The higher resolution screen frames “A” and “B” can be rendered in the same pass and on the same background canvas as lower resolution screen frames “C” and “D”. This intermixing of screen frames with different resolutions allows the streamed multi-user interactive content process and system 100 to generate screen frames that are optimized for devices of dissimilar resolutions all in a single pass. This mixed resolution optimization reduces rendering overhead by customizing screen frame resolution for each target device, rather than rendering all screen frames at the highest resolution needed.

The streamed multi-user interactive content process and system 100 may also allow non-player and special-purpose cameras that are used for PiP and similar content, such as but not limited to magnifier cameras, binocular cameras, and studio cameras for NPC virtual commentators and the like to be rendered in the same rendering pass as the player cameras. In a typical game or simulator, this type of special-purpose 3D rendering is typically rendered in a separate rendering pass for each PiP image needed. For example, FIG. 12, which is a diagrammatical illustration of the texture canvas 140 of the system 100, in accordance with embodiments of the present disclosure, shows intermediate frames “A” and “B” from two non-player cameras. A magnifier camera is rendered into intermediate frame “A”. During the same rendering pass, a view from a virtual studio camera for an NPC commentator is rendered into intermediate frame “B”. User screen frames “C” and “D” are also rendered in the same pass. After the single rendering pass but before the screen frames are separated into video streams, all or part of the intermediate frames are copied to their target locations in the corresponding player's screen frame.

Note that the copy process can use masked textures to allow arbitrary or irregular sections of the intermediate frame to be copied. In FIG. 12, only a circular section of intermediate frame “A” (dashed circle), is copied to the target then an optional PiP frame (such as a magnifying glass image) is copied onto the composite frame. Any arbitrary or irregular shape can be copied from an intermediate frame, or the entire intermediate frame can be copied. Intermediate frame “B” is copied in its entirety into the target location on screen frame “D”, then any boarder or other image trimming is added. Using this technique, any number of special-purpose content frames can be rendered in the same rendering pass as the player cameras, thereby reducing rendering overhead for special content when compared to traditional methods.

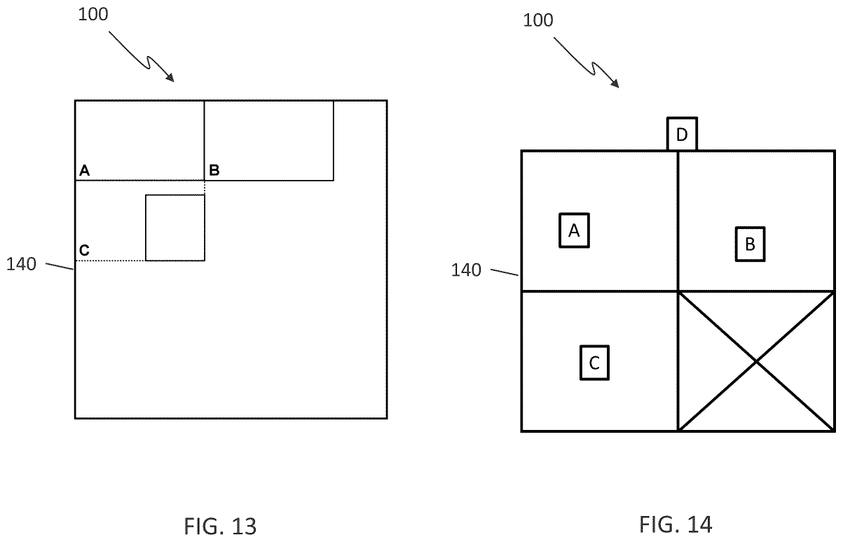

FIG. 13 is a diagrammatical illustration of the texture canvas 140 of the system 100, in accordance with embodiments of the present disclosure, and depicts the texture canvas 140 with differently sized viewports, where a viewport is the spatial area on a display screen through which the content of a virtual world is viewed by a user. For example, the background texture canvas 140 depicts screen frames with full-sized viewports “A” and “B” on the same background texture canvas 140 as screen frame “C” with a reduced viewport. The ability of the streamed multi-user interactive content method and system 100 to render screen frames and viewports in arbitrary locations on the background texture canvas 140 provides the ability to reserve space on any screen frame for ancillary information, such as UI elements, inventory listings, tutorial information, etc., without obstructing or occluding the rendered viewport. This is accomplished by reducing the size of the viewport as necessary.

In a conventional video game or simulator, information like UI elements cover areas of the 3D viewport seen by the camera frustrum or the viewport is hidden altogether if larger areas are needed. However, as shown in FIG. 13, two full-sized viewports (“A” and “B”) can be used, where the rendered 3D viewport captured by the camera frustrum fills the entire screen frame (typical gameplay). Screen frame “C” is an example of a reduced viewport, where the viewport (solid line) is reduced in size from the screen frame (dashed line). As illustrated in FIG. 13, the reduced viewport provides room above the viewport that might be used for UI elements, status information, etc., and reserves a large area to the left of the viewport that might be used for information that requires more screen space, such as an inventory list, tutorial information, etc. This allows information to be displayed on the user's screen without occluding any of the 3D view seen by the camera frustrum. The reduced viewport can be of any size or aspect ratio, can appear anywhere in the screen frame, and need not be anchored to an edge of the screen frame (allowing reserved areas on up to all 4 sides of the reduced viewport). The aspect ratio of the camera frustrum is adjusted to match the aspect ratio of the reduced viewport. Reduced viewports are dynamic and can be animated as the reserved area changes or the viewport is returned to fill the full screen frame.

It is also noted that the system 100 can accommodate various entities or types of entities, such as, for instance, individual users, teams of users, or other cohorts of users for different applications. The user frames can be grouped as needed. The system 100 can map a region of user frames on the master texture canvas 140 to a single viewport, thereby providing a composited screen frame. For example, in FIG. 14, which is a diagrammatical illustration of the texture canvas 140 of the system 100, in accordance with embodiments of the present disclosure, rectangle labeled “D” denotes a single viewport to which other viewports can be mapped. Accordingly, a user using viewport “D” can observe the actions of users in cohorts labeled “A”, “B”, “C” by assigning the grouped texture of “A”, “B”, “C” to user “D” instead of sending individual streamed frames to “D”. Thus, it is possible to have one user who can simultaneously view on a display screen their individual user screen frames and one or more other user's individual user screen frames.

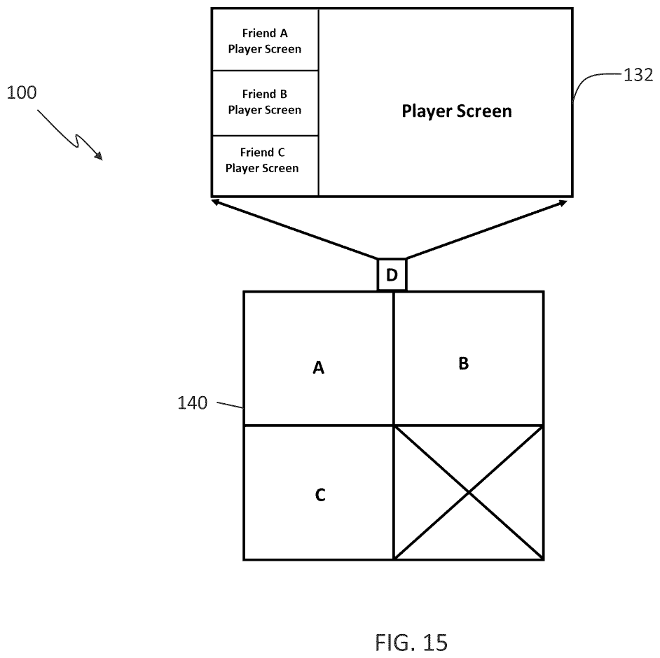

The ability to show multiple users on a single screen, as shown in FIG. 14 for the special users, can also apply to any user. For example, it may be possible for a user to see other user screens, such as their friends or other members of their cohort, alongside theirs. This is depicted in FIG. 15, which is a diagrammatical illustration of the texture canvas 140 of the system 100, in accordance with embodiments of the present disclosure. As shown in FIG. 15, the box labeled “D” represents a user who can see users “A”, “B”, and “C” on their screen of their local user computing device 132. This ability can be limited by system permissions and user privileges. Thus, it may be possible for the system 100 to allow the display of at least two of the individual user screen frames on a single display screen. Similarly, an individual user screen frame may have a reduced viewpoint, such that at least one individual user screen frame displayed on a display screen is smaller than another individual user screen frame displayed on the display screen.

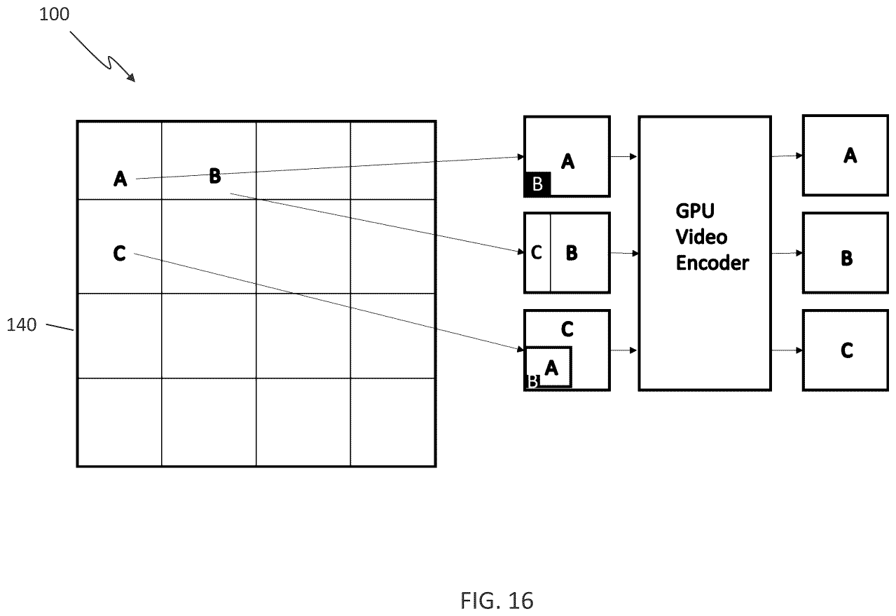

User screen frames can be also composited before and/or after additional information is added to the user frames. In FIG. 16, which is a diagrammatical illustration of the texture canvas 140 of the system 100, in accordance with embodiments of the present disclosure, user screen frame “B” can be copied to a corner of user screen frame “A” using a native U-V coordinate system. Similarly, user screen frame “C” can be configured as a reduced viewport view in user screen frame “B”. The modified user screen frame “A” including screen frame “B” can be copied into user screen frame “C”. There is no limit to the combinations of user screen frames that can be composited. Additionally, the streamed multi-user interactive content method and system 100 is capable of combining any set of textures prior to passing the textures through the PU video encoder. For example, in FIG. 16, user texture “B” can become a small window on User “A” texture before passing through the encoder, while user “C” texture can become a reduced viewport on User “B” texture, and the altered User “A” texture can be combined with User “C” texture, all prior to encoding. It is also possible to perform these actions before the user frames are separated.

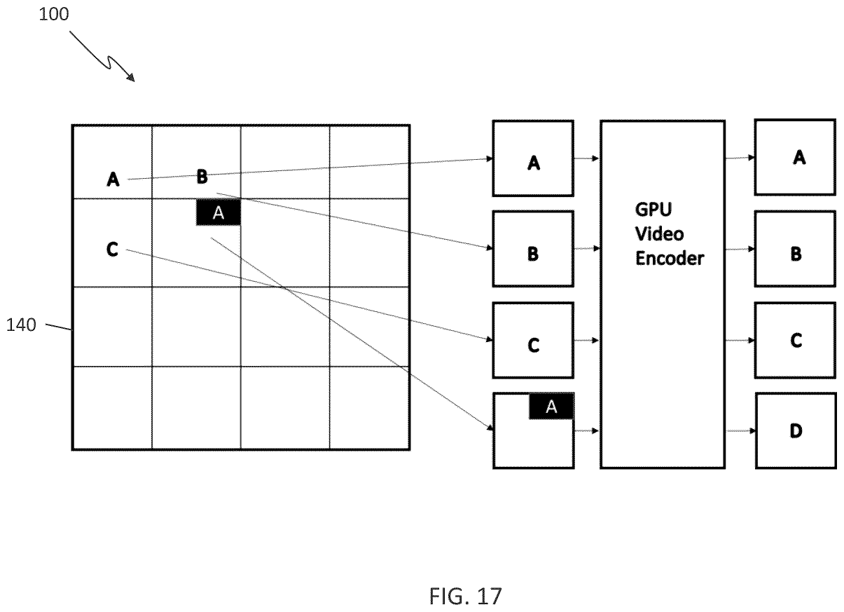

It is possible for the streamed multi-user interactive content method and system 100 to perform any combination of composites in a separate pass. For example, FIG. 17 is a diagrammatical illustration of the texture canvas 140 of the system 100, in accordance with embodiments of the present disclosure, which depicts user screen frames “A”, “B”, and “C” on the master texture canvas 140. In a separate pass, user screen frame “A” is reduced in size and copied into a blank cell. This can be performed before separating the textures for video encoding. The streamed multi-user interactive content method and system 100 can composite information from user screen frames in any possible combination as a separate pass prior to the separation of textures phase.

It is noted that the 3D engine 118 only must compute physics calculations once for all user screen frames. In conventional streaming code with one user per server instance, the physics, simulators, and state of the world must be computed for each user and for the authoritative server. Because of time delays between each server, the actions of objects viewed by each user and the authoritative server may not match. In the system 100, the physics is accurate and the same for each user. Specifically, each user is not operating in an ‘approximation’ of the world that is synchronized to an authoritative world, as is the case with conventional multi-user video gaming, rather each user resides in the same single authoritative virtual world as all other users, which is guaranteed to be exactly identical for each user.

With regard to authoritative virtual worlds, generally, conventional multi-user virtual environments have one and only one authoritative world to which user proxies or ‘approximations’ of the world are synchronized to. Users of this authoritative world do not reside within the authoritative world, however, but rather, in conventional multi-user virtual environments, an approximation of the virtual world is maintained for each user by attempting to synchronize their individual approximated proxies to the authoritative world. This is an imperfect process that results in error for both when and where an object might be at any given instant with respect to the authoritative world and with respect to other approximated proxies participating in the experience. In some cases, this error in synchronization can be significant and is frequently impacted by variables such as latency, network bandwidth, and disparity between processing capabilities at each device maintaining a proxy. Synchronization errors are particularly acute in fast-action experiences, such as shooter games.

The synchronization process for conventional multiplayer games contributes to the practical limit of how many users can participate in a common virtual experience. A significant amount of processing capacity and network bandwidth is required for the synchronization process, consequently, commercial multiplayer games, such as FORTNITE® running on production server hardware and fully optimized with less than photorealistic environments, reach a practical limit of approximately one hundred users per authoritative world. In addition to maintaining the location and state of one hundred user avatars in the authoritative world, the authoritative server must also continuously transfer large blocks of data to one hundred approximated proxy worlds to keep each one synchronized with the authoritative world.

In contrast, using the streamed multi-user interactive content method of system 100, no synchronization is required at all until or unless the system needs to scale beyond the user capacity of a single server instance. When using the streamed multi-user interactive content method of system 100 with a limited number of users that can be accommodated on a single server instance, all user experiences will take place in the same authoritative instance of the virtual world. As such, if a user kicks a rock in the virtual world, all other users in that world will agree on where and when the rock will come to rest, as well as any other visible attributes, such as velocity and direction of the rock at any given instance in time, and any ancillary actions that might result, such as if the rock hits a window. All users would be in agreement of the behavior of the rock because they are all looking at the same authoritative rock in the same authoritative world, as opposed to each user looking at various approximations of the rock in their corresponding approximated worlds (as is the case with conventional multi-user experiences). Likewise, if the rock broke a window, all users would agree on the number, size, and placement of each individual shard of glass resulting from the breakage. In addition, because there is only one copy of the rock (the authoritative copy), no synchronization processing needs to be performed between approximated copies of the rock.

This describes the small-scale user model of system 100, where the number of users participating in a virtual world is small enough that all users can be connected to a single server 110. The number of users that can participate in a small-scale user model depends on the complexity of the virtual world, the processing capacity of server 110, as well as other factors. In cases where the number of users participating in a virtual world exceeds the capacity of the small-scale user model, system 100 may automatically transition into the mid-scale user model.

System 100 may transition from a small-scale user model to a mid-scale user model when the processing or rendering capacity of server 110 reaches a predetermined load threshold. When this transition occurs, system 100 may spawn a new instance of server 110A, as illustrated in FIG. 8, which may also be referred to as proxy server 110A, and then load it with a copy of the authoritative world from server 110. After server 110A is initialized, the system 100 may evaluate the user population distribution in the authoritative world on server 110 and define a group of users that, in general, all share the same virtual geographic region in the authoritative world (i.e. users that are near each other). The system 100 will then seamlessly transfer the selected group of users from server 110 to server 110A, which will, in general, behave like an approximated proxy of the authoritative world hosted on server 110 with one notable exception; server 110 will grant the approximated proxy server 110A limited authority over the users that were transferred to it, as well as limited authority over the region of virtual world in which those users are located.

The term ‘limited authority’, as used in this disclosure, may refer to authority over a specified subset of a virtual world, but not necessarily authority over all objects or areas in the entire world, nor does it imply procedural authority over a world. A server that has authority over a set of objects and/or an area of a virtual world is recognized as possessing the official state of those object or areas; any other copies are considered approximations or proxies of those objects or areas, which must be synchronized to the official or authoritative versions of those copies held under limited authority. In a conventional multi-user system using an authoritative server model, the authoritative server holds the only official version of the virtual world in its entirety as well as full procedural authority over that world; all other servers hold an approximation of the virtual world in all respects and must synchronize all of its content to the official version held by the authoritative server.

Proxy server 110A with limited authority leaves procedural authority with the authoritative server 110, but assumes authority over the subset of the virtual world that it was directed to take control of; all other objects and areas of the virtual world remain under authority of authoritative server 110. Specifically, system 100 and authoritative server 110 will recognize that proxy server 110A holds the official version of all items and/or areas it has limited authority over, and that all other aspects of server 110A are approximated copies, and that authoritative server 110 holds the official copies of all items and areas in the world with exception of the objects and areas that proxy server 110A has authority over. As such, the approximated copies that server 110 is holding may be synchronized to the official copy held by the proxy server 110A (this is counter to the conventional authoritative server model).

This method of granting proxy servers limited authority over selected parts of the world has the effect of distributing the official versions of objects and areas of the virtual world across multiple servers. The purpose of this distribution is to organize groups of users to take advantage of optimizations associated with the streamed multi-user interactive content method, thereby allowing the streamed multi-user interactive content method to always operate on what it views as an authoritative server as far as users, user cameras, user input, and interactable objects are concerned.

Note that with the mid-scale model in the example above, only one pair of servers, approximated proxy server 110A and authoritative server 110, may be needed, which is invariant with respect to the number of users participating in the experience. For example, if one hundred fifty users are in the virtual world and are distributed between servers 110 and 110A, only two synchronization operations need to take place: server 110 may synchronize all objects and areas that server 110A has limited authority over, and server 110A must synchronize all other objects and areas of the world to the official copies being held by authoritative server 110. This is a significant reduction in synchronization processing when compared to conventional multi-user systems where one hundred fifty synchronization operations would be required (one synchronization operation for each user). This is possible because the streamed multi-user interactive content method of system 100 allows a significant number of users to participate in a single copy of the virtual world.

System 100 may attempt to keep users connected to whichever server (server 110 or server 110A) has authority (limited or otherwise) over the area in which the user is located. That is, if a user in the virtual world travels from a region that sever 110A has authority over to a region that server 110 has authority over, system 100 will seamlessly transfer the user from server 110A to server 110, thereby keeping the user on the same server that has the official copy of the user's immediate virtual environment. Optionally, if a user strays from a group in server 110A and leaves the area that server 110A has authority over, system 100 may direct server 110A to expand the area over which it has limited authority to include the wandering user. The decision to expand a domain of limited authority to include a user, versus transferring the user to another server, may be based on user population density and/or other factors.

From a user standpoint, the experience for all users connected to the same proxy server 110A of the virtual world using the mid-scale user model may be very similar to the experience described previously for users on the authoritative server 110 for the small-scale user model. Specifically, since system 100 keeps all users in a common region on the same server that has authority over that region, all users will be looking at the same virtual environment, as opposed to different approximations of that environment. If a user on server 110A kicks a rock, it will be the same rock that is in the same virtual world as other users in the area. As such, all users connected server 110A will be in agreement about the behavior of the rock because they are all viewing the same rock,

This unique method of replicated proxies used by system 100 and the mid-scale user model creates the ‘illusion of perfect synchronization’ across all versions of the world both authoritative and approximated, even though some synchronization error is likely to exist. Consider the rock kicked in the approximated proxy server 110A above; a user that is some distance away from the rock and connected to server 110 is, by design, outside of the area over which server 110A has limited authority and is therefore looking at an approximation of the rock. Because the rock is some distance away, the user would have difficulty determining the exact position of the rock. If that user were insistent on determining the exact location of the rock, the user could walk up to the rock for a closer inspection. However, in doing so the system 100 will seamlessly transfer the user to server 110A as the user approaches the area over which server 110A has limited authority. As the user approaches the rock, the user will find that his/her view of the rock is in exact agreement with the assessment of the rock by other users in the area. That is, there would never be a case where two or more users would disagree on the position of the rock.

If enough users leave the virtual world and the user population is again reduced to the point where all users could be managed by a single server, the system 100 may automatically transition from the mid-sized user model back to the small-scale user model. When this transition occurs, system 100 will first ensure that the state of the objects and areas that proxy server 110A had limited authority over are copied to the approximated counterparts being held by authoritative server 110, then the users connected to server 110A are seamlessly transferred to authoritative server 110, at which time the proxy server's limited authority is revoked and handed back to the authoritative server 110, thereby returning full authority over the virtual world back to the authoritative server 110. After the process is complete and verified, the proxy server 110A may be destroyed.

The mid-scale user model is not limited to two servers, such as authoritative server 110 and proxy server 110A in the discussion above. If additional users join the group of users that server 110A has limited authority over and the load on server 110A approaches its practical limit, system 100 could spawn another proxy server 110B, then system 100 may evaluate the user population connected to server 110A to determine which users should be transferred to proxy server 110B. After proxy server 110B is initialized, the system 100 will seamlessly transfer the selected group of users to server 110B then give server 110B limited authority over those users and the areas in which they are located and revoke server 110A′s limited authority over those users and areas. This process can be repeated as necessary to accommodate growing user populations.

If the user population of servers 110A and 110B decreased they can be merged into one: the surviving approximated proxy, for example, server 110A, will synchronize itself to the subset of the world that the server being absorbed, for example server 110B, but only from those regions over which the server 110B has limited authority over, then the system 100 will seamlessly transfer the users from server 110B to server 110A, after which, system 100 will destroy proxy server 110B.

Using the streamed multi-user interactive content method of system 100 in a both authoritative servers and proxy servers significantly reduces the number of worlds that need to be synchronized when compared to conventional multi-user methods. If a conventional multi-user system reaches a practical limit of, for example, one hundred users per authoritative world due to the overhead in synchronizing one hundred proxy users to the authoritative server, then using the streamed multi-user interactive content method of system 100, and assuming similar per-server limitations due largely to synchronization overhead (e.g., one hundred approximated proxy servers being synchronized to each authoritative world), the practical limit for the maximum number of users per authoritative world goes from one hundred users to ten thousand users (e.g., one hundred users per proxy server times one hundred proxy servers). As far as comparative operating costs are concerned, in this example using the streamed multi-user interactive content method of system 100 would require only approximately one percent of the cost per user compared to conventional method.

In order for conventional systems to accommodate one thousand users on conventional systems and assuming a practical limit of one hundred users per authoritative server, ten servers must be used, with each server hosting a unique authoritative world. The only commonality between these authoritative worlds is the starting conditions of the individual worlds; after the experience begins, the ten authoritative worlds each operate independently and have no operational commonality between one another. For example, consider a virtual world built around a fictitious city named Userville and that as many as ten thousand users have entered Userville. Using conventional multi-user methods, ten or more servers would need to be spawned to handle the volume, with each server hosting an independent version of Userville. If user Dan236 joins Userville on server A, and Betty721 joins Userville on server B, then Dan236 and Betty721 will never be able to meet each other in the virtual Userville experience because each is in a separate and disconnected version of Userville. Likewise, if someone cut down a tree in Userville on server A, only Dan236 and the other ninety-nine users on server A would see that the tree was cut down; Betty721 and the other nine thousand eight hundred and ninety nine users that are not connected to server A would disagree that the tree was cut down.

While this disparity between experiences between users in different authoritative worlds is not necessarily an issue for certain types of user experiences, it can be unacceptable for others. Using the streamed multi-user interactive content method of system 100 with the mid-size user model can, in this example, expand the practical limit for users operating in the same authoritative world from one hundred users to ten thousand users. As such, up to ten thousand users in this example could visit Userville and all users would be able to agree on the state of Userville at any given point in time, such as whether or not a tree was cut down. Another practical limit is the virtual geographic size of Userville; in order for ten thousand users to visit Userville simultaneously, Userville must be large enough to accommodate ten thousand user avatars.

The example of Userville illustrates how a large number of users can visit the same authoritative world, thereby preserving a sense of presences, commonality, and persistence over the world; that the virtual world behaves as it would in the real world. However, there are cases where it is desirable to push more users into a venue than will actually fit in it in terms of user avatars. Consider a concert taking place in a virtual world. One of the advantages of hosting a concert in any on-line venue is that the promoters can sell as many tickets as desired and not be limited by a maximum occupancy associated with a real-world venue. Likewise, concert patrons would never be denied a ticket because the concert was sold out.

Consider a concert venue in a virtual world with a maximum practical capacity of five thousand avatars. Assume concert promoters have sold seven hundred fifty thousand tickets to a concert that is about to begin. Using the streamed multi-user interactive content method of system 100 and the mid-scale user model, system 100 may create a sufficient number of proxy servers to accommodate, for example, five thousand. In order to accommodate the other seven hundred forty-five thousand users, system 100 creates an additional one hundred forty nine authoritative servers 110 as well as enough proxy servers to accommodate five thousand users for each of the additional one hundred forty nine authoritative servers. Note that there is no commonality between the one hundred fifty independent authoritative worlds hosted by the each of the authoritative servers. Any individual concert goer would see venue is packed with, for example, five thousand avatars, yet they would be unaware that attendance is actually seven hundred fifty thousand users.

The practical limits of the mid-size user model can also be impacted by the geographic size of the virtual world. Larger worlds, in general, have more objects and features that need to be synchronized between the authoritative server 100 and any proxy servers, which requires more synchronization processing than smaller worlds with less items. Furthermore, larger worlds using the mid-size user model require that each proxy server contains an entire copy of the authoritative world to include both the objects and areas that the proxy has limited authority over as well as the approximated items that it does not have control over; all of which need to be synchronized to one degree or another. As such, the mid-size user model would have a lower practical user limit for larger worlds than it would for smaller worlds.

The large-scale user model uses the mid-scale user model and the streamed multi-user interactive content method of system 100 to facilitate very large worlds. In the large-scale user model, very large worlds are divided into independent authoritative regions, with each region being managed by its own authoritative server 110. Like the mid-scale user model, each authoritative server will have proxy servers with limited authority over selected objects and areas over which they have been given limited authority. The significant difference between the large-scale user model and the mid-scale user model is the configuration of the proxy servers near the edge of each authoritative world where two authoritative worlds join. Proxy servers near the edge between two authoritative worlds will contain objects and areas from both authoritative worlds, may overlap the junction between two authoritative worlds (in terms of virtual area they serve), and may even have limited authority of objects and areas from both authoritative worlds.

If a user in an authoritative world on an authoritative server were to walk to the edge of the authoritative world, they would see the edge of the world and emptiness beyond it; they would not see the connecting world because that world is in a different server. However, under the large-scale user model, system 100 will seamlessly transfer that user to whichever proxy server is near the edge of the world. Because the proxy server near the edge of the authoritative world contains elements from both adjoining authoritative worlds, the user sees a seamless continuous world that contains elements from both authoritative worlds. Essentially, the proxy servers near the edge of two adjacent authoritative worlds (or even overlapping the junction between two adjacent authoritative worlds), form a seamless bridge between the two authoritative worlds. As far as the user experience is concerned, the user sees what appears to be a single continuous large world, when in reality they may be traveling across many independent authoritative worlds.

The processing and resources for synchronizing the official copies of objects and areas with their approximated proxy copies is significantly reduced because authoritative worlds do not need to synchronize with each other; they only need to synchronize with their applicable proxy servers. This still results in a large number of synchronization operation taking place for the entire collection of servers as a whole, however, the number of synchronization operations that need to be processed by any one server is limited to private communications between an authoritative server and the proxies that have limited authority over their content.

One of the many benefits of the streamed multi-user interactive content method and system 100 is that it is possible for the system 100 to stream each user screen frame to the appropriate user via the Internet through a standard web browser such as but not limited to MICROSOFT EDGE®, APPLE SAFARI®, GOOGLE CHROME®, FIREFOX®, etc. The user does not need to download an app to access the content. The user can simply access the content through a URL on any type of computing device.

The streamed multi-user interactive content method and system 100 may adequately manage the streaming of the rendered screen frames. For instance, it may use host streaming nodes and/or initiate a pre-set number of spare streaming nodes and supporting middleware upon launch to make those resources immediately available as other users join a session. As users leave a session these nodes are deleted until a pre-set minimum number of nodes are reached. This is beneficial because the system 100 is setting up these spare nodes within a single server rather than multiple servers, unlike conventional techniques. There is no hard coded limit on the number of users allowed on a single server instance; the limit depends on available resources in the PU and variables like screen resolution and desired frame rate.

In addition to the graphics in the user screen frame, audio for each user is also processed by the PU, routed by user, mixed, then integrated into each user's video stream. Video streaming may utilize a subsystem to manage the streaming port or network node to which outside user will connect. In one example, it may be possible to use a network interface application such as but not limited to WebRTC, which is a peer-to-peer communication method and is the preferred method for real time streaming due to its low latency when compared to other methods. The combination of peer-to-peer audio and video requires an exponential scaling of available server ports as the number of simultaneous clients increases. The total number of ports (and streams) required can be reduced somewhat by using a Selective Forwarding Unit (SFU), though the number of ports required at each user node increases as the number of users connected to the server increases.

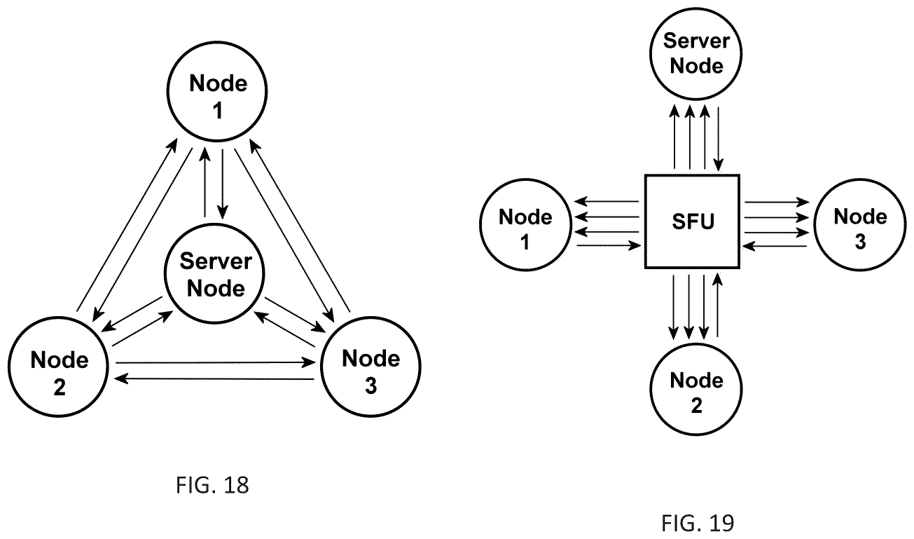

A typical peer-to-peer configuration for three users is shown in FIG. 18, which is a diagrammatical illustration of stream configuration, in accordance with conventional techniques. Each endpoint (whether it is the server or user node) must have N−1 outgoing streams and N−1 incoming streams for a total of 2N−2 streams at each endpoint (where N is the total number of endpoints including the server). Even if users are not streaming video (for example, as additional PiP content), these connections still need to be maintained to accommodate user audio. The 2N−2 scaling required at each endpoint is a particularly acute problem when streaming to mobile devices or to residential connections with limited bandwidth. In FIG. 18, the server node in the center maintains one outgoing and one incoming stream for each of the attached user nodes (Nodes 1, 2, and 3). In addition, each user node must maintain one outgoing and one incoming stream for every other user node connected to the system. This configuration scales poorly as each node requires 2N−2 streams and quickly becomes congested as additional users connect to the system.

Another issue with the peer-to-peer configuration is that each user hears audio from all other users on the system simultaneously, regardless of their location in the virtual world. This would make voice communication unusable as users scale.

The number of ports and streams required at each endpoint can be reduced using a selective forwarding unit (SFU), which may be used in conjunction with a network interface for this purpose. A conventional SFU configuration is shown in FIG. 19, which is a diagrammatical illustration of a SFU, in accordance with conventional techniques. The streaming server and user nodes are connected directly to the SFU, which typically resides on the same platform as the server node. The SFU routes incoming streams from a node to every other node that is connected to the system. This reduces the number of streams required at each user node to 1 outgoing stream and N−1 incoming streams for a total of N streams per node. The total number of streams required at the SFU is N2. This configuration reduces the total number of streams that need to be handled by each user node, and thus scales better than peer-to-peer, though it still does not scale well if a large number of users are connected. In addition, the audio problem, where each user hears all other users, is still present with an SFU.

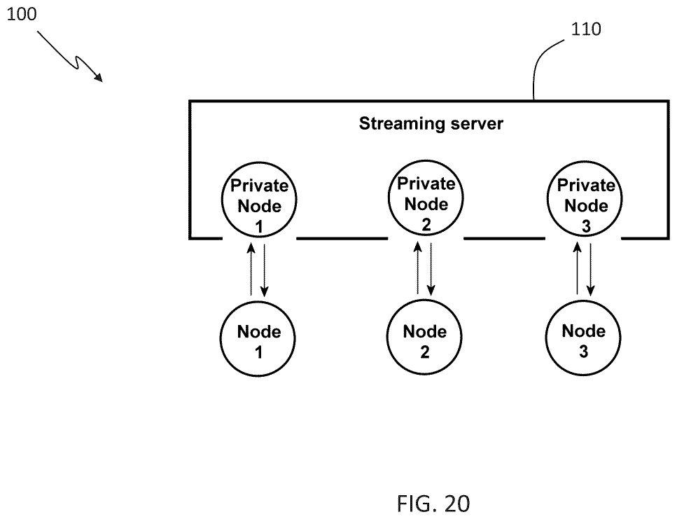

To improve the streaming operation, the streamed multi-user interactive content method and system 100 may resolve the scaling and audio issues seen in the peer-to-peer and SFU configurations by providing each user a private instance of the network interface. This is depicted in FIG. 20, which is a diagrammatical illustration of streaming method used by the system 100, in accordance with embodiments of the present disclosure. As shown in FIG. 20, user nodes (Nodes 1, 2, and 3) are each connected to a private instance of the network interface (Private Nodes 1, 2, and 3) at the streaming server 110. In this configuration, each private instance of the network interface is connected in its native peer-to-peer configuration with a single user. Each user node requires only 1 outgoing stream and 1 incoming stream for a total of 2 streams, which is invariant with respect to the total number of users connected to the system. At the server, the total number of streams are N outgoing and N incoming for a total scalability of 2N, where N is the number of user nodes (note that N in this case does not include the server node as was the case with the configurations described previously). As such, the system 100 is capable of scaling linearly at the server 110, and remains constant at the user nodes regardless how many users are connected. Thus, this design optimizes scalability with scaling at the server limited to 2N streams, and the number of streams at each user node fixed at 2, and it is invariant with respect to the number of users connected to the system.

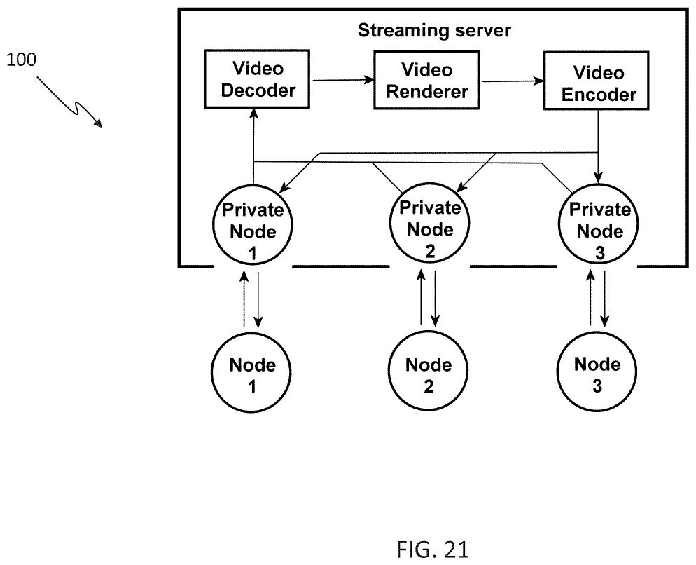

Any video sent from a user node (such as webcam video) to a private instance of the network interface is forwarded to a decoder, which decodes each video frame and converts it to a PU texture. For example, this is depicted in FIG. 21, which is a diagrammatical illustration of a video stream process used by the system 100, in accordance with embodiments of the present disclosure. Specifically, FIG. 21 depicts a video stream processing technique using private network interface nodes, where video streams from user nodes (Nodes 1, 2, and 3) are passed through the private network interface nodes (Private Nodes 1, 2, and 3) to a video decoder. The video decoder converts the incoming video streams into PU textures. The textures are passed to the single-pass video renderer where they are applied to user screen frames before being separated and applied to the video encoder to convert the frames back to a stream. The encoded streams are sent to the applicable user nodes through their respective private network interface nodes.

Accordingly, in FIG. 21, the textures are sent to a single-pass renderer in the system 100, and may be added to any applicable user screen frames. The webcam frames are added after all the user's 3D viewports have been rendered in a single pass but before the user frames are separated. These frames typically appear as PiP or are positions next to a reduced viewport, such as is depicted in FIG. 15, though other options are possible. After any user video is added to applicable user screen frames, the screen frames are separated, as shown in FIG. 17, then routed to the private network interface instance for the applicable user. The video sent by a user is not limited to web camera video: any video can be sent including a video representation of the user's screen as a screen share.

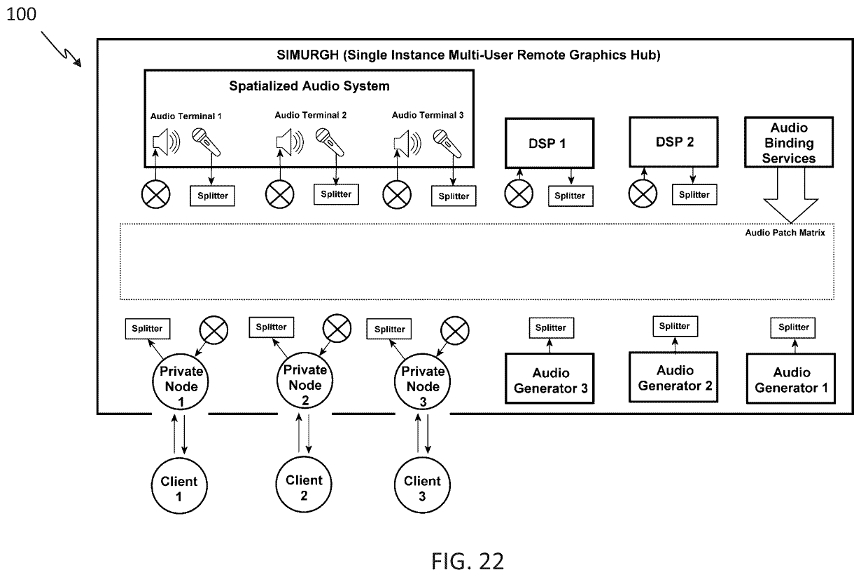

Audio processing for the system 100 is shown in FIG. 22, which is a diagrammatical illustration of an audio stream process used by the system 100, in accordance with embodiments of the present disclosure. For illustrative purposes, eleven autonomous audio components are shown in FIG. 22, which consist of three audio terminals in a Spatialized Audio System (Audio Terminals 1, 2, and 3), two Digital Signal Processors (DSP 1 and DSP 2), three audio generators (Audio Generators 1, 2, and 3), and three private network nodes (Private Nodes 1, 2, and 3) that are connected to remote clients (Client 1, 2, and 3). FIG. 22 shows examples of three audio terminals, digital signal processors, audio generators, private nodes and clients but the system 100 is not limited to three; any number of elements can be supported. In practice autonomous audio components are created on demand and destroyed when they are no longer needed, as such any number of audio components may be used as required depending on the application, conditions, and number of users. For example, if a fourth user joined an instance of the invention, then a fourth private node (not shown) would be created along with the applicable supporting audio components.

The output of each audio component is provided with a multi-channel splitter consisting of zero or more output channels, and each input of an audio component is provided with a multi-channel input mixer consisting of zero or more input channels. Like the audio components, input and output channels are created on demand and destroyed when they are no longer needed. The Audio Binding Services is responsible for managing the connections between the splitter output channels and the mixer input channels through a virtual Audio Patch Matrix. The Audio Patch Matrix can be thought of as virtual patch cords connecting the output of a component's splitter to the input mixer of another component. In practice, when a connection is established the Audio Binding Services creates a bound output/input channel pair (i.e. a virtual patch cord), then adds the output element of the pair as a new output channel to the source splitter while adding the input element of the pair as a new input channel to the target mixer. When a connection is removed, the Audio Binding Services removes the output and input channels from the corresponding splitter and mixer, respectively, then destroys the bound pair. This approach provides extreme audio flexibility by allowing any number of diverse audio components to be arbitrarily interconnected.

Each autonomous audio component depicted in FIG. 22 can be described as follows: Audio Terminals 1, 2, and 3 represent an audio presence at a specified location in the virtual world and are usually associated with an actor located somewhere in the virtual world (such as an Avatar, NPC, communications radio, loudspeaker, etc.). Audio from an Audio Terminal's input mixer is applied to the Spatialized Audio System where it is processed with respect to the Audio Terminal's location within the virtual world. Each Audio Terminal also supports a virtual microphone capable of sensing spatialized audio from various locations in the virtual world. That is, the virtual microphone is sensitive to the location and distance of other sound sources in the virtual world and provides modification of those sounds based on world topography including, but not limited to, attenuation for distance, stereo balance adjustment to imply direction, filtering for baffles or obstructions, etc. The Digital Signal Processors (DSP 1 and DSP 2) may be any type of digital signal processor that modifies the audio, including but not limited to, filtering, add reverb, modify voices, provide equalizer services, etc. A DSP receives audio from its input mixer, modifies the audio, then applies the output to its output splitter. Audio Generators 1, 2, and 3 generate sounds and applies the sound to their respective output splitters. Sounds created by an Audio Generator may be synthesized or may render audio from a sound file or other audio source. Typically, Audio Generators are used for user interface sounds, scoring, or background ambiance. The Private Network Nodes (Private Node 1, 2, and 3) convert compressed audio streams from their associated clients (Client 1, 2, and 3) to a format compatible with other audio components, then outputs that audio via its output splitter. A private node also accepts input from its mixer, compresses it into a network-compatible stream, then sends the audio to its remote client. Note that Clients 1, 2, and 3 represent user devices, such as cell phones, tablets, laptops, etc., and each is equipped with a sound system capable of delivering rendered sounds to the corresponding user (Users 1, 2, and 3 respectively), as well as equipped with a microphone or similar device to provide an audio output stream (such as voice) from the corresponding client.

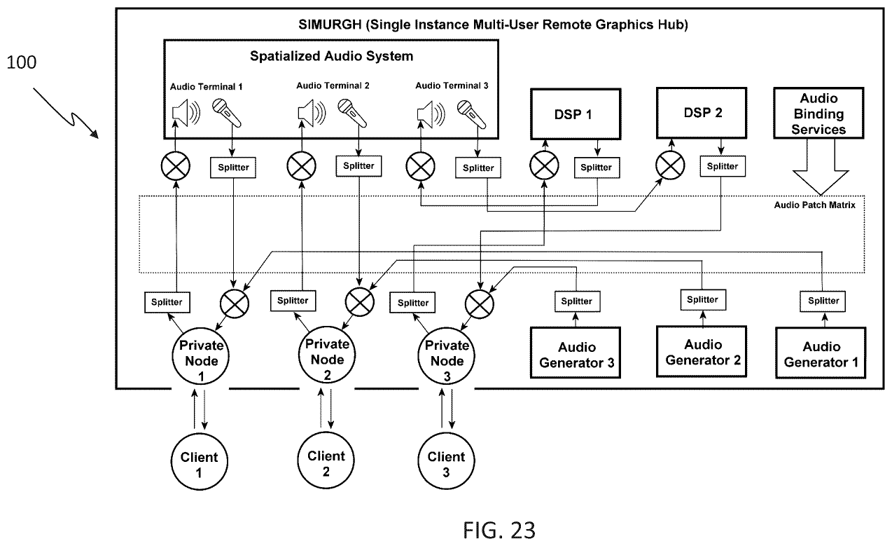

An example of how these audio components may be interconnected by the Audio Binding Services for a typical scenario is shown in FIG. 23, which is a diagrammatical illustration of a spatialized audio stream process used by the system, in accordance with embodiments of the present disclosure. In this example, it can be assumed Users 1 and 2 at Client 1 and Client 2 are represented by avatars in the virtual world, and User 3 at Client 3 is represented by a communications radio in the virtual world, i.e., that is, User 3 does not have an avatar but is capable of communication via radio located in the virtual world.

A voice stream from Client 1 (User 1) is available at the output splitter for Private Node 1; this is connected to the input mixer of Audio Terminal 1, which is associated with the avatar for User 1. Anything User 1 says will be processed by the Spatialized Audio System based on the location of the user's avatar in the virtual world. Any sounds detected at the location of user's avatar will be picked up by the avatar's Audio Terminal (Audio Terminal 1) and applied to the output splitter of Audio Terminal 1. An output channel from Audio Terminal 1 splitter is connected to the input mixer for Private Node 1, which converts the audio to a stream and sends it back to Client 1 (User 1). As such, anything that the user's avatar can ‘hear’ is applied to the audio stream received by Client 1 (User 1). In addition, the output splitter from Audio Generator 1 is applied to the input mixer for Private Node 1, thereby allowing additional sounds (such as user interface feedback, scoring, etc.) to be included in the output stream sent to Client 1 (User 1).

A similar series of connections is shown for Client 2 (User 2), Private Node 2, Audio Terminal 2, and Audio Generator 2 for use by Client 2 (User 2). If the avatars for Client 1 (User 1) and Client 2 (User 2) are in close proximity to each other, then any audio processed by Audio Terminal 1 will be picked up by Audio Terminal 2, and vice versa. Consequently, anything voiced by Client 1 (User 1) will be heard by Client 2 (User 2), and vice versa. As such Client 1 (User 1) will be able to communicate with Client 2 (User 2) via their avatars. However, if the distance between avatars were to increase, the audio volume heard by each user will decrease. If the distance between avatars is sufficiently large, then Client 1 (User 1) and Client 2 (User 2) will not be able to hear each other, thereby replicating similar conditions in the real world. Also note that because Client 1 (User 1) and Client 2 (User 2) each have inputs from separate Audio Generators and that generated audio is never applied to the virtual world by the Spatialized Audio System, Client 1 (User 1) and Client 2 (User 2) will never hear each other's user interface sounds, scoring, etc. This allows each user to choose their preferred style of scoring (e.g. classical music vs. rock and roll). In addition, this segregation of scoring allows the music mood to be completely different between users. For example, if Client 1 (User 1) defeats Client 2 (User 2) in battle, Client 1 (User 1) may hear an uplifting triumphant sound reward, while Client 2 (User 2) hears a sound typical of defeat.

The connections for User 3 using Client 3 and Private Node 3 are somewhat different. The output of the splitter for Private Node 3 is applied to the input mixer of DSP 1, which is configured to modify voice as if it were coming from a radio speaker. The output splitter of DSP 1 is applied to Audio Terminal 3, which is associated with (and located at) a communications radio in the virtual world. As such, anything Client 3 (User 3) says will come from the virtual radio associated with Audio Terminal 3 and be modified to mimic sounds coming from a small speaker in a radio. Any audio detected by Audio Terminal 3 is applied to the output splitter of Audio Terminal 3, which is connected to the input mixer of DSP 2. DSP 2 may modify the sounds detected by Audio Terminal 3 to make audio sound like it was picked up by a radio's microphone. The output splitter of DSP 2 is applied to the input mixer of Private Node 3, which streams the audio to Client 3 (User 3). In addition, the splitter output from Audio Generator 3 is also applied to the input mixer of Private Node 3. Because the output of Audio Generator 3 is not passed through DSP 2, Client 3 (User 3) will hear the user interface sounds and scoring clean and undistorted, while anything detected in the virtual world by Audio Terminal 3 will be distorted as if it were picked up by a radio microphone.

If Audio Terminal 1 and/or Audio Terminal 2 are near Audio Terminal 3 (i.e. the avatars for Client 1 (User 1) and/or Client 2 (User 2) are near the radio), then Client 1 (User 1) and/or Client 2 (User 2) can communicate directly to Client 3 (User 3), though the audio will be modified as if it were going through a communications radio. As with the previous example, if the distance between Audio Terminal 3 and the other Audio Terminals were to increase sufficiently, then the avatars would not hear the radio and the radio's microphone would not pick up conversations by the avatars.

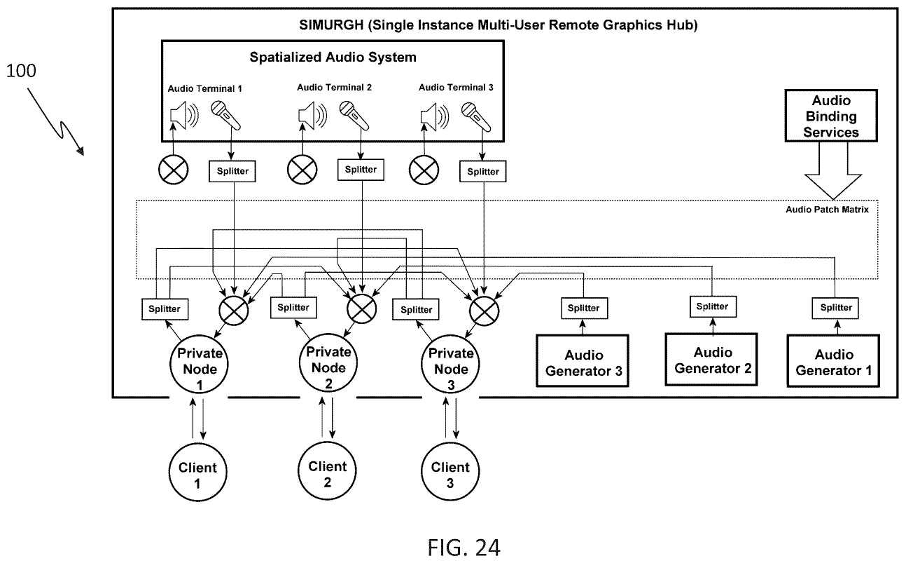

The above example discusses fully spatialized audio and behaves as audio would in the real world. However, there are applications where fully spatialized audio is not desired. A typical teleconferencing application (including video conference, web-based conferencing and similar applications) is shown in FIG. 24, which is a diagrammatical illustration of an audio stream process for teleconferencing and similar communications, in accordance with embodiments of the present disclosure. The Digital Signal Processors (DSPs) are not shown in FIG. 24. Optional DSP processing could be implemented depending on the nature of the conference application. Also, the input mixers for Audio Terminals 1, 2, and 3 have zero input channels and are essentially disconnected for teleconferencing applications, spatialization of user voices is generally not desired; users should hear each other clearly regardless of their location in the world.

As with the previous example's application, each private node (Private Nodes 1, 2, and 3) receives audio from separate audio generators (Audio Generators 1, 2, and 3, respectively). This allows each user in the teleconferencing session to not only have unique user interface sounds, but also allows each user to play different background music, or no music, if desired. Also shown are optional connections from the output splitters of Audio Terminals 1, 2, and 3 to the input mixers of Private Nodes 1, 2, and 3. These connections may be provided if users want to hear any sound effects that are generated in the virtual world by the Spatialized Audio System, as might be the case if the conference is taking place in a digital twin. These connections from the Spatialized Audio System may be severed if sound effects from the virtual world become a distraction or provide no value to the material of the conference.

Unlike the fully spatialized application, user audio (voice) is not processed with respect to the user's location in the virtual world. Instead, the output splitter of each Private Node is applied directly to the input mixer of all other Private Nodes, specifically, the output splitter of Private Node 1 is applied to the input mixers of Private Nodes 2 and 3, the output splitter of Private Node 2 is applied to the input mixers of Private Nodes 1 and 3, and the splitter output of Private Node 3 is applied directly to the input mixers of Private Nodes 1 and 2. The result is all users hear all other users at full volume regardless of where their avatars reside in the virtual world. This allows any venue, no matter how large, to be used comfortably for teleconferencing and eliminates the need to keep all participants in close proximity.

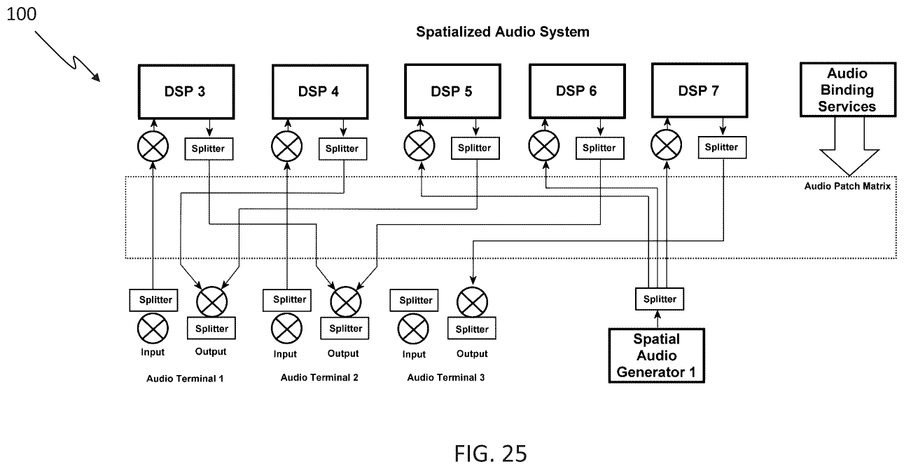

A detailed description of a Spatialized Audio System is depicted in FIG. 25, which is a diagrammatical illustration of the details of the digital signal processors of FIG. 23 in a spatialized audio stream process used by the system, in accordance with embodiments of the present disclosure. FIG. 25 is an extension of FIG. 23 or an expanded view of the Spatialized Audio System shown in FIG. 23. The same example described above for FIG. 23 also applies to the discussion of FIG. 25, specifically, User 1 and User 2 at Client 1 and Client 2, respectively, connected to Audio Terminal 1 and Audio Terminal 2, respectively, have a presence in the virtual world as Avatar 1 and Avatar 2, respectively, and User 3 at Client 3 is connected to Audio Terminal 3 and has a presence in the virtual world as a communications radio (Radio 1). Also assume that Avatar 1 and Avatar 2 are within hearing range of each other, and that Radio 1 is out of hearing range of both Avatar 1 and Avatar 2. In addition, assume that a pile driver is operating in the virtual world with a sound effect of sufficient volume and at a location where it can be effectively ‘heard’ by all Audio Terminals (Audio Terminals 1, 2, and 3) in the Spatialized Audio System.

Note that all Audio Terminals are associated with a location and an orientation in the virtual world. Spatial Audio Generator 1 is also associated with a location in the virtual world and otherwise includes the same functionality as Audio Generators 1, 2, and 3 in FIGS. 23 and 24. Also, the Audio Binding Services and/or Audio Patch Matrix in FIG. 25 may be the same Audio Binding Services and/or Audio Patch Matrix as shown in FIG. 23, or it can be a separate Audio Binding Service and/or Audio Patch Matrix that is optimized for spatialization.

The input for each Audio Terminal (Audio Terminals 1, 2, and 3) consists of a composite multi-channel mixer-splitter pair. The mixer portion of the mixer-splitter pair combines all of the mixer's input channels into a single stream, such as combining user voice with footstep sound effects associated with the avatar, which can then be subsequently distributed by the splitter portion as composite audio for the avatar as a whole. This process of combining all sounds that are associated with a common location in the virtual world reduces the number of connections and processing overhead that would otherwise be required for spatial processing of each sound individually.

A similar mixer-splitter pair is provided at the output of each Audio Terminal (Audio Terminals 1, 2, and 3). The mixer portion of the mixer-splitter pair combines spatialized audio from various location in the virtual world into a single audio stream, then the splitter portion of the output mixer-splitter pair distributes the composite spatialized audio to one or more destination points in the larger audio system shown in FIG. 23.

In these examples, Spatial Audio Generator 1 produces a sound effect for the pile driver present in the virtual world. This sound effect is loud enough that it can be heard by Audio Terminals 1, 2, and 3, however, each of the Audio Terminals are at different locations with respect to the pile driver's location and each Audio Terminal (1, 2 and 3) will perceive the sound differently. Specifically, the pile driver sound effect must be modified independently for each of the Audio Terminals (1, 2 and 3). If Avatars 1 and 2 are facing each other and the pile driver is located to the left of Avatar 1, then the pile driver will be perceived as being to the right of Avatar 2. Consequentially, the pile driver sound effect should be louder in the left stereo channel for Audio Terminal 1 utilized by User 1, where the same sound effect should be louder in the right stereo channel for Audio Terminal 2 utilized by User 2. If Audio Terminal 3 representing Radio 1 is equipped with an omni-directional microphone, then the direction to the pile driver would have no effect on stereo balance. The overall amplitude of the pile driver sound must be attenuated based on the distance between the pile driver and Audio Terminals 1, 2, and 3, independently. Other factors may also be taken into account, such as if there are any barriers or audio obstructions between the pile driver and Audio Terminals (1, 2 and 3), i.e., reflected sounds or changes resulting from air density or humidity.

The independent adjustments needed for spatialization may be accomplished using Digital Signal Processors (DSPs). For example, the splitter output channels of Spatial Audio Generator 1 are applied to the input mixers of DSP 5, 6, and 7 (shown in FIG. 25), each of which modify the audio for spatial properties based on their respective target Audio Terminals: the output of DSP 5 is applied to Audio Terminal 1, the output of DSP 6 is applied to Audio Terminal 2, and the output of DSP 7 is applied to Audio Terminal 3, thereby giving each Audio Terminal (1, 2, and 3) a different perception of the sound based on the location and orientation of each Audio Terminal with respect to the location associated with Spatial Audio Generator 1.

A similar process, as shown in FIG. 25, with similar connections, takes place between the input mixer-splitter of Audio Terminal 1 and the output mixer-splitter of Audio Terminal 2 via DSP 3. In this example, DSP 3 modifies audio from Audio Terminal 1 to provide characteristics that would be perceived by Audio Terminal 2 as coming from the virtual world location of Audio Terminal 1. The mixer element of the output mixer-splitter for Audio Terminal 2 will combine the modified audio from DSP 3 with that of DSP 6, thereby providing a composite perception of sounds present at the location of Audio Terminal 2. If the pile driver (audio from Spatial Audio Generator 1) is in the distance, the pile driver will be diminished and be perceived as a distant background effect while voice from Audio Terminal 1 will sound more like foreground audio. However, if the pile driver represented by Spatial Audio Generator 4 (not shown) is close to Audio Terminal 2, then its sound effects will be pronounced and compete with voice from Audio Terminal 1 as part of the foreground sounds. This mixing of multiple sounds processed for various relative locations produces the overall effect of audio spatialization.

A similar process, with similar connections, also takes place between the input mixer-splitter of Audio Terminal 2 and the output mixer-splitter of Audio Terminal 1 via DSP 4. However, it is noted that there is not an equivalent connection between Audio Terminals 1 or 2, and the output mixer-splitter of Audio Terminal 3. This is due to Audio Terminal 3 being located too far away from either Audio Terminal 1 or Audio Terminal 2 to ‘hear’ audio from their locations and any attempt to pass this audio through a spatial DSP would result in an output audio level of zero. As a matter of optimization, the connection may be omitted completely (as shown), rather than committing resources to produce a null effect. For this reason, there are also no connections from the input mixer-splitter of Audio Terminal 3 to either Audio Terminal 1 or 2 as Audio Terminal 3 is too far away from the other audio terminals to be perceived, therefore the connection is dropped.

Removing audio connections and DSPs when they fall out of scope is a form of optimization that that may be used to reduce system overhead. Consider how the connections and associated DSPs in FIG. 25 would change if Audio Terminals 1, 2, and 3 as well as Spatial Audio Generator 1 were all within range of each other, i.e. worst-case with all components within hearing range of each other. Under these conditions, each Audio Terminal (1, 2 and 3) would require connections to two DSPs, which, in turn, would require one connection to each of the remaining Audio Terminals. This would result in a total of 6 DSPs and 12 connections to spatialize audio between the Audio Terminals in addition to the 3 DSPs and 6 connections that are already in place for spatializing the output of Spatial Audio Generator 1 to each of the Audio Terminals (1, 2 and 3). If a fourth user joins the session and all spatialized audio components are within range of each other, then the total number of DSPs needed increases to 12 requiring a total of 24 connections. Also, an additional DSP along with 2 additional connections would be required to spatialize the output of Spatial Audio Generator 1 to the newly added Audio Terminal N (not shown). In total between all Audio Terminals and the Spatial Audio Generator, the requirements would be 15 DSPs and 30 connections. Stated in more general terms, scalability for spatialization between Audio Terminals (assuming worst case with all Audio Terminals within scope of each other) increases at a rate of N(N−1) for DSPs and 2N(N−1) for connections between Audio Terminals and DSPs. In addition, the scalability between any sound effects produced by Spatial Audio Generators is N for Digital Signal Processors with 2N connections required for each Spatial Audio Generator.

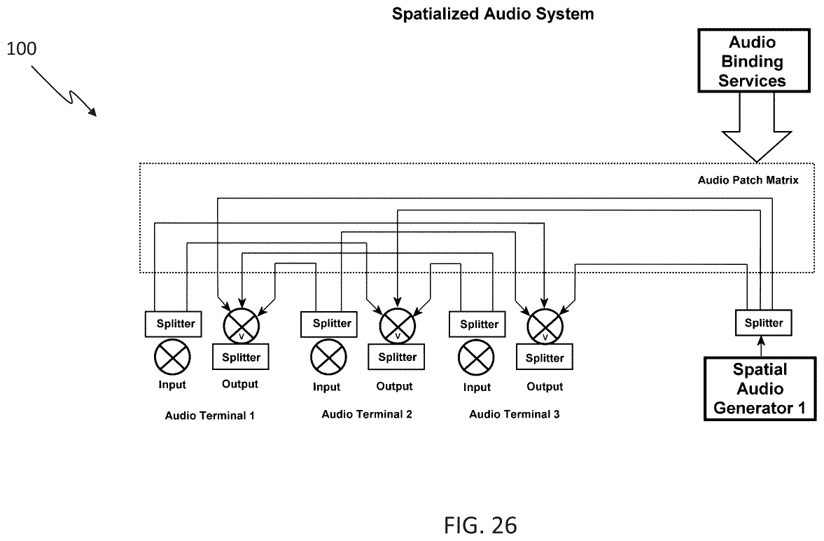

The worst-case scalability of the Spatialized Audio System can be further optimized by eliminating DSPs for the most basic spatialization requirements and handing that functionality off to the output mixers of the Audio Terminal's output mixer-splitter. At a minimum, spatialization of audio requires that the overall signal level be attenuated as a consequence of distance from the source and that the stereo balance be adjusted for directionality. If the mixer input channels allow independent adjustment of mixing level and stereo balance, then both of these functions may be performed at the mixer inputs without the need of a DSP. An example of this technique is depicted in FIG. 26, which is a diagrammatical illustration of the optimization of digital signal processors of FIG. 23 in a spatialized audio stream process used by the system, in accordance with embodiments of the present disclosure.

In FIG. 26 the mixer elements of output mixer-splitter on Audio Terminals 1, 2, and 3 support variable input channels that are independently adjustable (denoted by a ‘V’ on the mixer in the diagram). These variable input mixers differ from the other mixers discussed thus far by adding an additional operation to the mixing process. The simple fixed mixers discussed to this point may combine input using simple summation of the input channels. The mixers with variable input channels scale the input level prior to or during summation, allowing each input channel to be independently scaled for stereo left and stereo right levels. This allows control over both the balance and overall level of each input channel.

The specific level adjustments for each input channel are performed by the variable mixers themselves. The audio patch bindings from the output splitter of Spatial Audio Generator 1 and the splitter element of the input mixer-splitter from each Audio Terminal carry location data of the audio source along with the audio stream. Periodically, each variable input mixer compares the location data from the source with its own location and orientation; the result of this comparison is used to adjust the right and left stereo levels for the applicable mixer channel. This provides a near-continuous adjustment of the primary spatial audio properties of attenuation over distance and directionality.

With this optimization, the worst case scaling is reduced to N(N−1) connections between Audio Terminals and N connections for each Spatial Audio Generator. No Digital Signal Processors are required, and overall latency is reduced by removing latency that would have been introduced by DSPs.

The configuration shown FIG. 26 only processes directionality and attenuation over distance; it does not show more advanced spatial audio properties such as low-pass filtering as a result of sound behind a barrier, reflected sounds, etc. However, advanced spatial properties provided by a DSP can be included with this optimization by adding DSPs on demand as needed. For example, if Audio Terminal 3 moves behind a barrier with respect to Spatial Audio Generator 1, then the connection between the output splitter of Spatial Audio Generator 1 and Audio Terminal 3 can be removed and replaced by a DSP and its associated connections. The DSP can provide low pass filtering typical of a baffle or barrier to provide more realism to the audio. If or when Audio Terminal 3 moves out from behind the barrier and again has a direct line of sight to Spatial Audio Generator 1, then the DSP is removed and the original connection between Spatial Audio Generator 1 and Audio Terminal 3 is restored.

The specific examples shown in FIG. 22 through FIG. 26 were chosen to describe the behavior of audio streaming as it applies to this disclosure and does not imply that these are the only configurations applicable within this disclosure. Rather, the modular approach disclosed herein is capable of nearly unlimited permutations that may be adapted in various ways to accommodate a wide range of applications and conditions. Some examples of these variations include, but are not limited to, Audio Terminals do not necessarily need to include both an input and output mixer-splitter pair. If an Audio Terminal is associated with a loudspeaker that does not have the capability to ‘listen’ to spatialized sounds, then the Audio Terminal may consist of only the input mixer-splitter pair. Likewise, if an Audio Terminal is associated with a listening device (such as a spy's ‘bug’) and does not have the capability to emit sound in the virtual world, then the Audio Terminal may consist of only the output mixer-splitter. Spatial Audio Generators may be replaced by Audio Terminals if more than one sound effect needs to be generated at a single location. An example of this might be a vehicle, where it may be more beneficial to mix composite sound effects, such as engine noise, horns, door closures, etc., into a single stream before spatializing. One or more DSPs may be added to the splitter output of a Private Node to filter out background noise picked up by the user's microphone, provide squelch, provide automatic level control, etc.

Natively, the system 100 assumes only one keyboard and mouse per system, however, each user connected to the platform could each have a keyboard and mouse assigned to them. As such the context of many input devices needs to be segregated and tracked through a system that natively processes a single set of input devices. The user's device may also have additional input systems available, such as touch screens, motion detectors, steering wheels, accessibility devices, and more. Some user input devices may require additional processing or state tracking that was not processed at the user's device and/or browser. In addition, there may be differences in raw data returned by similar input systems across a diverse combinations of user device and browsers, all of which need to be standardized before they can be applied to the platform. A similar compatibility issue potentially exists for any commands sent back to the user's browser, such as haptic feedback, resolution adjustments, displaying overlays, or synchronizing entry into the world for tournament cohorts or any cohort that must enter the virtual world at the same time.

These issues may be handled by an input and command system, as shown in FIG. 20, where input data from a user node is passed through the corresponding private network interface node, and to a controller (not depicted). The controller may detect the user's browser and device type to determine if any compatibility conversion or adjustments need to be made. The controller may also make any necessary adjustment, then tag or index the input data to identify the user that submitted it before passing it onto the input queue for subsequent action by the system.

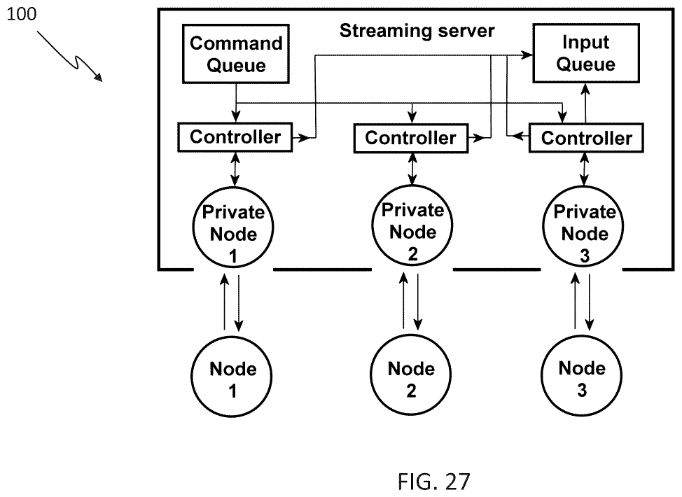

The system 100 may further utilize a command and control processing using private network interface nodes. FIG. 27 is an example diagrammatical illustration of command and control processing used by the system 100, and not limited to 3 nodes, in accordance with embodiments of the present disclosure. As shown, user inputs from each user node (Nodes 1, 2, and 3) are forwarded by the applicable private network interface node (Private Nodes 1, 2, and 3) to a controller for the corresponding user. User inputs are processed by the controllers and indexed by user, then applied to the input queue for subsequent processing by the system. Control commands destined for specific users are placed in the command queue then passed to the controller(s) for the applicable users, which is processed, vetted, then applied to the target user node via the private network interface node.

The controllers in FIG. 27 may perform a similar conversion function to that described relative to FIG. 20 for any commands being sent back to the user nodes. Standardized commands, such as changing resolution, haptic feedback, or requesting an overlay, are passed from the command queue to the applicable controller(s), which performs any compatibility conversions or adjustments before sending the command to the user node via the private network interface node. In addition to ensuring compatibility for input and command data, the controllers shown in FIG. 27 may also perform input custom mapping based on user preferences, thereby allowing each individual user to configure their controls and displays to match their needs.

In the system 100, each web browser used by users is not required to maintain peer-to-peer connections to all other client browsers and the server. Additionally, the streamed multi-user interactive content method and system 100 keeps the network footprint narrow compared to other methods. The importance of keeping bandwidth narrow is to allow more clients to use a single server instance. As such, the system 100 can replace the functionality of conventional websites. Virtual worlds created with the system 100 can be accessed through a URL launched from an object in another webpage or another virtual world as well as accessing through a URL tied directly to a specific virtual world.

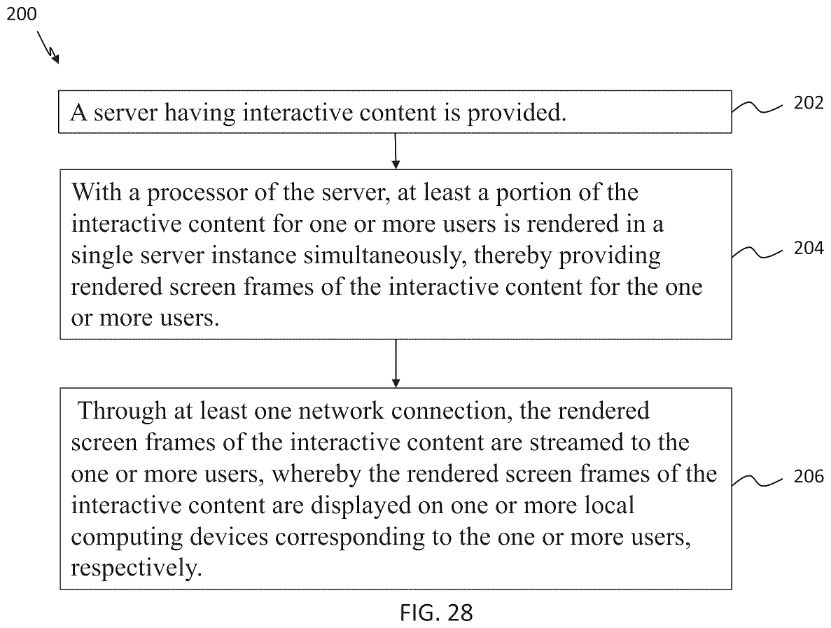

FIG. 28 is a flowchart 200 illustrating a method of providing interactive content to one or more users, in accordance with embodiments of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 202, a server having interactive content is provided. With a processor of the server, at least a portion of the interactive content for one or more users is rendered in a single server instance simultaneously, thereby providing rendered screen frames of the interactive content for the one or more users (block 204). Through at least one network connection, the rendered screen frames of the interactive content are streamed to the one or more users, whereby the rendered screen frames of the interactive content are displayed on one or more local computing devices corresponding to the one or more users, respectively (block 206). Any number of additional steps, functions, processes, or variants thereof may be included in the method, including any disclosed relative to any other figure of this disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method of providing interactive content to at least one user, the method comprising:
providing a server having interactive content;
rendering, with a processor of the server, at least a portion of the interactive content for one or more users in a single server instance simultaneously, thereby providing rendered screen frames of the interactive content for the one or more users; and
streaming, through at least one network connection, the rendered screen frames of the interactive content to the one or more users, whereby the rendered screen frames of the interactive content are displayed on one or more local computing devices corresponding to the one or more users, respectively.

2. The method of claim 1, wherein interactive content further comprises a single authoritative virtual world, wherein the single authoritative virtual world is identical for the one or more users.

3. The method of claim 1, wherein rendering the interactive content for the one or more users in the single server instance simultaneously further comprises:
rendering the interactive content to a texture canvas, wherein the texture canvas is large enough for all rendered screen frames of the interactive content; and
partitioning the rendered screen frames of the interactive content into individual user screen frames, wherein the individual user screen frames correspond to different users and are adjustable for each specific user's perspective, whereby each user sees a screen frame from the specific user's perspective.

4. The method of claim 3, further comprising encoding the individual user screen frames prior to streaming.

5. The method of claim 3, further comprising displaying at least two of the individual user screen frames on a single display screen.

6. The method of claim 5, wherein each individual user screen frame has a reduced viewpoint, wherein at least one of the at least two of the individual user screen frames displayed on the single display screen is smaller than another of the at least two of the individual user screen frames displayed on the single display screen.

7. The method of claim 3, wherein the texture canvas is large enough for all rendered screen frames of the interactive content and for any individual user requested resolutions.

8. The method of claim 3, wherein rendering the interactive content to the texture canvas further comprises rendering all overlay icons on the rendered screen frames before partitioning the rendered screen frames into individual user screen frames.

9. The method of claim 3, further comprising mapping a region of individual user screen frames to a single viewport, thereby providing a composited screen frame.

10. The method of claim 9, wherein a first user of the one or more users can simultaneously view on a display screen one of the individual user screen frames corresponding to the first user and another of the individual user screen frames corresponding to a second user.

11. The method of claim 9, further comprising compositing the individual user screen frames:
before additional information is added; or
after additional information is added.

12. The method of claim 9, wherein mapping a region of individual user screen frames to a single viewport further comprises defining source and destination regions of the texture canvas using a native U-V coordinate system.

13. The method of claim 1, further comprising managing streaming of the rendered screen frames using host streaming nodes, wherein the host streaming nodes do not exceed one in-bound and one out-bound stream per user.

14. The method of claim 13, further comprising setting up and managing spare host streaming nodes.

15. The method of claim 1, wherein the rendered screen frames of the interactive content streamed to the one or more local computing devices corresponding to the one or more users, respectively, further comprises playing audio associated with the rendered screen frames of the interactive content, wherein the audio is spatialized.

16. The method of claim 3, wherein the rendered screen frames of the interactive content streamed to the one or more local computing devices corresponding to the one or more users, respectively, further comprises playing user video provided by a user, wherein the user video is routed between the one or more users by rendering each video frame to a user cell in the texture canvas.

17. The method of claim 16, wherein video provided by the user is rendered in a same rendering pass as the rendered screen frames to which the video is added.

18. The method of claim 1, wherein the one or more users use a web browser to access the rendered screen frames of the interactive content that are displayed on the one or more local computing devices of the one or more users, respectively.

19. A method of providing interactive gaming content to at least one user, the method comprising:
providing a server having a virtual environment with interactive gaming content;
rendering, with a processor of the server, at least a portion of the interactive gaming content for at least one user in a single server instance simultaneously, thereby providing rendered screen frames of the interactive gaming content for all users of the virtual environment, wherein the portion of the interactive gaming content is rendered to a texture canvas which has capacity for all rendered screen frames of the interactive gaming content;
partitioning the rendered screen frames of the interactive content into individual user screen frames corresponding to each user of the virtual environment; and
streaming, through at least one network connection, the rendered screen frames of the interactive content to each user of the virtual environment, whereby the virtual environment is accessed by each user through a web browser on a local computing device of the user, and the rendered screen frames of the interactive content are displayed on the local user computing device of the user.

20. A system of providing interactive content to at least one user comprising:
a server having interactive content, the server having a processor and a non-transitory memory;
rendered screen frames derived from the interactive content by a rendering process with the processor of the server, wherein the rendering process renders at least a portion of the interactive content for one or more users in a single server instance simultaneously, thereby providing the rendered screen frames of the interactive content for the one or more users;
at least one network connection between the server and local computing devices, wherein the rendered screen frames of the interactive content are streamed to the one or more users; and
a display device for each of the local computing devices, wherein the rendered screen frames of the interactive content are displayed on the display device of each of the local computing devices corresponding to the one or more users, and are adjustable for each specific user's perspective, whereby each user sees a screen frame from the specific user's perspective.
